(19) United States
(12) Patent Application Publication
(10) Pub. No.: US 2004/0153560 A1
(43) Pub. Date: Aug. 5, 2004

(54) Maintenance interface user authentication method and apparatus in client/server type distribution system

(75) Inventors: Mao Masuhiro, Tokyo (JP); Yasuhiro Watanabe, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/728,820

(22) Filed: Dec. 8, 2003

(30) Foreign Application Priority Data
Dec. 9, 2002 (JP) 2002-356839

(51) Int. Cl. G06F 15/16

(52) U.S. Cl. 709/229; 713/201

(57) ABSTRACT

A request receiving section of a server device receives, from a server-side console, an information setting request including user authentication information and designation of a client device and a setting nullification request including designation of a client device, and a request transfer section transfers the requests to a designated client device over a LAN. A remote request processing section of a client device sets user authentication information in the received setting request in a user authentication section which authenticates a user who uses a maintenance interface, and opens the maintenance interface. When receiving the setting nullification request, the remote request processing section nullifies the user authentication information set in the user authentication section and closes the maintenance interface. Accordingly, a client/server type distribution system can remotely open and close the maintenance interface of a client device from the server device.

### BACKGROUND OF THE INVENTION

1. Field of the Invention

The present invention relates to a maintenance interface user authentication method and apparatus in a client/server type distribution system, and, more particularly, to a maintenance interface user authentication method and apparatus which can set or nullify user authentication information for authentication of a user at the time of using a maintenance interface provided in a client device from a server device over a network.

2. Description of the Related Art

In a client/server type distribution system, as client devices are sited geometrically dispersed, the individual client devices are remotely maintained over a LAN from a remote maintenance console on the LAN in at the time of system operation in some cases. Because the remote maintenance over the LAN should security guaranteed, however, only those who know user authentication information set beforehand are permitted to use the maintenance interface of a client device. Specifically, user authentication information which is comprised of a user name and a password is set in a client device beforehand by using a remote maintenance console connected to the client device, and at the time ordinary operations called “log-in” and “log-out” are performed, a user is asked to enter a user name and password for authentication and a maintenance work from the remote maintenance console is enabled only when the entered user name and password match with those registered in the client device.

The technique which performs user authentication using a user name and password in case where maintenance of one device is executed from a remote maintenance console over a network is described in Japanese Patent No. 3214423, which does not however disclose a specific method of registering a user name and password beforehand. Japanese Patent Laid-Open No. 2001-197058 describes a terminal-maintenance-server authentication key sharing method of sharing an authentication key between a terminal a maintenance server for allowing a plurality of terminals, connected dial-up to the Internet, and a single maintenance server to share an IPsec authentication key to realize a VPN session in a network layer of an OSI reference model. Japanese Patent Laid-Open No. 2001-197058 however fails- to describe a scheme of nullifying the set authentication key and closing the maintenance interface.

To secure the security of remote maintenance over a network, as mentioned above., user authentication is carried out using authentication information at the time of using the maintenance interface of a client device. If a user name and password set beforehand are leaked, however, the client device can be accessed when the proper user name and password are input from another terminal connected to the network in the same procedures, leading to a possible danger of hacking or so through the maintenance interface. In case where there occurs a danger of being hacked or so during system operation, protection against hacking should be taken by deleting user names and passwords registered in client devices or rewriting them to different user names and passwords. It however requires a troublesome work and takes time to go over to sites of the individual client devices dispersed geometrically and delete or change authentication information from the local maintenance consoles. In addition, if the local maintenance consoles of clients have already been removed, a maintenance worker should go over a troublesome work of reconnecting. Should authentication information be deleted once, maintenance from a remote maintenance console could not be performed during system operation, so that for maintenance of a client device, the worker should go through a troublesome work of going over to the site of the client device again and setting authentication information. In other words, the maintenance interface user authentication system for the conventional client/server type distribution system has a difficulty in both guaranteeing security and facilitating the maintenance.

### SUMMARY OF THE INVENTION

Accordingly, it is an object of the invention to provide a maintenance interface user authentication method and apparatus in a client/server type distribution system that can guarantee the security of a maintenance interface in each client device and can manage permission and inhibition of the use of the maintenance interfaces of a plurality of client devices from a server device.

It is another object of the invention to provide a maintenance interface user authentication method and apparatus in a client/server type distribution system that manage the allowable use time of the maintenance interface of a client device to thereby minimize a chance of hacking or so, which may take place as the maintenance interface of a client device is kept open.

It is a further object of the invention to provide a maintenance interface user authentication method and apparatus in a client/server type distribution system that improve the usability of the maintenance interface of a client device by ensuring extension of the allowable use time of the maintenance interface of the client device and closure of the maintenance interface from a maintenance worker.

In a maintenance interface user authentication apparatus according to the invention in a first client/server type distribution system having a plurality of client devices connected to a server device over a network, the server device has a request receiving section which receives from a server-side console a user authentication information setting request including user authentication information and designation of the client devices and a nullification-of-user-authentication-information-setting request including designation of the client devices; and a request transfer section which transfers the user authentication information setting request and the nullification-of-user-authentication-information-setting request, received by the request receiving section, to those of the client devices which are designated over the network, and each of the client devices has user an authentication section which authenticates a user at a time of using a maintenance interface; and a remote request processing section which sets the user authentication information, included in the user authentication information setting request, in the user authentication section when receiving the user authentication information setting request from the server device over the network, and nullifies the user authentication information set in the user authentication section when receiving the nullification-of-user-authentication-information-setting request from the server device over the network.

In the first maintenance interface user authentication apparatus in a client/server type distribution system, user authentication information for guaranteeing security for the maintenance interfaces of a plurality of client devices can be set remotely from the server-side console over a network and user authentication information already set can be nullified remotely from the server-side console over the network, so that the server side can manage the security for all the maintenance interfaces of the individual client devices.

A second maintenance interface user authentication apparatus according to the invention in a client/server type distribution system is the first maintenance interface user authentication apparatus, wherein setting of the user authentication information in the user authentication section in each of the client devices can be done only from the server-side console. This can allow the maintenance interfaces of the individual client devices to be opened only from the server-side console, thus ensuring better security.

A third maintenance interface user authentication apparatus according to the invention in a client/server type distribution system is the maintenance interface user authentication apparatus, wherein the server device has an encryption section which encrypts the user authentication information in the user authentication information setting request to be transferred by the request transfer section, and each of the client devices has a decryption section which decrypts encrypted user authentication information in the user authentication information setting request received by the remote request processing section. This can prevent leakage of user authentication information for opening the maintenance interfaces of the client devices over the network, thus ensuring security.

A fourth maintenance interface user authentication apparatus according to the invention in a client/server type distribution system is the first or second maintenance interface user authentication apparatus, wherein each of the client devices has a cutoff enforcement section which forcibly disables use of a user who is currently using the maintenance interface in case where that user authentication information which is already set in the user authentication section is set again by a new user authentication information setting request received over the network. Accordingly, in case where a malignant access is made through the maintenance interface of a client device, the access can be inhibited immediately by remote control from the server-side console and at the same time user authentication information which is used in intrusion can be nullified and new user authentication information can be set again for the normal maintenance.

A fifth maintenance interface user authentication apparatus according to the invention in a client/server type distribution system is the first or second maintenance interface user authentication apparatus, wherein each of the client devices has a use time management section which nullifies the user authentication information set in the user authentication section and forcibly disables use of a user who is currently using the maintenance interface when an allowable use time has elapsed since setting of the user authentication information in the user authentication section. This can prevent the maintenance interface of each client device from being open over a long period of time which would increase the threat of malignant accesses.

A sixth maintenance interface user authentication apparatus according to the invention in a client/server type distribution system is the fifth maintenance interface user authentication apparatus, wherein each of the client devices has a use time extending section which extends a remaining use time of the use time management section by a predetermined extension time only for first log-in since opening of the maintenance interface. Specifically, at a time a first log-in request is issued since opening of the maintenance interface, the use time extending section determines whether or not a remaining use time managed by the use time management section lies within a predetermined given time and extends the remaining use time of the use time management section by a predetermined extension time when the remaining use time lies within the predetermined given time. During first log-in since opening of the maintenance interface, the use time extending section may determine whether or not a remaining use time managed by the use time management section has fallen within a predetermined given time and may extend the remaining use time of the use time management section by a predetermined extension time when the remaining use time has fallen within the predetermined given time. With this structure, therefore, even if it takes a little while for a maintenance worker to actually use the maintenance interface a client device after opening the maintenance interface of the client device and the worker logs in when the remaining use time is short, the worker can do a sufficient maintenance work. What is more, as extension of the use time can be permitted only at the time of the first log-in, security can be guaranteed.

In the fifth or sixth maintenance interface user authentication apparatus in a client/server type distribution system, as the allowable use time, the use time management section may use an allowable use time designated in the user authentication information setting request sent from the server device or may use an allowable use time reference value prestored in the client devices. Alternatively, when an allowable use time is designated in the user authentication information setting request sent from the server device, the use time management section may use the designated allowable use time as the allowable use time, and when the allowable use time is not designated, the use time management section may use an allowable use time reference value prestored in the client devices as the allowable use time.

A seventh maintenance interface user authentication apparatus according to the invention in a client/server type distribution system is the first or second maintenance interface user authentication apparatus, wherein each of the client devices has a log-in number management section which nullifies the user authentication information set in the user authentication section and forcibly disables use of a user who is currently using the maintenance interface when an allowable number of log-in events has taken place since setting of the user authentication information in the user authentication section. This can guarantee security against a malignant user who repeats log-in and log-out.

In the seventh maintenance interface user authentication apparatus in a client/server type distribution system, as the allowable number of log-in events, the log-in number management section may use an allowable number of log-in events designated in the user authentication information setting request sent from the server device, or may use an allowable-number-of-log-in reference value prestored in the client devices. Alternatively, when an allowable number of log-in events is designated in the user authentication information setting request sent from the server device, the log-in number management section may use the designated allowable number of log-in events as the allowable number of log-in events, and when the allowable number of log-in events is not designated, the log-in number management section may use an allowable-number-of-log-in reference value prestored in the client devices as the allowable number of log-in events.

An eight maintenance interface user authentication apparatus according to the invention in a client/server type distribution system is the first or second maintenance interface user authentication apparatus, wherein each of the client devices has an authentication nullification section which nullifies the user authentication information set in the user authentication section at a time a user of the maintenance interface ends use of the maintenance interface. This can close the maintenance interface at the same time as a maintenance work is finished, making it possible to guarantee security of the maintenance interface of each client device.

A first maintenance interface user authentication method according to the invention in a client/server type distribution system is so designed as to include (a) a step in which a server device receives a user authentication information setting request including user authentication information and designation of client devices from a server-side console and transfers the user authentication information setting request to the designated client devices over a network; (b) a step in which the client devices receive the user authentication information setting request over the network and set the user authentication information setting request in a user authentication section which authenticates a user at a time of using a maintenance interface; (c) a step in which the server device receives a nullification-of-user-authentication-information-setting request including designation of the client devices from the server-side console and transfers the nullification-of-user-authentication-information-setting request to the designated client devices over the network; and (d) a step in which the client devices receive the nullification-of-user-authentication-information-setting request over the network and nullify the user authentication information set in the user authentication section.

In the first maintenance interface user authentication method in a client/server type distribution system, user authentication information for guaranteeing security for the maintenance interfaces of a plurality of client devices can be set remotely from the server-side console over a network and user authentication information already set can be nullified remotely from the server-side console over the network, so that the server side can manage the security for all the maintenance interfaces of the individual client devices.

A second maintenance interface user authentication method according to the invention in a client/server type distribution system is the first maintenance interface user authentication method, wherein setting of the user authentication information in the user authentication section in each of the client devices can be done only from the server-side console. This can allow the maintenance interfaces of the individual client devices to be opened only from the server-side console, thus ensuring better security.

A third maintenance interface user authentication method according to the invention in a client/server type distribution system is the first or second maintenance interface user authentication method designed in such a way that the step (a) includes a process of causing the server device to encrypt the user authentication information to be transferred and the step (b) includes a process of causing the client devices to decrypt the received user authentication information. This can prevent leakage of user authentication information for opening the maintenance interfaces of the client devices over the network, thus ensuring security.

A fourth maintenance interface user authentication method according to the invention in a client/server type distribution system is the first or second maintenance interface user authentication method designed in such a way that the step (b) includes a process of forcibly disabling use of a user who is currently using the maintenance interface in case where that user authentication information which is already set in the user authentication section is set again to new user authentication information received. Accordingly, in case where a malignant access is made through the maintenance interface of a client device, the access can be inhibited immediately by remote control from the server-side console and at the same time user authentication information which is used in intrusion can be nullified and new user authentication information can be set again for the normal maintenance.

A fifth maintenance interface user authentication method according to the invention in a client/server type distribution system is the first or second maintenance interface user authentication method designed in such a way as to further include (e) a step in which each of the client devices nullifies the user authentication information set in the user authentication section and forcibly disables use of a user who is currently using the maintenance interface when an allowable use time has elapsed since setting of the user authentication information in the user authentication section. This can prevent the maintenance interface of each client device from being open over a long period of time which would increase the threat of malignant accesses.

A sixth maintenance interface user authentication method according to the invention in a client/server type distribution system is the fifth maintenance interface user authentication method designed in such a way as to further include (f) a step in which the each of the client devices extends a remaining use time of the use time management section by a predetermined extension time only for first log-in since opening of the maintenance interface. Specifically, at a time a first log-in request is issued since opening of the maintenance interface, the step (f) determines whether or not a remaining use time managed in the step (e) lies within a predetermined given time and extends the remaining use time by a predetermined extension time when the remaining use time lies within the predetermined given time. During first log-in since opening of the maintenance interface, the step (f) may determine whether or not a remaining use time managed in the step (e) has fallen within a predetermined given time and extend the remaining use time by a predetermined extension time when the remaining-use time has fallen within the predetermined given time. With this structure, therefore, even if it takes a little while for a maintenance worker to actually use the maintenance interface a client device after opening the maintenance interface of the client device and the worker logs in when the remaining use time is short, the worker can do a sufficient maintenance work. What is more, as extension of the use time can be permitted only at the time of the first log-in, security can be guaranteed.

In the fifth or sixth maintenance interface user authentication method, as the allowable use time in the step (e), an allowable use time designated in the user authentication information setting request sent from the server device may be used, or an allowable use time reference value prestored in the client devices may be used. Alternatively, when an allowable use time is designated in the user authentication information setting request sent from the server device, the designated allowable use time may be used as the allowable use time in the step (e), and when the allowable use time is not designated, an allowable use time reference value prestored in the client devices may be used as the allowable use time.

A seventh maintenance interface user authentication method according to the invention in a client/server type distribution system is the first or second maintenance interface user authentication method designed in such a way as to further include (e) a step in which each of the client devices nullifies the user authentication information set in the user authentication section and forcibly disables use of a user who is currently using the maintenance interface when an allowable number of log-in events has taken place since setting of the user authentication information in the user authentication section. This can guarantee security against a malignant user who repeats illegitimate log-in and log-out.

In the seventh maintenance interface user authentication method, as the allowable number of log-in events in the step (e), an allowable number of log-in events designated in the user authentication information setting request sent from the server device may be used, or an allowable-number-of-log-in reference value prestored in the client devices may be used. When an allowable number of log-in events is designated in the user authentication information setting request sent from the server device, the designated allowable number of log-in events may be used as the allowable number of log-in events in the step (e), and when the allowable number of log-in events is not designated, an allowable-number-of-log-in reference value prestored in the client devices may be used as the allowable number of log-in events.

An eighth maintenance interface user authentication method according to the invention in a client/server type distribution system is the first or second maintenance interface user authentication method designed in such a way as to further include (e) a step in which each of the client devices nullifies the user authentication information set in the user authentication section at a time a user of the maintenance interface ends use of the maintenance interface. This can close the maintenance interface at the same time as a maintenance work is finished, making it possible to guarantee security of the maintenance interface of each client device.

A first server device according to the invention is to be connected to a plurality of client devices over a network, and comprises a request receiving section which receives from a server-side console a user authentication information setting request including user authentication information, which is set in user authentication section for authenticating a user at a time the client devices use a maintenance interface, and designation of the client devices and a nullification-of-user-authentication-information-setting request including designation of the client devices; and a request transfer section which transfers the user authentication information setting request and the nullification-of-user-authentication-information-setting request, received by the request receiving section, to those of the client devices which are designated over the network.

In the first server device, user authentication information for guaranteeing security for the maintenance interfaces of a plurality of client devices can be set remotely from the server-side console over a network and user authentication information already set can be nullified remotely from the server-side console over the network, so that the server side can manage the security for all the maintenance interfaces of the individual client devices.

A second server device according to the invention is the first server device further has an encryption section which encrypts the user authentication information in the user authentication information setting request to be transferred by the request transfer section. This can prevent leakage of user authentication information for opening the maintenance interfaces of the client devices over the network, thus ensuring security.

A third server device according to the invention is the first server device, wherein each of the client devices has a structure for transmitting the allowable use time to be set in use time management section, which nullifies the user authentication information set in the user authentication section and forcibly disables use of a user who is currently using the maintenance interface when an allowable use time has elapsed since setting of the user authentication information in the user authentication section, in such a way as to be included in the user authentication information setting request. Accordingly, an allowable use time which is used to prevent the maintenance interface of each client device from being open over a long period of time and the jeopardy of malignant accesses from becoming greater can be set in each client device remotely from the server device.

A fourth server device according to the invention is the first server device, wherein each of the client devices has a structure for transmitting the allowable number of log-in events to be set in a log-in number management section, which nullifies the user authentication information set in the user authentication section and forcibly disables use of a user who is currently using the maintenance interface when an allowable number of log-in events has taken place since setting of the user authentication information in the user authentication section, in such a way as to be included in the user authentication information setting request. Accordingly, the allowable number of log-in events to guarantee security against a malignant user who repeats illegitimate log-in and log-out can be set remotely from the server device.

A first client device according to the invention is to be connected to a server device over a network, and comprises a user authentication section which authenticates a user at a time of using a maintenance interface; and a remote request processing section which sets user authentication information, included in a user authentication information setting request, in the user authentication section when receiving the user authentication information setting request including the user authentication information from the server device over the network, and nullifies the user authentication information set in the user authentication section when receiving the nullification-of-user-authentication-information-setting request from the server device over the network.

In the first client device, user authentication information for guaranteeing security for the maintenance interfaces of a plurality of client devices can be set remotely from the server-side console over a network and user authentication information already set can be nullified remotely from the server-side console over the network, so that the server side can manage the security for all the maintenance interfaces of the client devices.

A second client device according to the invention is the first client device which has such a structure that setting of the user authentication information in the user authentication section can be done only by the user authentication information setting request received from the server device. This can allow the maintenance interfaces of the individual client devices to be opened only from the server device, thus ensuring better security.

A third client device according to the invention is the first or second client device which further includes a decryption section which decrypts encrypted user authentication information in the user authentication information setting request received from the server device over the network. This can prevent leakage of user authentication information for opening the maintenance interfaces of the client devices over the network, thus ensuring security.

A fourth client device according to the invention is the first or second client device which further comprises a cutoff enforcement section which forcibly disables use of a user who is currently using the maintenance interface in case where that user authentication information which is already set in the user authentication section is set again by a new user authentication information setting request received over the network. Accordingly, in case where a malignant access is made through the maintenance interface of a client device, the access can be inhibited immediately by remote control from the server device and at the same time user authentication information which is used in intrusion can be nullified and new user authentication information can be set again for the normal maintenance.

A fifth client device according to the invention is the first or second client device which further comprises a use time management section which nullifies the user authentication information set in the user authentication section and forcibly disables use of a user who is currently using the maintenance interface when an allowable use time has elapsed since setting of the user authentication information in the user authentication section. This can prevent the maintenance interface of each client device from being open over a long period of time which would increase the jeopardy of malignant accesses.

A sixth client device according to the invention is the fifth client device which further comprises a use time extending section which extends a remaining use time of the use time management section by a predetermined extension time only for first log-in since opening of the maintenance interface. With this structure, therefore, even if it takes a little while for a maintenance worker to actually use the maintenance interface a client device after opening the maintenance interface of the client device and the worker logs in when the remaining use time is short, the worker can do a sufficient maintenance work. What is more, as extension of the use time can be permitted only at the time of the first log-in, security can be guaranteed.

A seventh client device according to the invention is the first or second client device which further comprises a log-in number management section which nullifies the user authentication information set in the user authentication section and forcibly disables use of a user who is currently using the maintenance interface when an allowable number of log-in events has taken place since setting of the user authentication information in the user authentication section. This can guarantee security against a malignant user who repeats illegitimate log-in and log-out.

An eighth client device according to the invention is the first or second client device which further comprises a authentication nullification section which nullifies the user authentication information set in the user authentication section at a time a user of the maintenance interface ends use of the maintenance interface. This can close the maintenance interface at the same time as a maintenance work is finished, making it possible to guarantee security of the maintenance interface of each client device.

As described above, the invention can remotely control the setting and nullification of user authentication information for guaranteeing security for the maintenance interfaces of a plurality of client devices remotely from the server-side, thus ensuring both guaranteeing of security and easier maintenance.

As user authentication information to be transferred to a client device from the server device over a network, firmer security can be achieved.

The time over which user authentication information is valid after being set in a client device, i.e., the allowable use time for the maintenance interface is introduced and user authentication information is nullified automatically after the allowable use time elapses, so that it is possible to prevent the maintenance interface of each client device from being open over a long period of time which would increase the danger of malignant accesses. Particularly, in the structure where when the allowable use time is designated from the server device, that time is used, and when the allowable use time is not designated, the allowable use time reference value stored in a client device is used, the allowable use time can be determined freely by a system manager. Even in case where one forgets to designate the allowable use time, for example, it is possible to prevent the maintenance interface of each client device from being kept open over a long period of time which would increase the danger of malignant accesses.

As the use time is extended automatically only at the time of the first log-in, it is possible to permit a maintenance worker who has logged in later to do a maintenance work without hindrance while guaranteeing security.

When the number of log-in events since opening of the maintenance interface reaches a predetermined allowable number of log-in events, the logged-in access is stopped and the user authentication information is nullified. This can prevent frequent attacks by a malignant person who frequently repeats log-in and log-out.

As the user authentication information is automatically nullified in response to an end-of-user-authentication-information-setting notification input from a maintenance interface worker who has finished a maintenance work, it is possible to prevent the maintenance interface of a client device from being open over a long period of time and the jeopardy of malignant accesses from becoming greater.

### BRIEF DESCRIPTION OF THE DRAWINGS

FIG. 1 is a block diagram of a client/server type distribution system according to a first embodiment of the invention;

FIG. 2 is a flowchart illustrating an example of a process done by a server device at the time a user authentication information setting request is input from a server-side local maintenance console in the first embodiment of the invention;

FIG. 3 is a flowchart illustrating an example of a process done by a server device at the time a nullification-of-user-authentication-information-setting request is input from the server-side local maintenance console in the first embodiment of the invention;

FIG. 4 is a flowchart illustrating an example of a process done by a client device at the time an instruction to set user authentication information is sent over a LAN from a server device in the first embodiment of the invention;

FIG. 5 is a flowchart illustrating an example of a process done by a client device at the time an instruction to nullify user authentication information is sent over the LAN from the server device in the first embodiment of the invention;

FIG. 6 is a flowchart illustrating an example of a process done by a client device at the time an instruction to set user authentication information is input from a client-side local maintenance console in the first embodiment of the invention;

FIG. 7 is a flowchart illustrating an example of a process done by a client device at the time a nullification-of-user-authentication-information-setting request is input from the client-side local maintenance console in the first embodiment of the invention;

FIGS. 8A and 8B are flowcharts illustrating an example of a process done by a client device at the time a log-in request including designation of a user name and password is sent over a LAN from a remote maintenance console in the first embodiment of the invention;

FIG. 9 is a flowchart illustrating an example of a process done by a client device at the time a log-out request is sent over the LAN from the logged-in remote maintenance console in the first embodiment of the invention;

FIGS. 10A to 10C are sequence charts illustrating an operational example of the first embodiment of the invention;

FIGS. 11A to 11C are sequence charts illustrating an operational example of the first embodiment of the invention;

FIG. 12 is a block diagram of a client/server type distribution system according to a second embodiment of the invention;

FIG. 13 is a block diagram of a client/server type distribution system according to a third embodiment of the invention;

FIG. 14 is a flowchart illustrating an example of a process done by a server device at the time a user authentication information setting request is input from a server-side local maintenance console in the third embodiment of the invention;

FIG. 15 is a flowchart illustrating an example of a process done by a client device at the time an instruction to set user authentication information is sent over a LAN from a server device in the third embodiment of the invention;

FIG. 16 is a sequence chart illustrating an operational example of the third embodiment of the invention;

FIG. 17 is a block diagram of a client/server type distribution system according to a fourth embodiment of the invention;

FIGS. 18A and 18B are flowcharts illustrating an example of a process done by a client device at the time an instruction to set user authentication information is sent over a LAN from a server device in the fourth embodiment of the invention;

FIGS. 19A to 19C are sequence charts illustrating an operational example of the fourth embodiment of the invention;

FIG. 20 is a block diagram of a client/server type distribution system according to a fifth embodiment of the invention;

FIG. 21 is a flowchart illustrating an example of a process done by a server device at the time a user authentication information setting request is input from a server-side local maintenance console in the fifth embodiment of the invention;

FIGS. 22A and 22B are flowcharts illustrating an example of a process done by a client device at the time an instruction to set user authentication information is sent over a LAN from a server device in the fifth embodiment of the invention;

FIG. 23 is a flowchart illustrating an example of a process after a use time management section in the fifth embodiment of the invention has started managing the use time;

FIGS. 24A and 24B are sequence charts illustrating an operational example of the fifth embodiment of the invention;

FIG. 25 is a block diagram of a client/server type distribution system according to a sixth embodiment of the invention;

FIG. 26 is a flowchart illustrating an example of a process done by a server device at the time a user authentication information setting request is input from a server-side local maintenance console in the sixth embodiment of the invention;

FIGS. 27A and 27B are flowcharts illustrating an example of a process done by a client device at the time an instruction to set user authentication information is sent over a LAN from a server device in the sixth embodiment of the invention;

FIGS. 28A and 28B are flowcharts illustrating an example of a process done by a client device at the time a log-in request including designation of a user name and password is sent over a LAN from a remote maintenance console in the sixth embodiment of the invention;

FIGS. 29A and 29B are sequence charts illustrating an operational example of the sixth embodiment of the invention;

FIG. 30 is a block diagram of a client/server type distribution system according to a seventh embodiment of the invention;

FIG. 31 is a flowchart illustrating an example of a process done by a server device at the time a user authentication information setting request is input from a server-side local maintenance console in the seventh embodiment of the invention;

FIGS. 32A to 32C are flowcharts illustrating an example of a process done by a client device at the time an instruction to set user authentication information is sent over a LAN from a server device in the seventh embodiment of the invention;

FIG. 33 is a block diagram of a client/server type distribution system according to an eighth embodiment of the invention;

FIGS. 34A and 34B are flowcharts illustrating an example of a use time extending section in the first embodiment of the invention;

FIGS. 35A and 35B are sequence charts illustrating an operational example of the eighth embodiment of the invention;

FIG. 36 is a block diagram of a client/server type distribution system according to a ninth embodiment of the invention; and

FIGS. 37A and 37B are sequence charts illustrating an operational example of the ninth embodiment of the invention.

### DETAILED DESCRIPTION OF THE PREFERRED EMBODIMENTS

Preferred embodiments of the invention are described below with reference to the accompanying drawings.

First Embodiment of the Invention

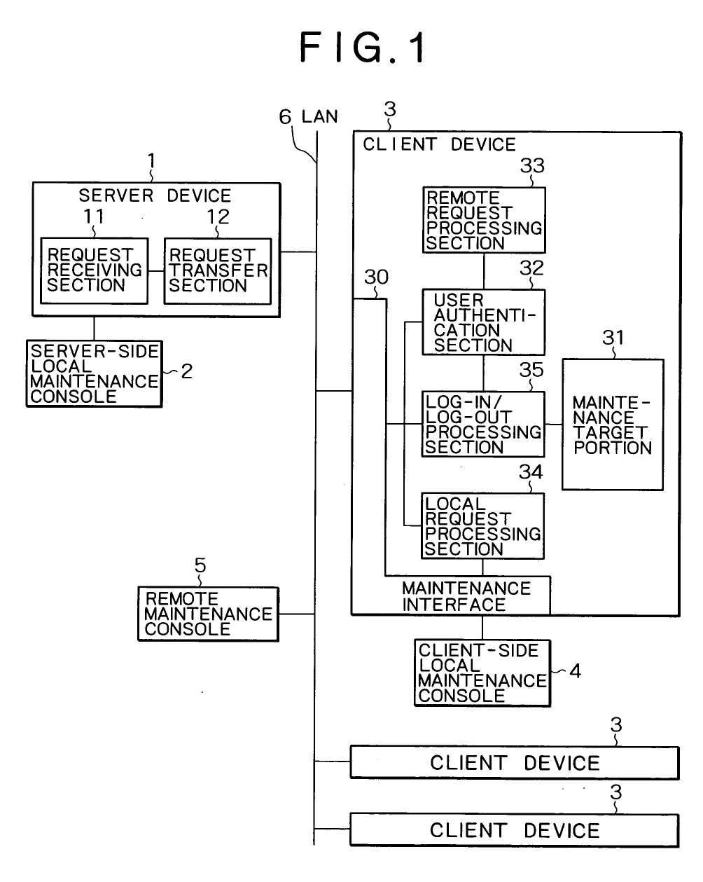

Referring to FIG. 1, a client/server type distribution system according to the first embodiment of the invention has a server device 1, a plurality of client devices 3 and a remote maintenance console 5 connected together over a LAN 6 in a mutually communicatable manner. A local maintenance console 2 is connected to the server device 1 via a serial interface or so, and a local maintenance console 4 is connected to each client device 3. Hereinafter, the local maintenance console that is connected to the server device 1 is called “server-side local maintenance console”, and the local maintenance console that is connected to the client device 3 is called “client-side local maintenance console”. The client-side local maintenance console 4 is temporarily sited in a work period or so for the client device 3 to set or change system data of the client device 3 and need not be connected during system operation. The server-side local maintenance console 2 monitors a failure in and the processing performance of the client devices 3 and set and change system data thereof, and is connected when needed during system operation. In case where the invention is adapted to a client/server type IP-PBX which is a VoIP system, for example, the server device 1 is equivalent to an MGC (Media Gateway Controller) which performs call control in the IP-PBX, and the server-side local maintenance console 2 is equivalent to a console connected to the MGC. The client device 3 is equivalent to an MG (Media Gateway) which connects to a public telephone network or so, an MC (Media Converter) which retains a telephone or an IP phone, and the client-side local maintenance console 4 is equivalent to a console connected thereto. It should be noted that the application of the invention is not limited to a client/server type IP-PBX.

The server device 1 includes a request receiving section 11 which receives a user authentication information setting request and a nullification-of-user-authentication-information-setting request both designating a client device 3 from the server-side local maintenance console 2, and a request transfer section 12 which transfers a request received by the request receiving section 11 to the designated client device 3 over the LAN 6.

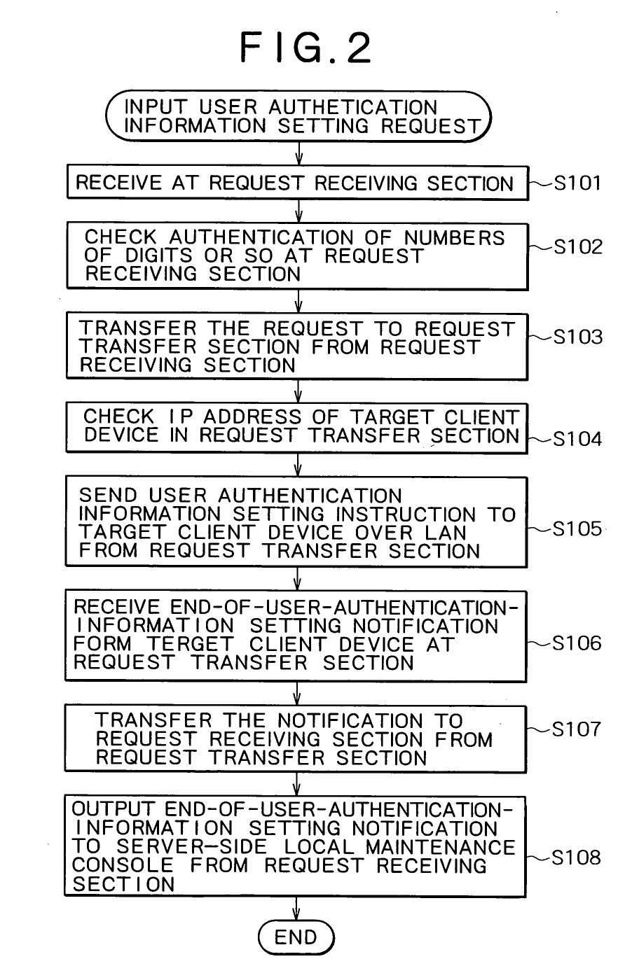

FIG. 2 is a flowchart illustrating an example of a process done by the server device 1 at the time a user authentication information setting request is input from a server-side local maintenance console 2. When a system manager or so inputs a user authentication information setting request including information designating a client device 3 where user authentication information is to be set (e.g., a client device name to specifically identify a client device) and a user name and password as user authentication information to be set from the server-side local maintenance console 2, the request receiving section 11 receives the request (S101) and checks the authentication of the numbers of digits or so of the user name and password (S102). In case where the numbers of digits or so do not meet a predetermined condition, the request is denied. When the user name and password are checked OK, the request receiving section 11 transfers the received user authentication information setting request to the request transfer section 12 (S103). Next, the request transfer section 12 checks the IP address of the client device 3 designated in the user authentication information setting request by referring to, for example, a correlation table (not shown) or so of client device names and IP addresses (S104), and sends a user authentication information setting instruction including the user name and password in the user authentication information setting request to the target client device 3 over the LAN 6 using the IP address (S105). When an end-of-user-authentication-information-setting notification is returned from the target client device 3, the request receiving section 11 receives the notification (S106) and transfers it to the request receiving section 11 (S107), and the request receiving section 11 sends the end-of-user-authentication-information-setting notification to the server-side local maintenance console 2 (S108).

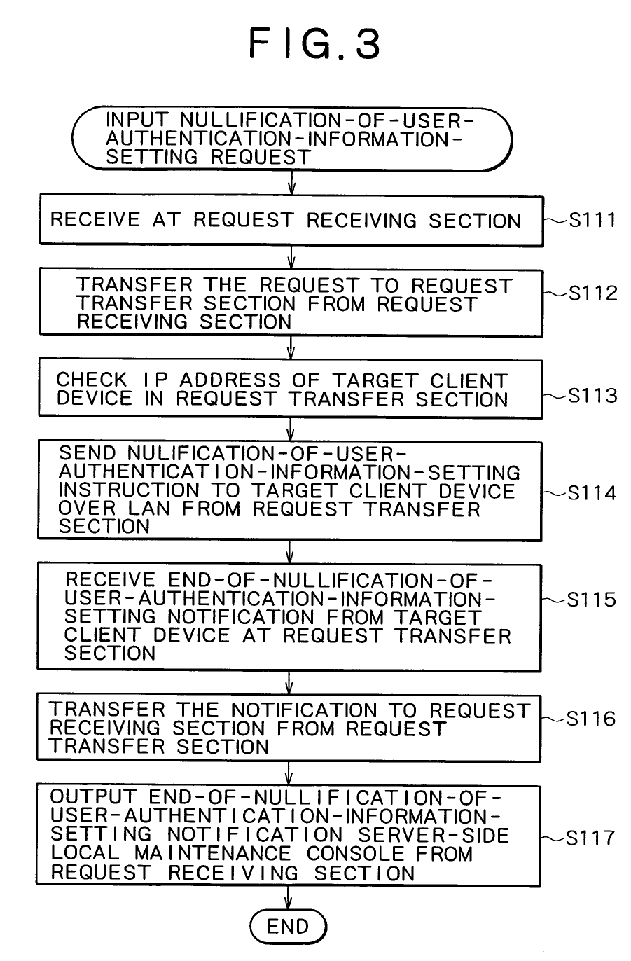

FIG. 3 is a flowchart illustrating an example of a process done by the server device 1 at the time a nullification-of-user-authentication-information-setting request is input from the server-side local maintenance console 2. When a system manager or so inputs a nullification-of-user-authentication-information-setting request designating a client device 3 setting of whose user authentication information is to be nullified from the server-side local maintenance console 2, the request receiving section 11 receives the request (S111) and transfers the received nullification-of-user-authentication-information-setting request to the request transfer section 12 (S112). Next, the request transfer section 12 checks the IP address of the client device 3 designated in the nullification-of-user-authentication-information-setting request (S113), and sends a nullification-of-user-authentication-information-setting instruction to the target client device 3 over the LAN 6 using the IP address (S114). When an end-of-nullification-of-user-authentication-information-setting notification is returned from the target client device 3, the request receiving section 11 receives the notification (S115) and transfers it to the request receiving section 11 (S116), and the request receiving section 11 sends the end-of-nullification-of-user-authentication-information-setting notification to the server-side local maintenance console 2 (S117).

Each client device 3 has a maintenance interface 30 which is typified by a Telnet interface, and includes a maintenance target portion 31 to be subjected to maintenance, a user authentication section 32, a remote request processing section 33, a local request processing section 34 and a log-in/log-out processing section 35. The user authentication section 32 preforms user authentication on a user who maintains the maintenance target portion 31 based on authentication information. The remote request processing section 33 receives a user authentication information setting request and a nullification-of-user-authentication-information-setting request, sent from the server device 1 over the LAN 6, and executes processes according to the requests. The local request processing section 34 receives the user authentication information setting request and nullification-of-user-authentication-information-setting request input from the client-side local maintenance console 4 and executes processes according to the requests. The maintenance target portion 31 is, for example, a memory which stores the operational status and failure status of hardware and software, constituting the client device 3, and various kinds of system setting data, software itself or the like. The maintenance of the maintenance target portion 31 is reference to the operational status and failure status stored in the memory, and an operation for, for example, alteration of the system setting data and software.

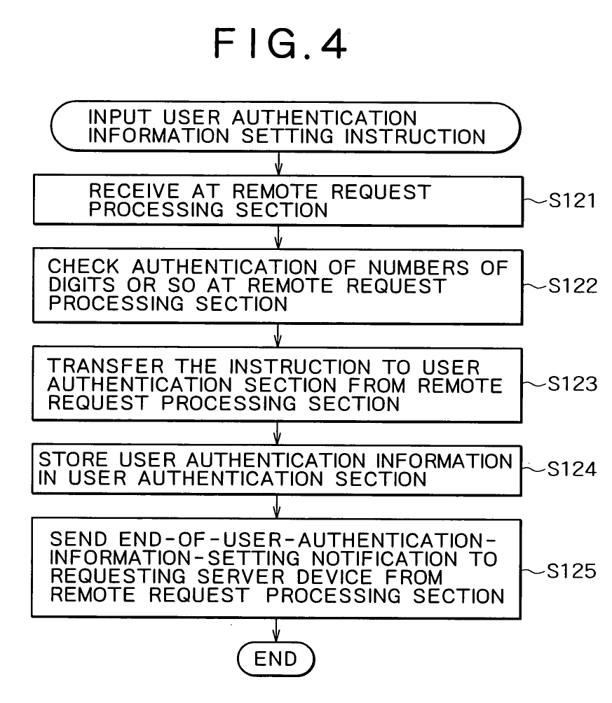

FIG. 4 is a flowchart illustrating an example of a process done by the client device 3 at the time a user authentication information setting instruction is sent over the LAN 6 from the server device 1. The client device 3 to which the user authentication information setting instruction is sent over the LAN 6 receives the instruction at the remote request processing section 33 (S121), and checks if the user name and password in the instruction meet predetermined numbers of digits (S122). If they do not meet the predetermined numbers of digits, the instruction is denied. When the user name and password are checked OK, the remote request processing section 33 transfers the instruction to the user authentication section 32 (S123). The user authentication section 32 internally stores the user name and password in the transferred instruction (S124). Meanwhile, the remote request processing section 33 sends an end-of-user-authentication-information-setting notification to the requesting server device 1 over the LAN 6 (S125).

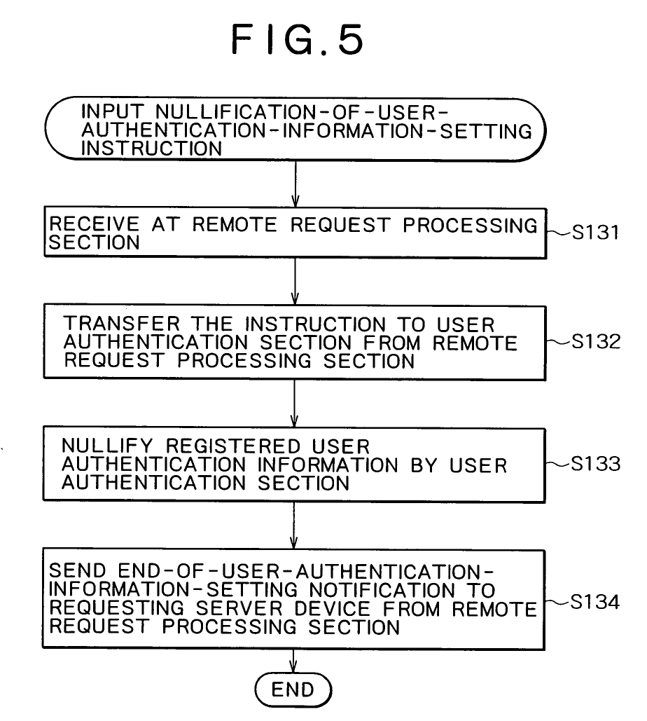

FIG. 5 is a flowchart illustrating an example of a process done by the client device at the time a nullification-of-user-authentication-information-setting instruction is sent over the LAN 6 from the server device 1. The client device 3 to which the nullification-of-user-authentication-information-setting instruction is sent over the LAN 6 receives the instruction at the remote request processing section 33 (S131), and transfers the instruction to the user authentication section 32 (S132). The user authentication section 32 nullifies the user authentication information by erasing the user name and password registered inside (S133). Meanwhile, the remote request processing section 33 sends an end-of-nullification-of-user-authentication-information-setting notification to the requesting server device 1 over the LAN 6 (S134).

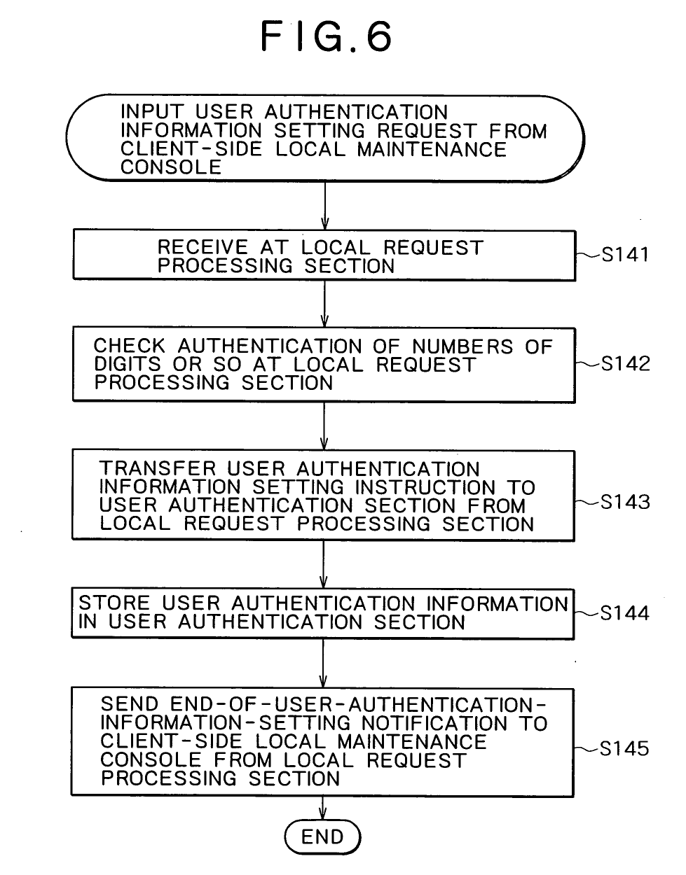

FIG. 6 is a flowchart illustrating an example of a process done by the client device 3 at the time a user authentication information setting request is input from the client-side local maintenance console 4. When a system manager or so inputs a user name and password as user authentication information to be set from the client-side local maintenance console 4, the local request processing section 34 receives the request (S141) and checks if the user name and password in the request satisfy predetermined numbers of digits (S142). If the numbers of digits do not meet a predetermined condition, the request is denied. When the user name and password are checked OK, the local request processing section 34 transfers a user authentication information setting instruction including the user name and password in the request to the user authentication section 32 (S143). The user authentication section 32 internally stores the user name and password in the transferred instruction (S144). Meanwhile, the local request processing section 34 sends an end-of-user-authentication-information-setting notification to the client-side local maintenance console 4 (S145).

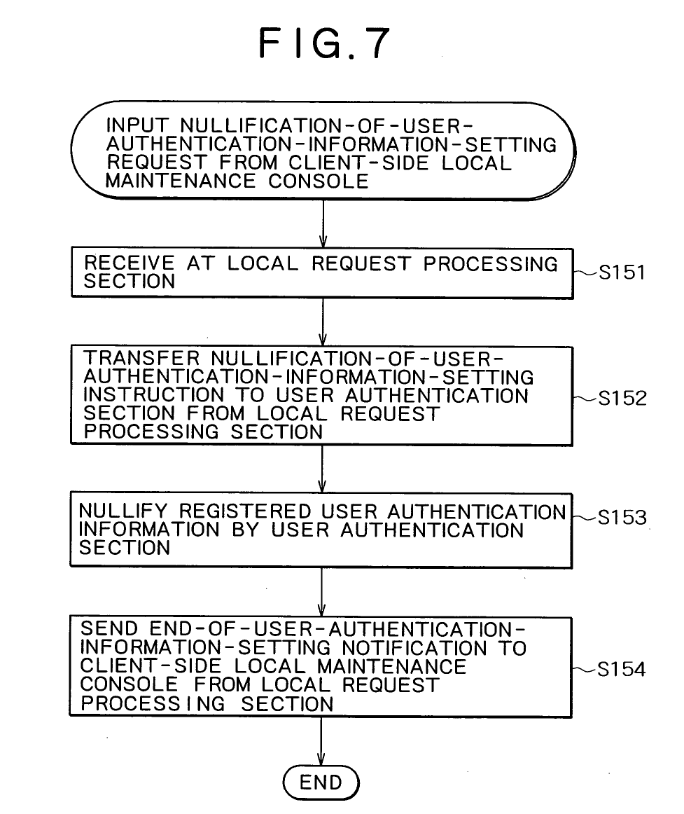

FIG. 7 is a flowchart illustrating an example of a process done by the client device 3 at the time a nullification-of-user-authentication-information-setting request is input from the client-side local maintenance console 4. When a system manager or so inputs a nullification-of-user-authentication-information-setting request to nullify the set user authentication information from the client-side local maintenance console 4, the local request processing section 34 receives the request (S151) and transfers it to the user authentication section 32 (S152). The user authentication section 32 nullifies the user authentication information by, for example, erasing the user name and password registered inside (S153). Meanwhile, the local request processing section 34 sends an end-of-nullification-of-user-authentication-information-setting notification to the client-side local maintenance console 4 (S154).

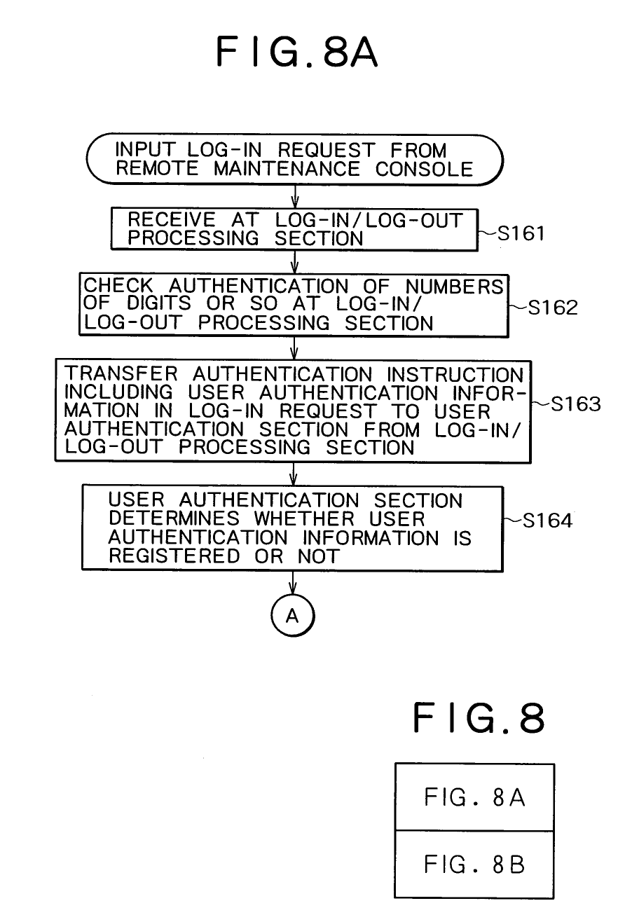

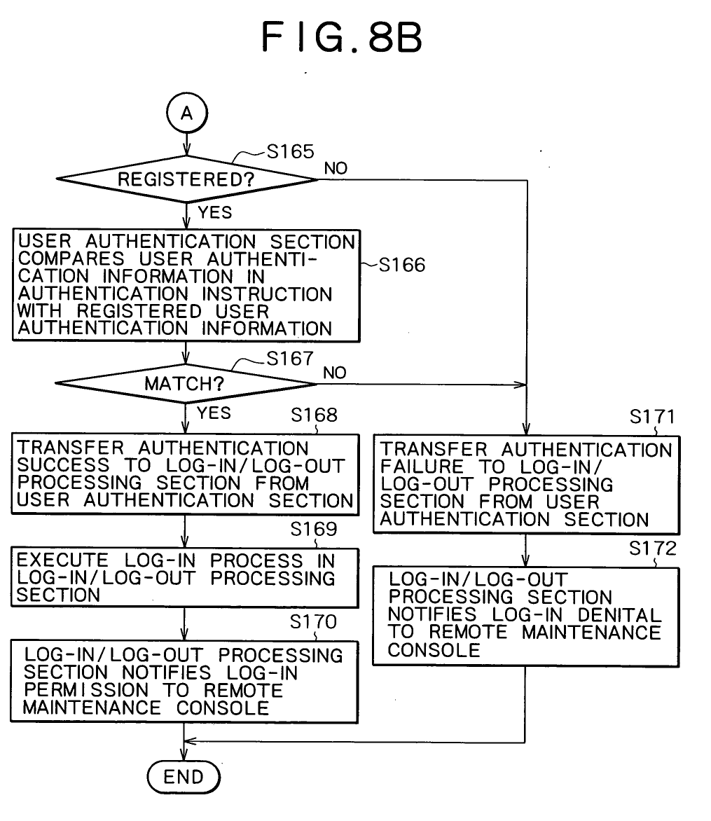

FIGS. 8A and 8B are flowcharts illustrating an example of a process done by the client device 3 at the time a log-in request including designation of a user name and password is sent over the LAN 6 from the remote maintenance console 5. The client device 3 to which a log-in request is sent over the LAN 6 receives the log-in request at the log-in/log-out processing section 35 (S161), and checks if the user name and password in the log-in request satisfy predetermined numbers of digits or so (S162). If the numbers of digits or so do not meet a predetermined condition, the log-in request is denied. When the user name and password are checked OK, the log-in/log-out processing section 35 transfers an authentication instruction designating the user name and password in the log-in request to the user authentication section 32 (S163). The user authentication section 32 determines whether the internal user authentication information has been registered beforehand or not (S164). When the user authentication information has been registered beforehand (YES in S165), the user authentication section 32 compares the user name and password in the authentication instruction transferred from the log-in/log-out processing section 35 with the user name and password registered inside (S166). When both match each other (YES in S167), the user authentication section 32 sends an authentication success to the log-in/log-out processing section 35 (S168). The log-in/log-out processing section 35 executes a log-in process for permitting an access to the maintenance target portion 31 from the remote maintenance console 5 (S169) and notifies the permission of log-in to the remote maintenance console 5 (S170). Thereafter, a maintenance worker can access the maintenance target portion 31 of the client device 3 over the LAN 6 from the remote maintenance console 5.

If it is determined that the user authentication information has not been registered beforehand (NO in S165) or that the user authentication information has been registered but the user name and password in the authentication instruction do not match with the registered user name and password (NO in S167), the user authentication section 32 sends an authentication failure to the log-in/log-out processing section 35 (S171) and the log-in/log-out processing section 35 notifies denial of log-in to the remote maintenance console 5 (S171).

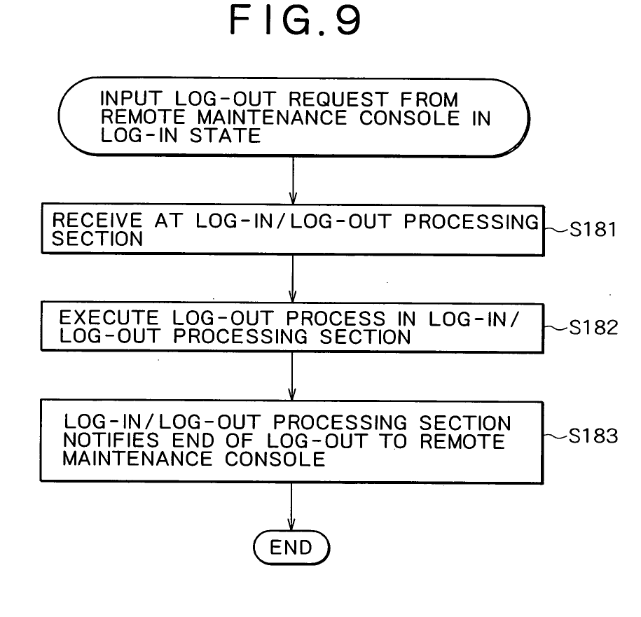

FIG. 9 is a flowchart illustrating an example of a process done by the client device 3 at the time a log-out request including designation of a user name and password is sent over the LAN 6 from the remote maintenance console 5. The client device 3 to which a log-in request is sent over the LAN 6 receives the log-out request at the log-in/log-out processing section 35 (S181), and executes a log-out process to inhibit a subsequent access to the maintenance target portion 31 from the remote maintenance console 5 (S182). Then, the log-in/log-out processing section 35 sends a log-out end notification to the remote maintenance console 5 (S183).

The operation of the embodiment is described next.

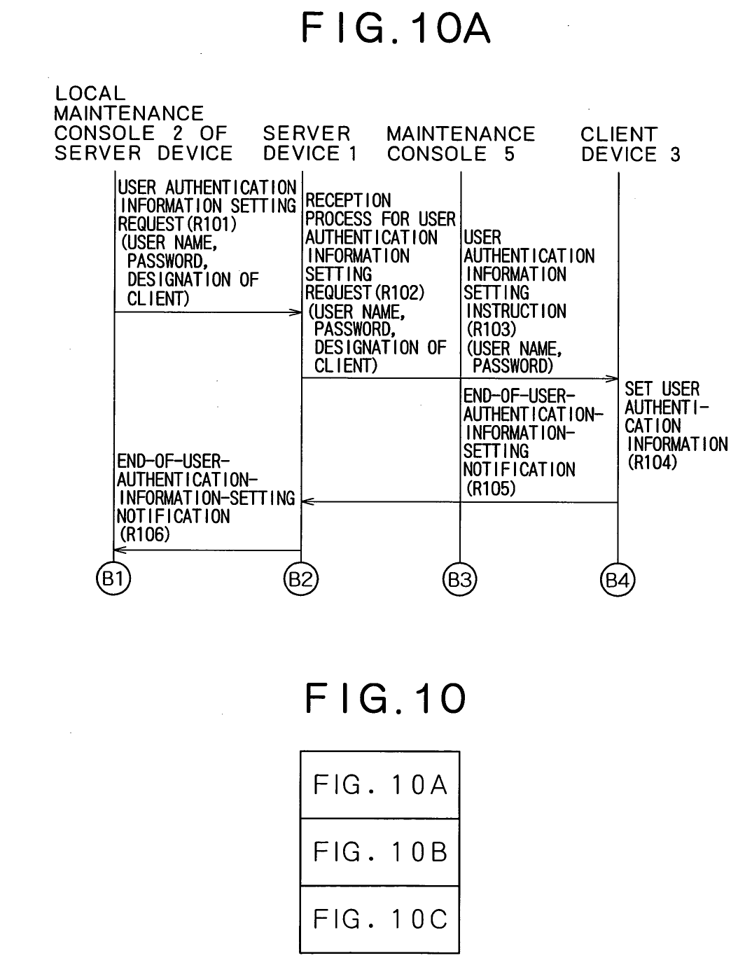

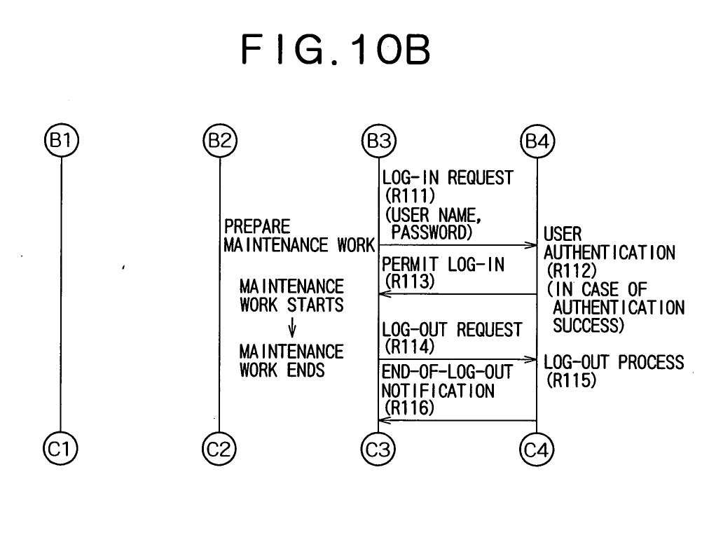

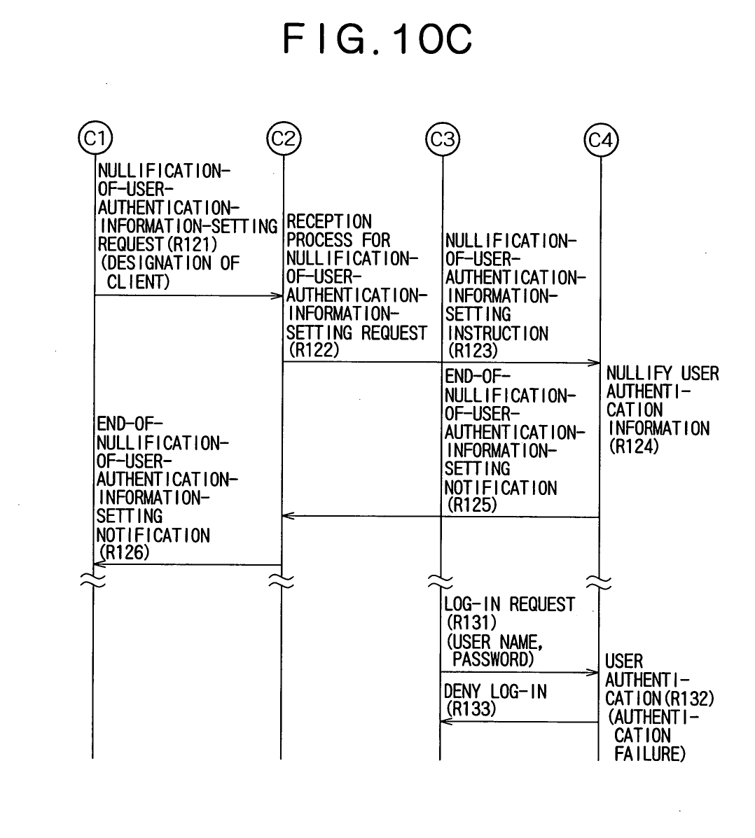

FIGS. 10A to 10C are sequence charts illustrating an operational example of the embodiment showing sequences for the following four cases.

(1) Setting of user authentication information in the client device 3 from the server-side local maintenance console 2

(2) Log-in and log-out to and from the client device 3 by the remote maintenance console 5 after registration of user authentication information

(3) Nullification of user authentication information to the client device 3 from the server-side local maintenance console 2

(4) Log-in to the client device 3 by the remote maintenance console 5 after nullification of user authentication information

The operation of the embodiment is described below on the four cases.

(1) First, referring to FIGS. 1, 2, 4 and 10, an operation at the time of setting user authentication information in the client device 3 from the server-side local maintenance console 2 is described.

When a system manager or so inputs a user authentication information setting request including a user name and password for releasing the security on the maintenance interface 30 of the client device 3 and designation of the target client device 3 from the server-side local maintenance console 2 (R101 in FIGS. 10A to 10C), the server device 1 executes a process of receiving this request (R102). In this reception process, when the request receiving section 11 performs a process of receiving the user authentication information setting request and a process of checking the authentication of the user name and password (S101 and S102 in FIG. 2). When there is no authentication problem, the request is transferred to the request transfer section 12 (S103 in FIG. 2). Then, the request transfer section 12 acquires the IP address of the client device 3 designated in the user authentication information setting request (S104 in FIG. 2), and sends a user authentication information setting instruction including the user name and password to the remote request processing section 33 of the client device 3 over the LAN 6 (R103 in FIGS. 10A to 10C and S105 in FIG. 2).

The client device 3 receives the user authentication information setting instruction sent from the server device 1 at the remote request processing section 33 (S121 in FIG. 4), and checks the authentication of the user name and password (S122) and transfers the user authentication information setting instruction to the user authentication section 32 if there is no authentication problem (S123). The user authentication section 32 stores the user name and password in the user authentication information setting instruction (R104 in FIGS. 10A to 10C and S124 in FIG. 2). Meanwhile, the remote request processing section 33 sends an end-of-user-authentication-information-setting notification to the request transfer section 12 of the server device 1 over the LAN 6 (R105 in FIGS. 10A to 10C and S125 in FIG. 2). When receiving the end-of-user-authentication-information-setting notification, the request transfer section 12 sends the notification to the server-side local maintenance console 2 through the request receiving section 11 (R106 in FIGS. 10A to 10C and S106 to S108 in FIG. 2).

(2) Referring now to FIGS. 1, 8, 9 and 10, a description is given of an operation at the time the remote maintenance console 5 logs in and logs out from the client device 3 after registration of user authentication information.

After user authentication information comprised of a user name and password is registered in the user authentication section 32 of the client device 3, when a maintenance worker inputs a log-in request designating a user name and password to the client device 3 over the LAN 6 from the remote maintenance console 5 (R111 in FIGS. 10A to 10C), the client device 3 executes a sequence of processes associated with user authentication (R112 in FIGS. 10A to 10C and S161 to S172 in FIGS. 8A and 8B). Specifically, the log-in/log-out processing section 35 receives a log-in request from the remote maintenance console 5 and checks authentication of the log-in (S161 and S162), and sends an authentication instruction including the user name and password in the log-in request to the user authentication section 32 there is no authentication problem (S163). Next, the user authentication section 32 determines whether or not the user authentication information is registered (S164 and S165), and checks if the user name and password in the authentication instruction match with the registered user name and password when the user authentication information is registered (S166 and S167). In the user authentication R112 in FIGS. 10A to 10C, it is assumed that the user authentication information has been registered beforehand and the user name and password designated in the log-in request match with the registered user name and password, resulting in an authentication success. Accordingly, the user authentication section 32 notifies an authentication success to the log-in/log-out processing section 35 (S168) and the log-in/log-out processing section 35 performs a log-in process (S169) and notifies a log-in permission to the remote maintenance console 5 (S170 and R113 in FIGS. 10A to 10C). This can allow the maintenance worker to access the maintenance target portion 31 of the client device 3 from the remote maintenance console 5 and start various kinds of maintenance works.

When the maintenance worker who has finished a maintenance work inputs a log-out request from the remote maintenance console 5 (R114 in FIGS. 10A to 10C), the log-in/log-out processing section 35 of the client device 3 receives the request (S181 in FIG. 9) and executes a log-out process (S182 and R115 in FIGS. 10A to 10C). Then, the log-in/log-out processing section 35 sends a log-out end notification to the remote maintenance console 5 (S183 and R116 in FIGS. 10A to 10C). This inhibits an access to the maintenance target portion 31 of the client device 3 from the remote maintenance console 5. It is to be noted however that as the user name and password are stored in the user authentication section 32 and a log-in request is waited, the maintenance interface 30 of the client device 3 is open. That is, the maintenance interface 30 of the client device 3 is not closed. If the next log-in request comes from the remote maintenance console 5 and the user name and password have a match, resulting in an authentication success, therefore, an access to the maintenance target portion 31 of the client device 3 becomes possible again.

(3) Referring now to FIGS. 1, 3, 5 and 10, a description is given of an operation at the time of nullifying user authentication information registered in the client device 3 from the server-side local maintenance console 2.

When a maintenance worker inputs a nullification-of-user-authentication-information-setting request designating a target client device 3 to secure security by closing the maintenance interface 30 of the client device 3 from the server-side local maintenance console 2 (R121 in FIGS. 10A to 10C), the server device 1 performs a process of receiving the nullification-of-user-authentication-information-setting request (R122). In this reception process, when the request receiving section 11 performs a process of receiving the nullification-of-user-authentication-information-setting request and a process of transferring the received request to the request transfer section 12 (S111 and S112 in FIG. 3). Then, the request transfer section 12 acquires the IP address of the client device 3 designated in the nullification-of-user-authentication-information-setting request (S113 in FIG. 3), and sends a nullification-of-user-authentication-information-setting instruction to the remote request processing section 33 of the client device 3 over the LAN 6 (R123 in FIGS. 10A to 10C and S114 in FIG. 3).

The client device 3 receives the nullification-of-user-authentication-information-setting instruction sent from the server device 1 at the remote request processing section 33 (S131 in FIG. 5), and transfers the nullification-of-user-authentication-information-setting instruction to the user authentication section 32 (S132). The user authentication section 32 nullifies the user authentication information comprised of the registered user name and password (R124 in FIGS. 10A to 10C and S133 in FIG. 5). Meanwhile, the remote request processing section 33 sends an end-of-nullification-of-user-authentication-information-setting notification to the request transfer section 12 of the server device 1 over the LAN 6 (R125 in FIGS. 10A to 10C and S134 in FIG. 5). When receiving the end-of-nullification-of-user-authentication-information-setting notification, the request transfer section 12 sends the notification to the server-side local maintenance console 2 through the request receiving section 11 (R126 in FIGS. 10A to 10C and S115 to S117 in FIG. 3).

(4) Referring now to FIGS. 1, 8 and 10, a description is given of an operation at the time the remote maintenance console 5 makes a log-in request to the client device 3 after nullification of user authentication information.

When a log-in request is input to the client device 3 from the remote maintenance console 5 over the LAN 6 (R131 in FIGS. 10A to 10C), the client device 3 performs a sequence of processes associated with user authentication (R132 in FIGS. 10A to 10C and S161 to S172 in FIGS. 8A and 8B). As the user authentication information is not registered in the user authentication section 32, however, authentication fails (NO in S165 in FIGS. 8A and 8B). Therefore, the log-in/log-out processing section 35 notifies denial of log-in to the remote maintenance console 5 (S172 and R133 in FIGS. 10A to 10C). This inhibits an access to the maintenance target portion 31 of the client device 3 from the remote maintenance console 5. Even in case where a user name and password are registered in the user authentication section 32, if the user name and password designated in the log-in request from the remote maintenance console 5 do not match those registered in the user authentication section 32, the log-in/log-out processing section 35 likewise operates to refuse log-in.

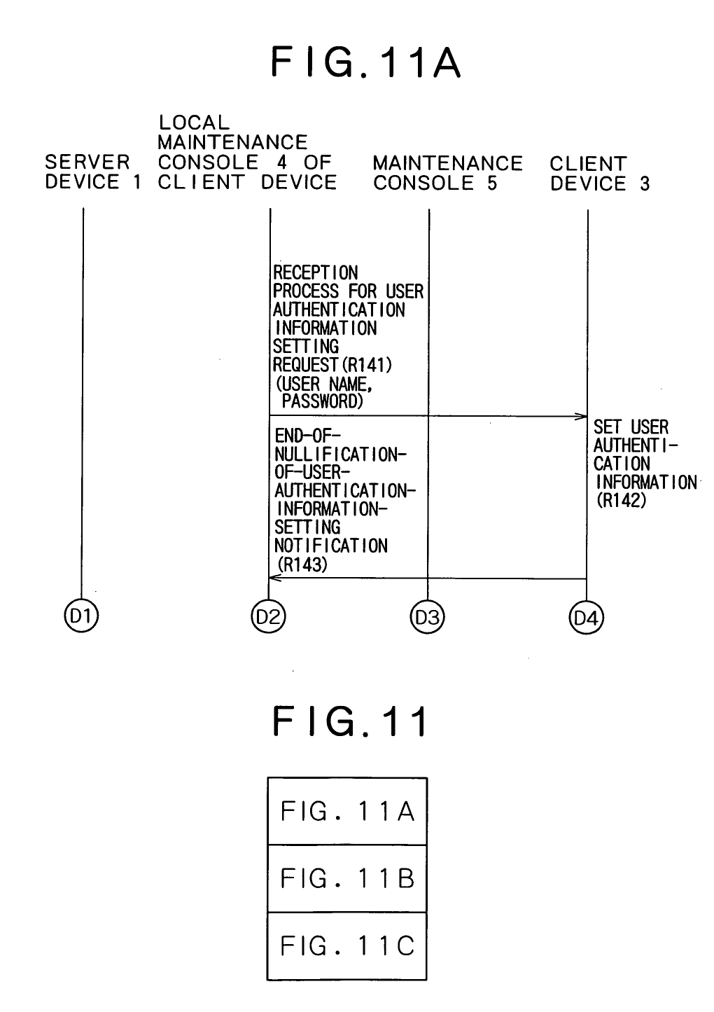

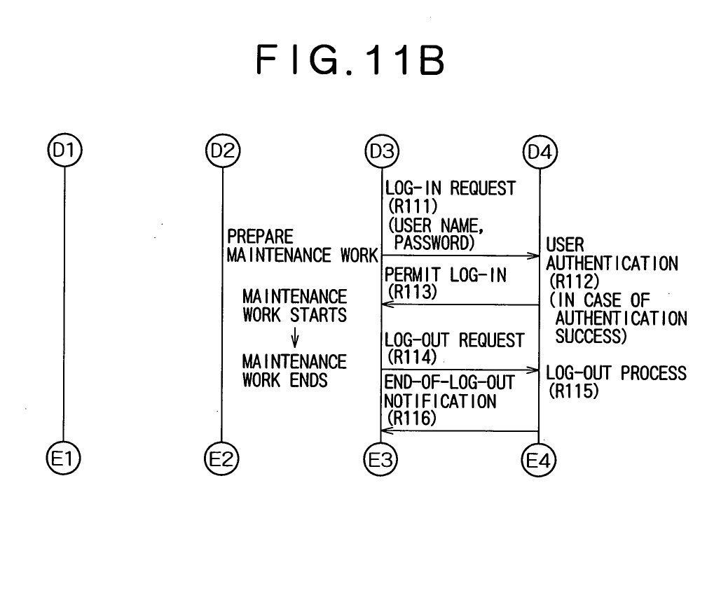

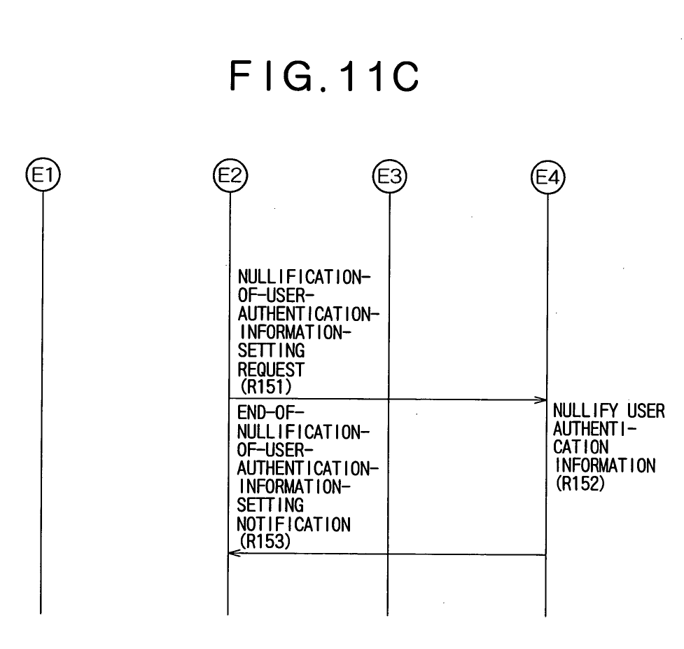

FIGS. 11A to 11C are sequence charts illustrating an operational example of the embodiment showing sequences for the following three cases.

(1) Setting of user authentication information in the client device 3 from the client-side local maintenance console 4

(2) Log-in and log-out to and from the client device 3 by the remote maintenance console 5 after registration of user authentication information

(3) Nullification of user authentication information to the client device 3 from the client-side local maintenance console 4

The operation of the embodiment is described below on the three cases.

(1) To begin with, referring to FIGS. 1, 6 and 11, an operation at the time of setting user authentication information in the client device 3 from the client-side local maintenance console 4 is described.

When a system manager or so inputs a user authentication information setting request including designation of a user name and password for releasing the security on the maintenance interface 30 of the client device 3 from the client-side local maintenance console 4 (R141 in FIGS. 11A to 11C), the client device 3 receives the user authentication information setting request at the remote request processing section 33 (S141 in FIG. 6), and checks the authentication of the user name and password (S142) and transfers the user authentication information setting instruction to the user authentication section 32 if there is no authentication failure (S143). The user authentication section 32 stores the user name and password in the user authentication information setting instruction (R142 in FIGS. 11A to 11C and S144 in FIG. 6). Meanwhile, the local request processing section 34 sends an end-of-user-authentication-information-setting notification to the client-side local maintenance console 4 (R143 in FIGS. 11A to 11C and S145 in FIG. 6).

(2) As the operation at the time the remote maintenance console 5 logs in and logs out from the client device 3 after registration of user authentication information is the same as the sequence R111 to R116 in FIGS. 10A to 10C discussed above, its description is not repeated.

(3) Referring now to FIGS. 1, 7 and 11, a description is given of an operation at the time of nullifying user authentication information registered in the client device 3 from the client-side local maintenance console 4.

When a maintenance worker inputs a nullification-of-user-authentication-information-setting request designating a target client device 3 to secure security by closing the maintenance interface 30 of the client device 3 from the client-side local maintenance console 4 (R151 in FIGS. 11A to 1C), the client device 3 receives this nullification-of-user-authentication-information-setting request at the local request processing section 34 (S151 in FIG. 7) and transfers the nullification-of-user-authentication-information-setting instruction to the user authentication section 32 (S152). The user authentication section 32 nullifies user authentication information comprised of the registered user name and password (R152 in FIGS. 11A to 11C and S153 in FIG. 7). The local request processing section 34 sends the sends an end-of-nullification-of-user-authentication-information-setting notification to the client-side local maintenance console 4 (R153 in FIGS. 11A to 11C and S154 in FIG. 7).

According to this embodiment, as described above, the maintenance interfaces 30 of a plurality of client devices 3 at remote locations can be opened from the server-side local maintenance console 2 and can be closed from the server-side local maintenance console 2. In case where the client-side local maintenance console 4 is connected to each client device 3, the maintenance interface 30 of the client device 3 can be opened and closed from the client-side local maintenance console 4 for each client device.

Second Embodiment of the Invention

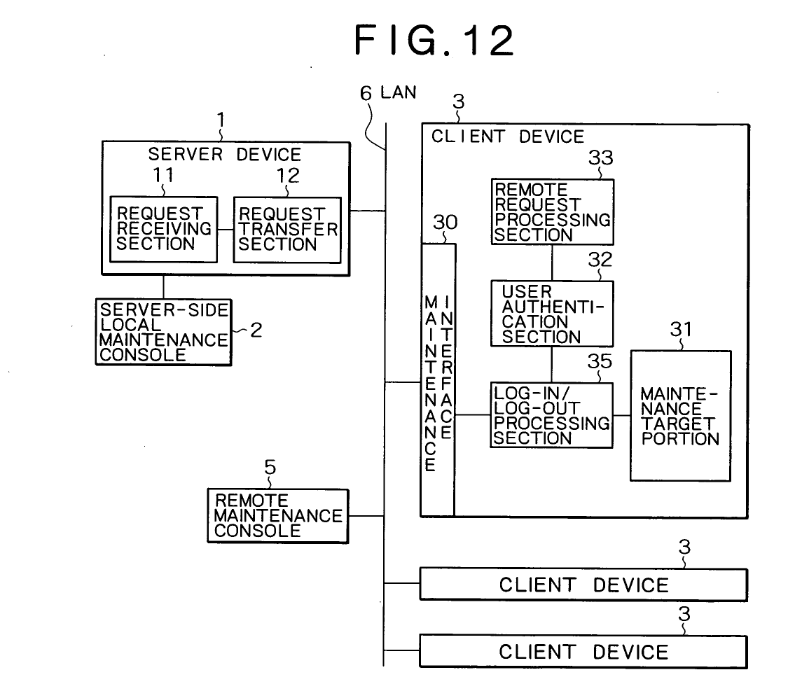

Referring to FIG. 12, a client/server type distribution system according to the second embodiment of the invention differs from the client/server type distribution system according to the first embodiment of the invention illustrated in FIG. 1 in that the local request processing section 34 is eliminated from each client device 3 in the first embodiment to disable setting and nullification of user authentication information into the user authentication section 32 of the client device 3 from the client-side local maintenance console 4, and is identical to the first embodiment in the other points.

In this embodiment, it is possible to set the user authentication information (user name and password) for opening the maintenance interface 30 of the client device 3 over the LAN 6 from the remote maintenance console 5 in the client device 3 over the LAN 6 only from the server-side local maintenance console 2, and to delete user authentication information set in the client device 3 and inhibit the use of the maintenance interface 30 of the client device 3 from the server-side local maintenance console 2.

As opening and closing of the maintenance interfaces 30 of a plurality of client devices 3 can be done only from the server-side local maintenance console 2, the management of the security of the maintenance interface 30 can easily be managed by the system manager of the server device 1.

Third Embodiment of the Invention

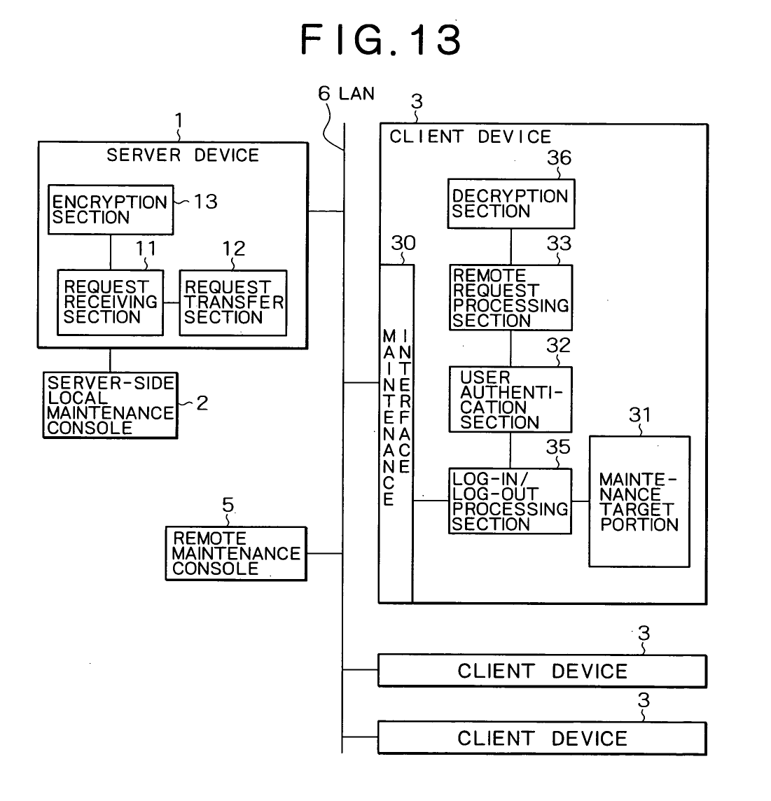

Referring to FIG. 13, a client/server type distribution system according to the third embodiment of the invention differs from the client/server type distribution system according to the second embodiment of the invention illustrated in FIG. 12 in that the server device 1 in the second embodiment has an encryption section 13 for encrypting a user name and password and each client device 3 has a decryption section 36 for decrypting an encrypted user name and password, and is identical to the second embodiment in the other points.

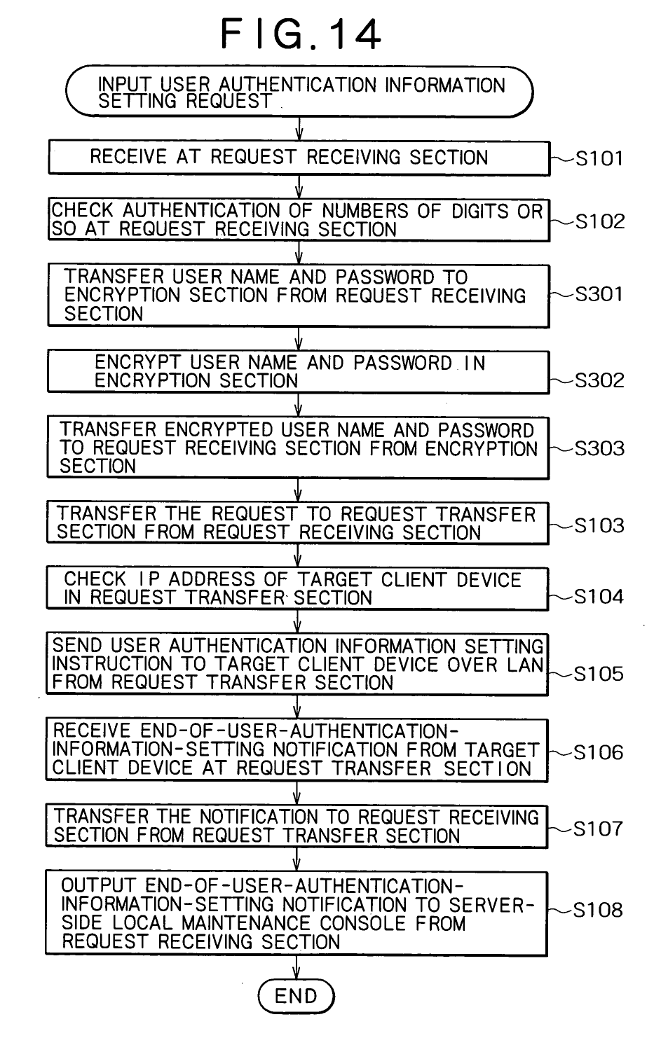

FIG. 14 is a flowchart which illustrates an example of a process done by the server device 1 at the time a user authentication information setting request is input from the server-side local maintenance console 2, and differs from the flowchart in FIG. 3 in that steps S301 to S303 are added. When a system manager or so inputs a user authentication information setting request including information designating a client device 3 where user authentication information is to be set and a user name and password as user authentication information to be set from the server-side local maintenance console 2, the request receiving section 1.1 receives the request (S101) and checks the authentication of the numbers of digits or so of the user name and password (S102). When there is no authentication failure, the request receiving section 11 transfers the user name and password in the received user authentication information setting request to the encryption section 13 (S301). The encryption section 13 encrypts the user name and password by an arbitrary encryption scheme predetermined by the system, such as common-key encryption or private-key encryption (S302) and transfers the encrypted user name and password to the request receiving section 11 (S303). The request receiving section 11 transfers the user authentication information setting request including the encrypted user name and password to the request transfer section 12 (S103). Thereafter, the same processes as have been discussed above referring to FIG. 3 will be executed (S104 to S108).

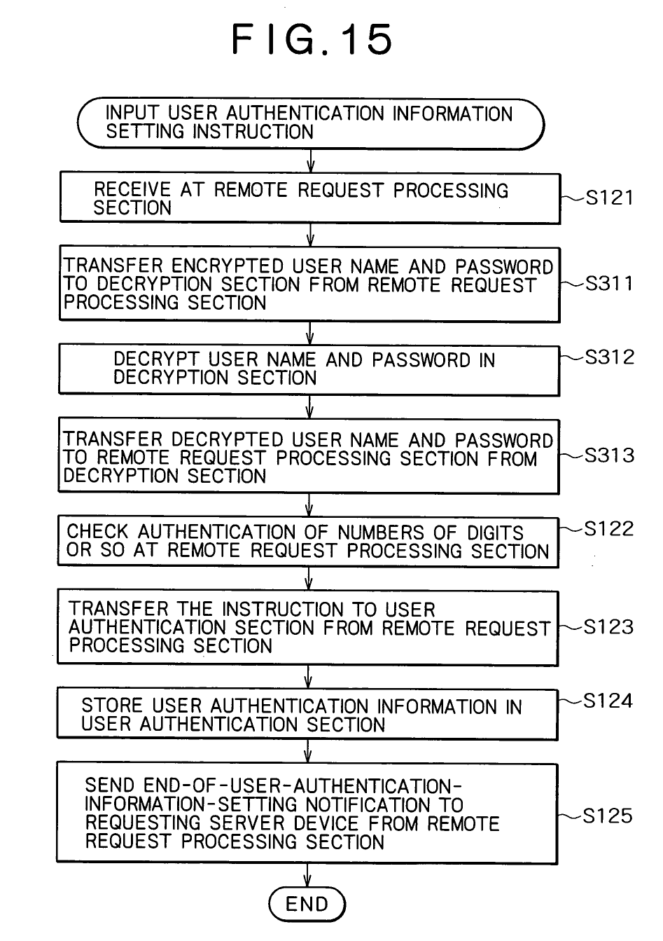

FIG. 15 is a flowchart which illustrates an example of a process done by the client device 3 at the time a user authentication information setting instruction is sent over the LAN 6 from the server device 1 and differs from the flowchart in FIG. 4 in that steps S311 to S313 are added. The client device 3 to which the user authentication information setting instruction is sent over the LAN 6 receives the instruction at the remote request processing section 33 (S121), and transfers the encrypted user name and password to the decryption section 36 (S311). The decryption section 36 decrypts the encrypted user name and password (S312) and transfers them to the remote request processing section 33 (S313). The remote request processing section 33 checks if the user name and password satisfy predetermined numbers of digits (S122), and transfers the instruction to the user authentication section 32 if the check is successful (S123). Thereafter, the same processes as have been discussed above referring to FIG. 4 will be executed (S124 and S125).

The operation of the embodiment is described next.

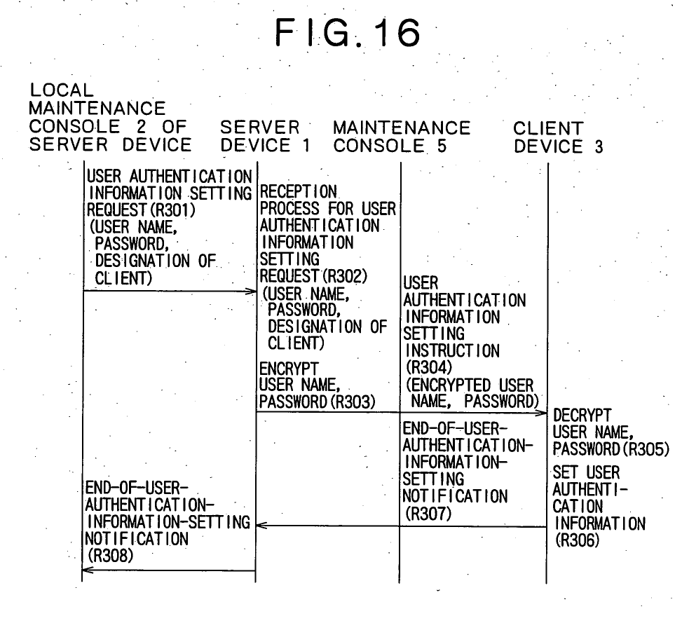

FIG. 16 is a sequence chart illustrating an operational example of the embodiment showing sequences for a case of setting user authentication information in the client device 3 from the server-side local maintenance console 2. Referring to FIGS. 13 to 16, an operation at the time of setting user authentication information in the client device 3 from the server-side local maintenance console 2 is described.

When a system manager or so inputs a user authentication information setting request including a user name and password for releasing the security on the maintenance interface 30 of the client device 3 and designation of the target client device 3 from the server-side local maintenance console 2 (R301 in FIG. 16), the server device 1 executes a process of receiving this request (R302). In this reception process, when the request receiving section 11 performs a process of receiving the user authentication information setting request and a process of checking the authentication of the user name and password (S101 and S102 in FIG. 14). When there is no authentication failure, encryption of the user name and password is performed in the encryption section 13 (R303 in FIG. 14 and S301 to S303 in FIG. 14). Then, the request receiving section 11 transfers the user authentication information setting request including the encrypted user name and password to the request transfer section 12 (S103). Thereafter, the request transfer section 12 acquires the IP address of the client device 3 designated in the user authentication information setting request (S104) and sends a user authentication information setting instruction including the user name and password to the remote request processing section 33 of the client device 3 over the LAN 6 (R304 in FIG. 16 and S105 in FIG. 14).

The client device 3 receives the user authentication information setting instruction, transferred from the server device 1, at the remote request processing section 33 (S121 in FIG. 15) and decrypts the encrypted user name and password included in the instruction using the decryption section 36 (R305 in FIG. 16 and S311 to S313 in FIG. 15). Subsequently, authentication of the decrypted user name and password is checked (S122) and the user authentication information setting instruction is transferred to the user authentication section 32 if there is no authentication failure (S123). The user authentication section 32 stores the user name and password in the user authentication information setting instruction (R306 in FIG. 16 and S124 in FIG. 15). Meanwhile the remote request processing section 33 sends an end-of-user-authentication-information-setting notification to the request transfer section 12 of the server device 1 over the LAN 6 (R307 in FIG. 16 and S125 in FIG. 15). When receiving the end-of-nullification-of-user-authentication-information-setting notification, the request transfer section 12 sends it to the server-side local maintenance console 2 through the request receiving section 11 (R308 in FIG. 16 and S106 to S108 in FIG. 14).

The other operations, such as a sequence of procedures by which a maintenance worker logs in and logs out using the remote maintenance console 5 and a sequence of procedures of nullifying the set user name and password from the server-side local maintenance console 2 are the same as those of the second embodiment.

According to the embodiment, as described above, user authentication information comprised of a user name and password which is transferred between the server device 1 and the client device 3 is encrypted at the time the maintenance interfaces 30 of plural client devices 3 are opened from the server-side local maintenance console 2, leakage of the user authentication information can be prevented, thus ensuring security.

In the embodiment, like in the first embodiment, the client-side local maintenance console 4 in FIG. 1 may be connected to each client device 3 and the local request processing section 34 may be provided in each client device 3.

Fourth Embodiment of the Invention

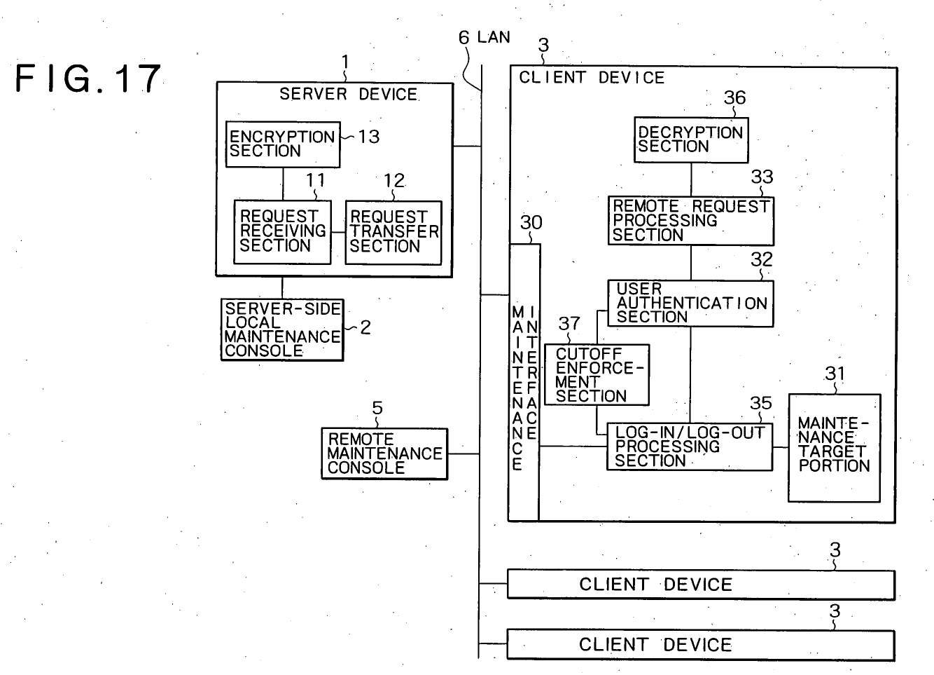

Referring to FIG. 17, a client/server type distribution system according to the fourth embodiment of the invention differs from the client/server type distribution system according to the third embodiment of the invention illustrated in FIG. 13 in that each client device 3 in the third embodiment has a cutoff enforcement section 37 which sends an enforced cutoff notification to, and forcibly cuts off, any device which uses the maintenance interface 30 of the client device 3 at the time setting user authentication information in the user authentication section 32, and is identical to the third embodiment in the other points.

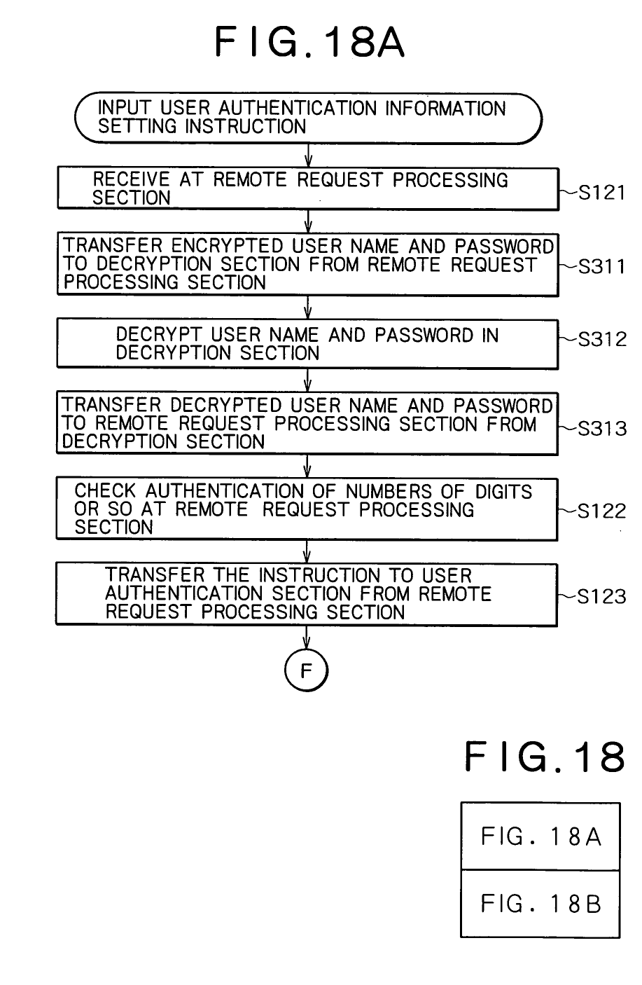

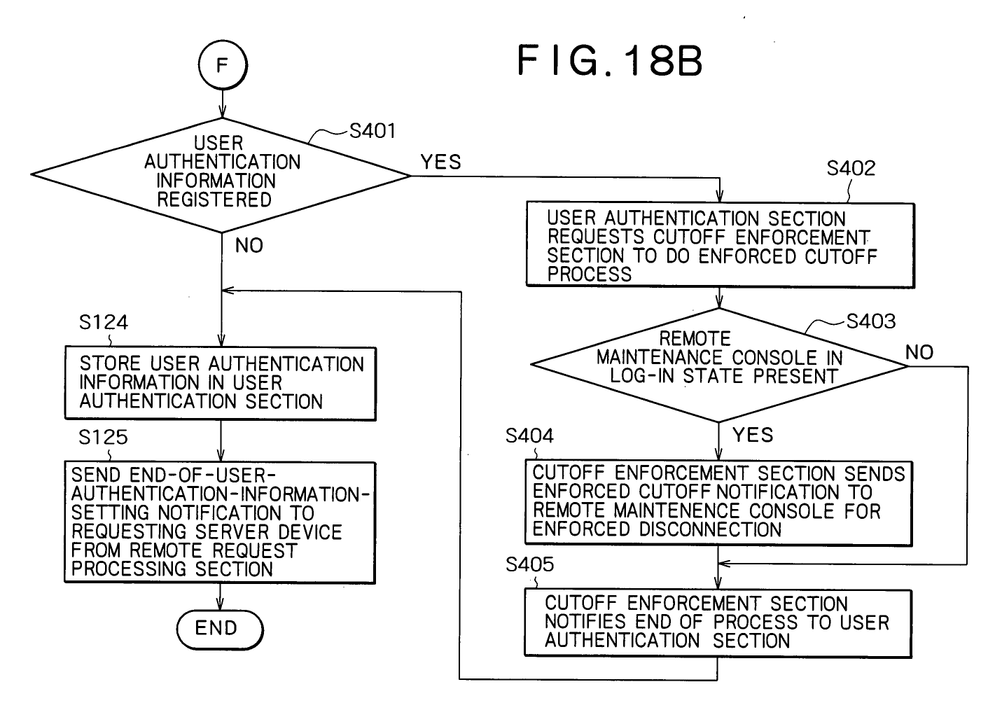

FIGS. 18A and 18B are flowcharts which illustrate an example of a process done by the client device 3 at the time a user authentication information setting instruction is transmitted from the server device 1 over the LAN 6, and differs from the flowchart in FIG. 15 in that steps S401 to S405 are added. The client device 3 receives the user authentication information setting instruction, transferred over the LAN 6, at the remote request processing section 33 (S121), decrypts the encrypted user name and password included in the instruction in the decryption section 36 (S311 to S313), checks if the user name and password meet predetermined numbers of digits (S122) and transfers the user authentication information setting instruction including the user name and password to the user authentication section 32 from the remote request processing section 33 if there is no check failure (S123). The operation up to this point is the same as that of the third embodiment. Subsequently, it is determined whether or not user authentication information has already been registered by the user authentication section 32 (S401) and the process is separated into two flows, depending on whether the user authentication information is registered or not.

When the user authentication information is not registered in the user authentication section 32, the user name and password in the user authentication information setting instruction are registered in the user authentication section 32 promptly (S124) and an end-of-user-authentication-information-setting notification is sent to the server device 1 from the remote request processing section 33 (S125).

In case where the user authentication information is registered in the user authentication section 32, on the other hand, the user authentication section 32 requests the cutoff enforcement section 37 to execute an enforced cutoff process (S402). The cutoff enforcement section 37 inquires the log-in/log-out processing section 35 if there is the remote maintenance console 5 which is in a log-in state in order to use the maintenance interface 30 of the client device 3 (S403), and notifies the end of the process to the user authentication section 32 if there is no such a remote maintenance console 5 (S405). If there is the logged-in remote maintenance console 5, the cutoff enforcement section 37 sends an enforced cutoff notification to the remote maintenance console 5 to forcibly disconnect it (S404). Then, the cutoff enforcement section 37 notifies the end of the process to the user authentication section 32 (S405). Thereafter, the user authentication section 32 registers the user name and password in the user authentication information setting instruction in the user authentication section 32 (S124) and sends an end-of-user-authentication-information-setting notification to the server device 1 (S125).

The operation of the embodiment is described next.

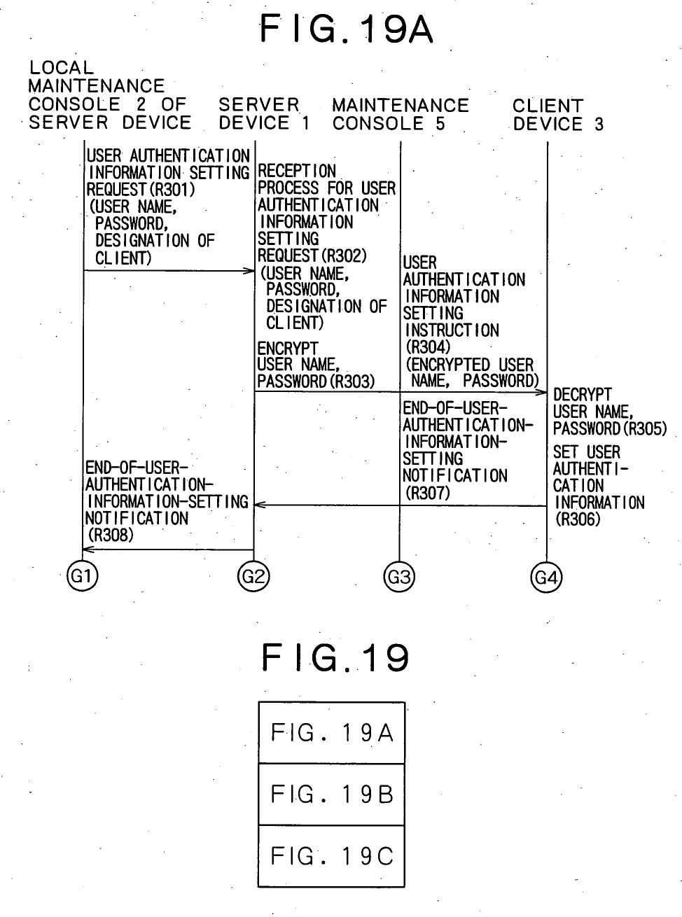

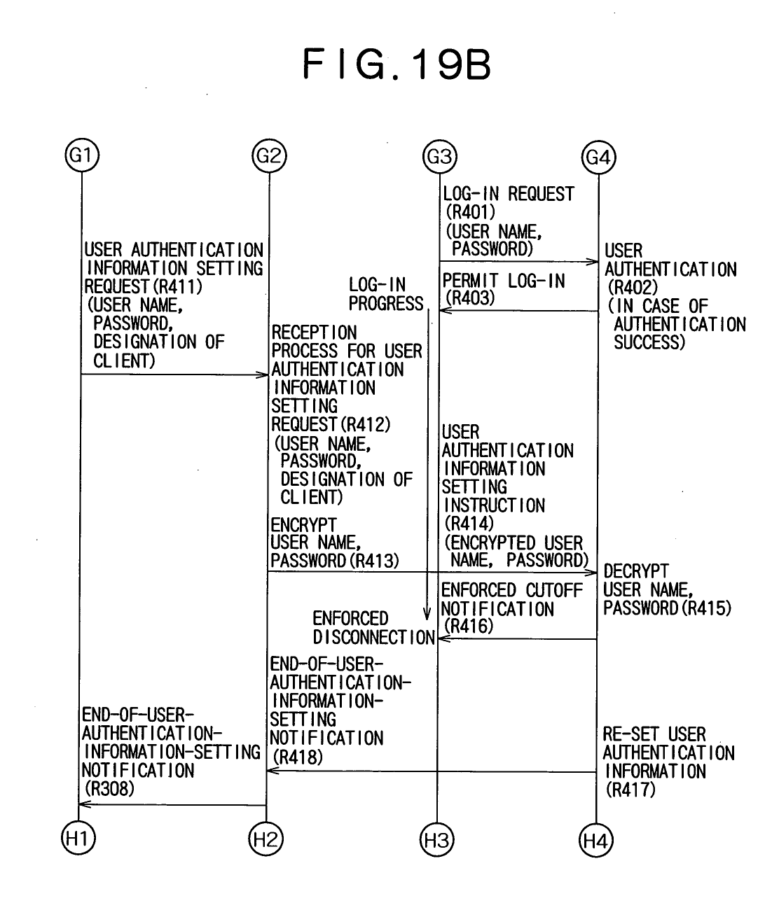

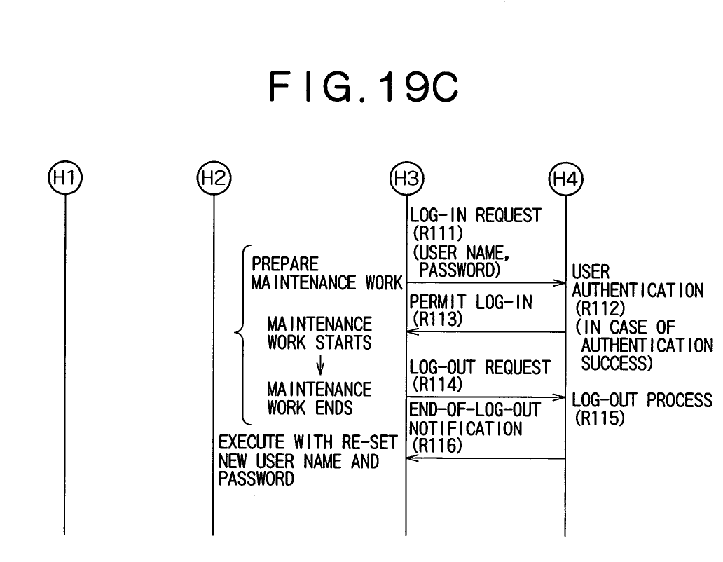

FIGS. 19A to 19C are sequence charts illustrating an operational example of the embodiment. The sequence chart illustrates sequences for a case where after the user name and password for opening the maintenance interface 30 of the client device 3 are initialized in the client device 3 over the LAN 6 from the server-side local maintenance console 2, the user name and password of the maintenance interface 30 of the client device 3 are set again from the server-side local maintenance console 2 and the normal remote maintenance is performed, with someone logging in the client device 3 from the remote maintenance console 5 and accessing the maintenance target portion 31.

Of the sequences in FIGS. 19A to 19C, sequences R310 to R308 to initialize a user name and password in the client device 3 from the server-side local maintenance console 2 are the same as those described referring to FIG. 16. In this case, sequences S402 to S405 in FIGS. 18A and 18B are skipped.

If someone inputs a log-in request designating a user name and password to the client device 3 from the remote maintenance console 5 over the LAN 6 after the user name and password are set in the user authentication section 32 of the client device 3 (R401 in FIGS. 19A to 19C), the same processes as those described referring to FIGS. 8 and 10 are executed by the client device 3. When the user name and password in the log-in request match with those registered in the user authentication section 32, the log-in is permitted (R402 and R403 in FIGS. 19A to 19C) and an access to the maintenance target portion 31 of the client device 3 from the remote maintenance console 5 becomes possible.

In case where a user authentication information setting request is input from the server-side local maintenance console 2 while the remote maintenance console 5 maintains the log-in state (R411 in FIGS. 19A to 19C), the following operation is performed.

First, the request receiving section 11 of the server device 1 performs a reception process of receiving the user authentication information setting request from the server-side local maintenance console 2 and checking authentication of the request (R412 in FIGS. 19A to 19C). Subsequently, the user name and password are encrypted by the encryption section 13 (R413 in FIGS. 19A to 19C) and a user authentication information setting instruction including encrypted user name and password is sent to the remote request processing section 33 of the client device 3 from the request transfer section 12 over the LAN 6 (R414 in FIGS. 19A to 19C).

The client device 3 receives the user authentication information setting instruction, transferred from the server device 1, at the remote request processing section 33 (S121 in FIGS. 18A and 18B) and decrypts the encrypted user name and password included in the instruction using the decryption section 36 (R415 in FIGS. 19A to 19C and S311 to S313 in FIGS. 18A and 18B). Next, authentication of the decrypted user name and password is checked (S122) and the user authentication information setting instruction is transferred to the user authentication section 32 if there is no authentication failure (S123).

As the user authentication information has already been registered (YES in S401), the user authentication section 32 requests the cutoff enforcement section 37 to perform an enforced cutoff process (S402). The cutoff enforcement section 37 checks if the remote maintenance console 5 is in the log-in state by the log-in/log-out processing section 35 (YES in S403), and sends a enforced cutoff notification to the remote maintenance console 5 to forcibly disconnect the console 5 (R416 in FIGS. 19A to 19C and S404 in FIGS. 18A and 18B). This can permit an access to the maintenance target portion 31 from the remote maintenance console 5. Thereafter, the cutoff enforcement section 37 notifies the end of the process to the user authentication section 32 (S405), nullifies the already registered user authentication information by erasure or so and then registers the user name and password in the user authentication information setting instruction (R417 in FIGS. 19A to 19C and S124 in FIGS. 18A and 18B). Then, the end-of-user-authentication-information-setting notification is sent to the server device 1 by the remote request processing section 33 (R418 in FIGS. 19A to 19C and S125 in FIGS. 18A and 18B) and is finally given to the server-side local maintenance console 2 (R419 in FIGS. 19A to 19C).

Sequences R111 to R116 in which after the user name and password are set again, the maintenance worker logs in the client device 3 from the remote maintenance console 5 using the new reset user name and password to do a maintenance work and logs out when the work is done are the same as the sequences described referring to FIGS. 10A to 10C.

According to the embodiment, as apparent from the above, in case where the server-side local maintenance console 2 issues an instruction to set the user name and password of the maintenance interface 30 of the client device 3, the client device 3 sends an enforced cutoff notification to and forcibly disconnects the remote maintenance console 5 if keeping the log-in state and sets the user name and password in the user authentication section 32 again. In case where a malignant access is made to the maintenance target portion 31 of the client device 3 or so, therefore, re-setting the user name and password of the maintenance interface 30 of the client device 3 from the server-side local maintenance console 2 can hinder the malignant access and set the user name and password again at the same time. This can guarantee sufficient security.

In the embodiment, like in the first embodiment, the client-side local maintenance console 4 in FIG. 1 may be connected to each client device 3 and the local request processing section 34 may be provided in each client device 3. In addition, user authentication information may be transferred, unencrypted, to the client device 3 from the server device 1 in which case the encryption section 13 and the decryption section 36 are omitted.

Fifth Embodiment of the Invention

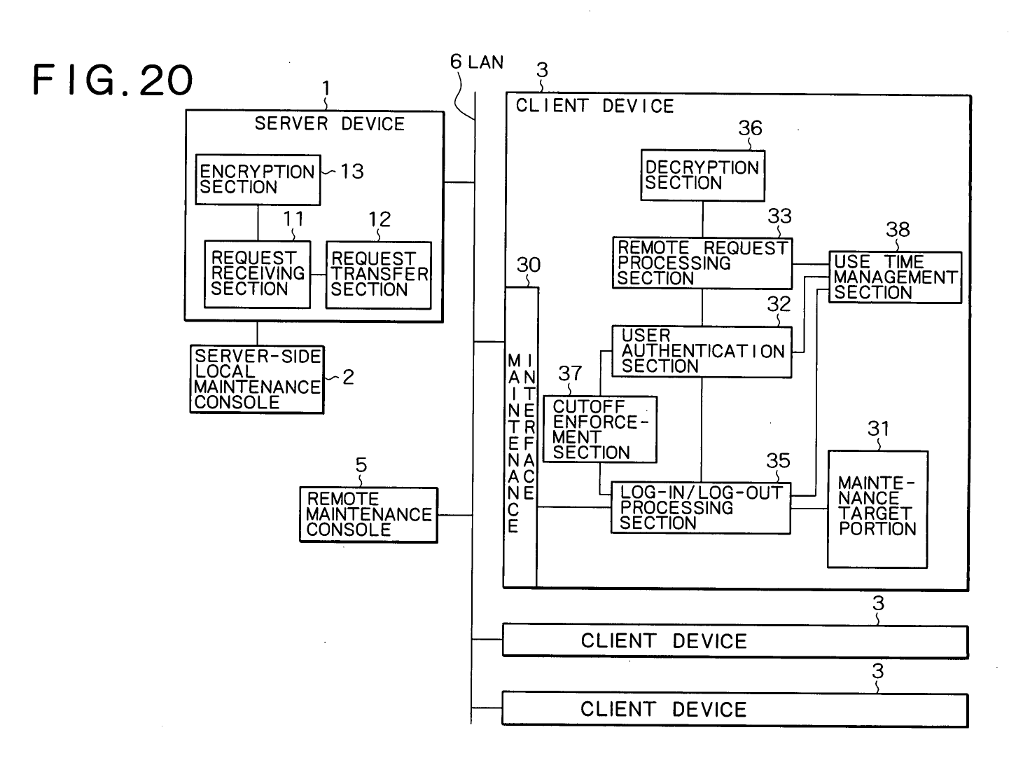

Referring to FIG. 20, a client/server type distribution system according to the fifth embodiment of the invention differs from the client/server type distribution system according to the fourth embodiment of the invention illustrated in FIG. 17 in that the server device 1 in the fourth embodiment is given a function of receiving an allowable use time setting request from the server-side local maintenance console 2 and transferring it to the client device 3 and each client device 3 has a use time management section 38 which manages the use time of the maintenance interface 30 from the remote maintenance console 5 and forcibly disconnects the remote maintenance console 5 by sending an enforced cutoff notification thereto and nullifies the user authentication information registered in the user authentication section 32 when the use time exceeds an allowable use time set beforehand by the server device 1. The fifth embodiment is identical to the fourth embodiment in the other points.

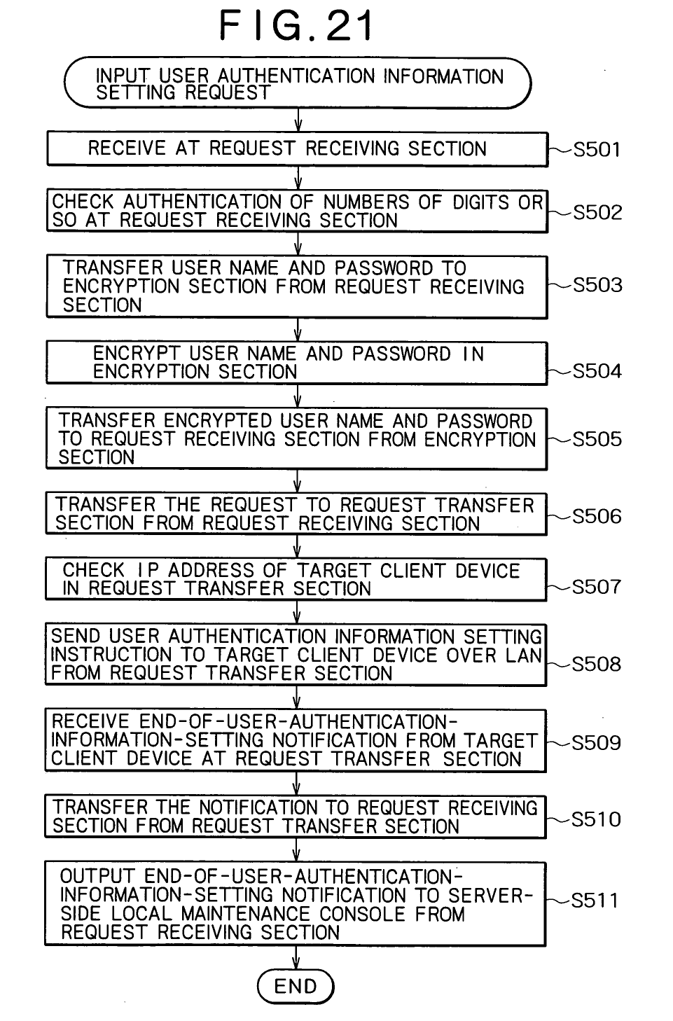

FIG. 21 is a flowchart which illustrates an example of a process done by the server device 1 at the time a user authentication information setting request is input from the server-side local maintenance console 2. When a system manager or so inputs, from the server-side local maintenance console 2, a user authentication information setting request including information designating a client device 3 where user authentication information is to be set, a user name and password as user authentication information to set and an allowable use time to set, the request receiving section 11 receives the request (S501) and checks the authentication of the numbers of digits or so of the user name and password and the allowable use time (S502). In case where the numbers of digits or so do not meet a predetermined condition, the request is rejected. When there is no authentication failure, the encryption section 13 encrypts the user name and password in the received user authentication information setting request (S503 to S505) and the user authentication information setting request including the encrypted user name and password and the allowable use time is transferred to the request transfer section 12 (S506). Then, the request transfer section 12 acquires the IP address of the client device 3 designated in the user authentication information setting request (S507) and sends a user authentication information setting instruction including the encrypted user name and password and the allowable use time in the user authentication information setting request to the target client device 3 over the LAN 6 (S508). Then, when the target client device 3 returns an end-of-user-authentication-information-setting notification, the notification is received at the request transfer section 12 and the end-of-user-authentication-information-setting notification is sent to the server-side local maintenance console 2 through the request receiving section 11 (S509 to S511).

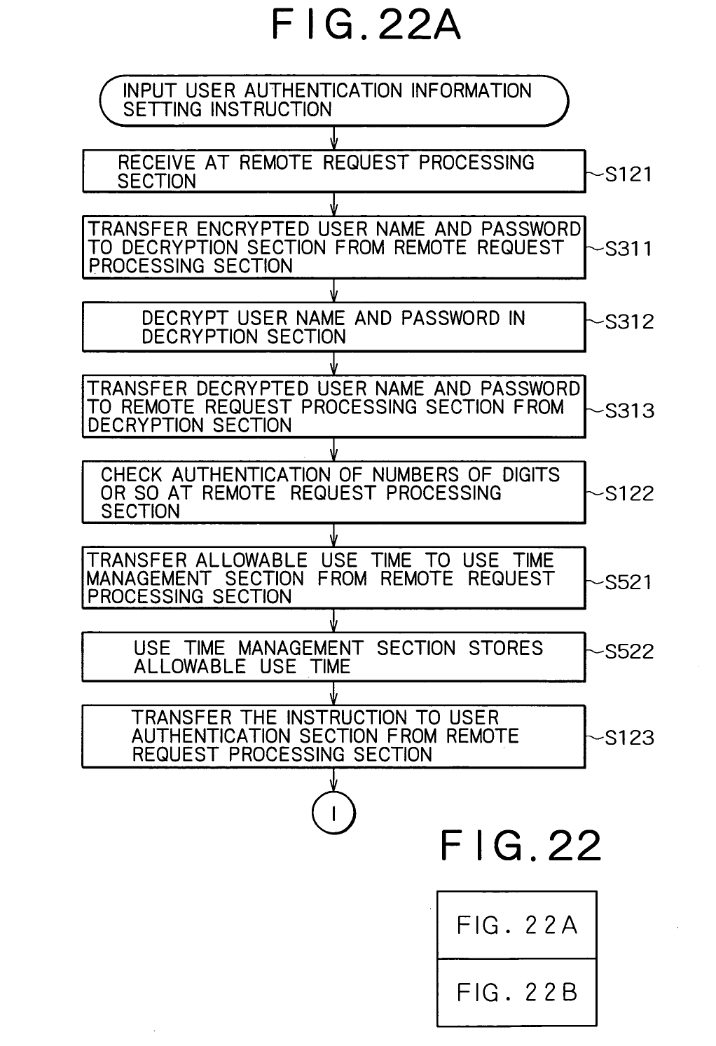

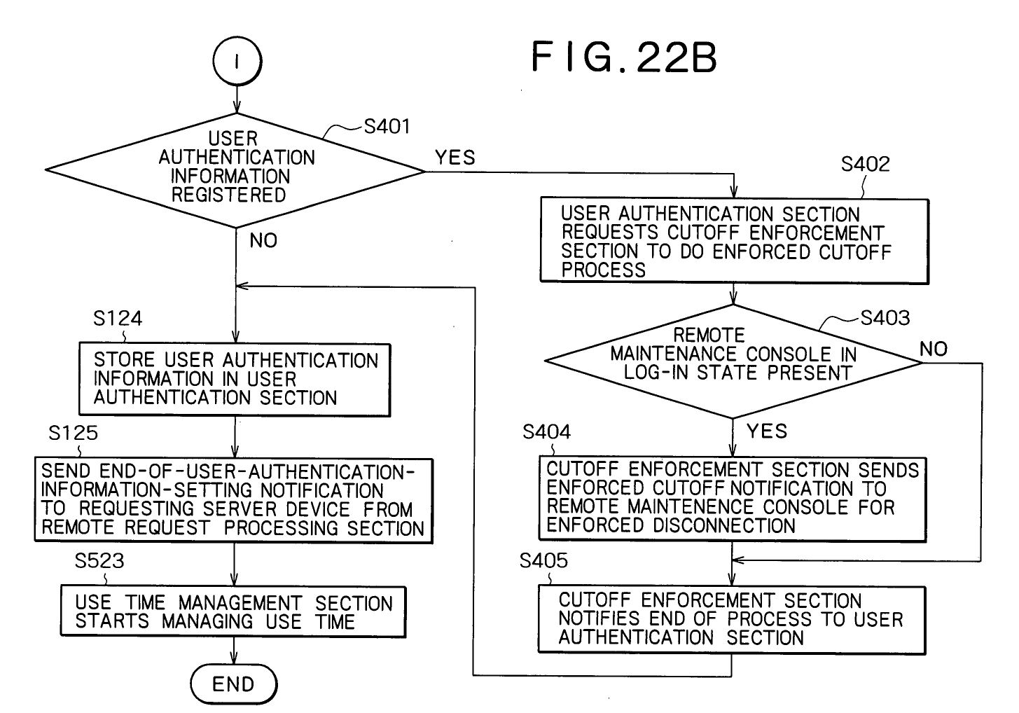

FIGS. 22A and 22B are flowcharts which illustrate an example of a process done by the client device 3 at the time a user authentication information setting instruction is sent over the LAN 6 from the server device 1 and differs from the flowchart in FIGS. 18A and 18B in that steps S521, S522 and S523 are added. The client device 3 to which the user authentication information setting instruction is sent over the LAN 6 receives the instruction at the remote request processing section 33 (S121), decrypts the encrypted user name and password in the decryption section 36 (S311 to S313), checks if the user name and password and the allowable use time satisfy predetermined numbers of digits (S122), and then transfers the allowable use time to the user authentication section 32 if there is no check failure (S521). The use time management section 38 stores the allowable use time (S522). The remote request processing section 33 transfers the user authentication information setting instruction including the user name and password to the user authentication section 32 (S123). Thereafter, the same processes as shown in FIGS. 18A and 18B are executed (S401 to S405, S124 and S125), and when the user authentication information is stored in the user authentication section 32, releasing the maintenance interface 30, the use time management section 38 starts managing the use time in accordance with the stored allowable use time (S523).

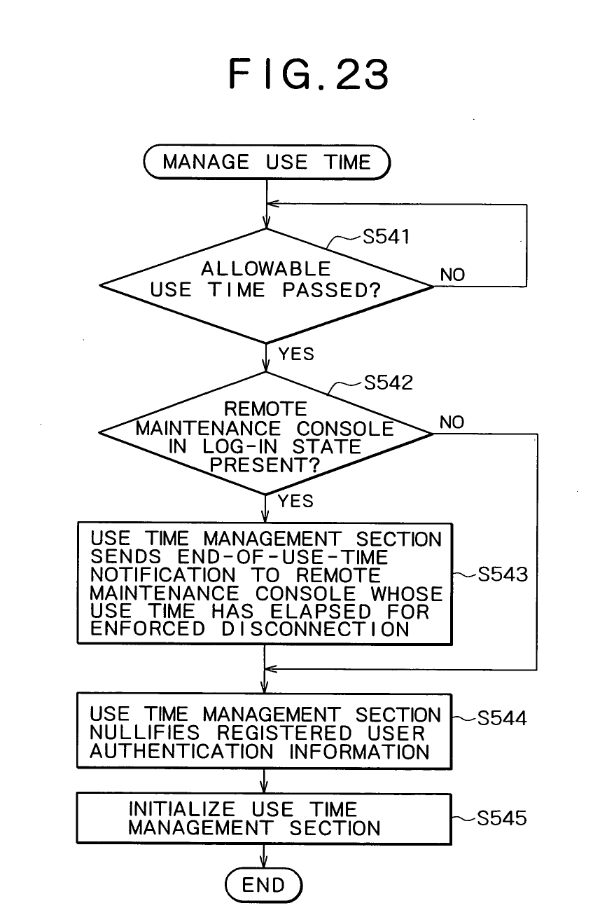

FIG. 23 is a flowchart illustrating an example of a process after the use time management section 38 starts managing the use time. When the use time management section 38 starts managing the use time, the management section 38 decrements the allowable use time recorded inside with the passage of time and determines whether or not the remaining use time becomes 0, i.e., whether or not the allowable use time set beforehand has elapsed (S541). When the remaining use time becomes 0, an end-of-use-time notification is sent to the remote maintenance console 5 maintaining the log-in state, if such a console exists (YES in S542), and forcibly disconnects the console 5 (S543). If the remote maintenance console 5 keeping the log-in state does not exist, this step S543 is skipped. Next, the use time management section 38 instructs the user authentication section 32 to nullify user authentication information and the user authentication section 32 nullifies the registered user authentication information accordingly (S544). Then, the use time management section 38 is initialized (S545).

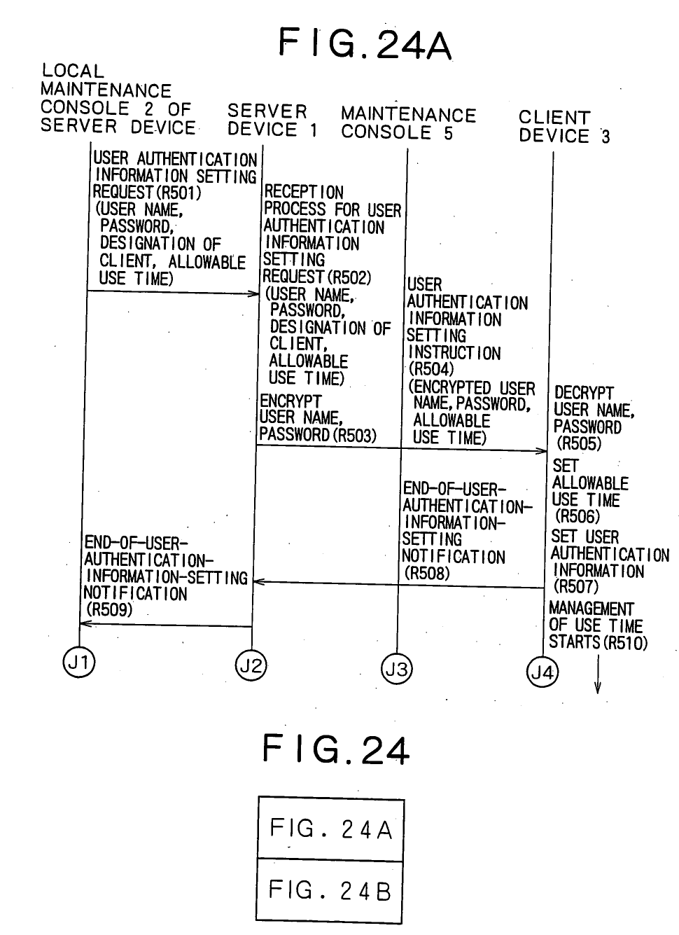

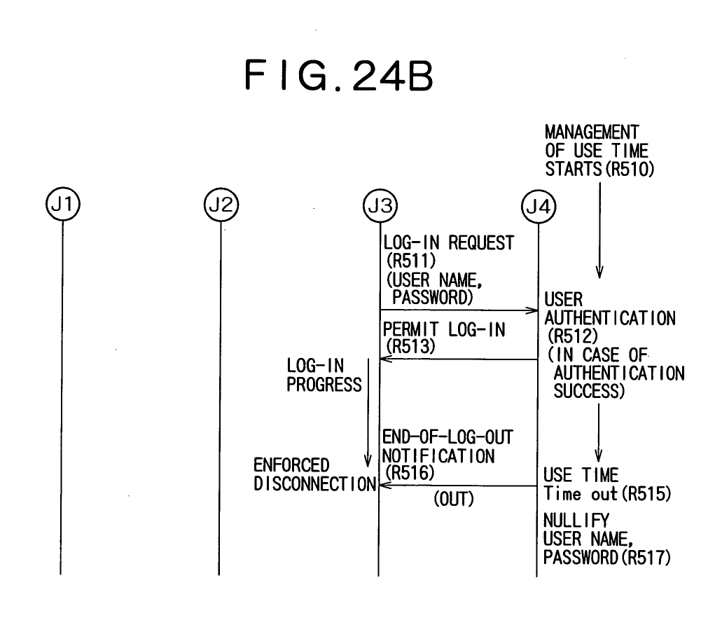

FIGS. 24A and 24B are sequence charts illustrating an operational example of the embodiment showing sequences for the following two cases.

(1) Setting of user authentication information and allowable use time in the client device 3 from the server-side local maintenance console 2

(2) Log-in to the client device 3 by the remote maintenance console 5

The operation of the embodiment is described below on the two cases.

(1) First, referring to FIGS. 20 to 24, an operation at the time of setting the user authentication information and allowable use time in the client device 3 from the server-side local maintenance console 2 is described.

When a system manager or so inputs a user authentication information setting request including a user name and password for releasing the security on the maintenance interface 30 of the client device 3, designation of the target client device 3 and an allowable use time from the server-side local maintenance console 2 (R501 in FIGS. 24A and 24B), the server device 1 executes a process of receiving this request (R502). In this reception process, when the request receiving section 11 performs a process of receiving the user authentication information setting request and a process of checking the authentication of the user name and password and the allowable use time (S501 and S502 in FIG. 21). When there is no authentication failure, encryption of the user name and password is performed in the encryption section 13 (R503 in FIGS. 24A and 24B and S503 to S505 in FIG. 21). Then, the request receiving section 11 transfers the user authentication information setting request including the encrypted user name and password and the allowable use time to the request transfer section 12 (S506). Thereafter, the request transfer section 12 acquires the IP address of the client device 3 designated in the user authentication information setting request (S507) and sends a user authentication information setting instruction including the user name and password and the allowable use time to the remote request processing section 33 of the client device 3 over the LAN 6 (R504 in FIGS. 24A and 24B and S508 in FIG. 21).

The client device 3 receives the user authentication information setting instruction, transferred from the server device 1, at the remote request processing section 33 (S121 in FIGS. 22A and 22B) and decrypts the encrypted user name and password included in the instruction using the decryption section 36 (R505 in FIGS. 24A and 24B and S311 to S313 in FIGS. 22A and 22B). Subsequently, authentication of the decrypted user name and password and the allowable use time is checked (S122), and the allowable use time is transferred to the use time management section 38 first if there is no authentication failure (S521). The use time management section 38 stores this allowable use time (R506 in FIGS. 24A and 24B and S522 in FIGS. 22A and 22B). Next, the remote request processing section 33 sends a user authentication information setting instruction including the user name and password to the user authentication section 32 (S123). Thereafter, the same processes as described referring to FIGS. 18A and 18B are carried out (S401 to S405, S124 and S125), the user name and password are set in the user authentication section 32 (R507 in FIGS. 24A and 24B) and the end-of-user-authentication-information-setting notification is given to the server-side local maintenance console 2 from the client device 3 (R508 and R509). Then, the use time management section 38 starts managing the use time (R510 and S523 in FIGS. 22A and 22B).

(2) Referring to FIGS. 23 and 24, the following discusses an operation when someone has logged into the client device 3 from the remote maintenance console 5.

After the user name and password are set in the user authentication section 32 of the client device 3 and the use time management section 38 starts managing the use time, when someone inputs a log-in request designating a user name and password to the client device 3 from the remote maintenance console 5 over the LAN 6 (R511 in FIGS. 24A and 24B), the same processes as described referring to FIGS. 8 and 10 are executed by the client device 3. When the user name and password in the log-in request match with those registered in the user authentication section 32, the log-in is permitted (R512 and R513 in FIGS. 24A and 24B), thus permitting the remote maintenance console 5 to access the maintenance target portion 31 of the client device 3.

In case where the allowable use time elapses before a log-out request is input to the log-in/log-out processing section 35 from the remote maintenance console 5 (R15 in FIGS. 24A and 24B and YES in S541 and S542 in FIG. 23), however, the use time management section 38 sends an end-of-use-time notification to the remote maintenance console 5 and performs enforced cutoff process (R516 in FIGS. 24A and 24B ad S543 in FIG. 23). The use time management section 38 instructs the user authentication section 32 to nullify user authentication information so that the user authentication section 32 nullifies the registered user authentication information (R517 in FIGS. 24A and 24B and S544 in FIG. 23).

According to the embodiment, as described above, it is possible to designate the allowable use time from the server-side local maintenance console 2 and manage the use time of the maintenance interface 30 of the client device 3. This can prevent an increase in the occurrence of possible malignant accesses originated as the maintenance interface 30 of the client device 3, once opened, is kept open over a long period of time.

Although the setting of the allowable use time is instructed also by an instruction to set user authentication information in the client device 3 from the server-side local maintenance console 2 in this embodiment, an instruction to set the user authentication information in the client device 3 from the server-side local maintenance console 2 and an instruction to set the allowable use time in the client device 3 from the server-side local maintenance console 2 may be given independently. A function of setting the allowable use time to the client device 3 from the server-side local maintenance console 2 may be omitted and a fixed allowable use time prestored in the use time management section 38 may be used instead.

In the embodiment, like in the first embodiment, the client-side local maintenance console 4 in FIG. 1 may be connected to each client device 3 and the local request processing section 34 may be provided in each client device 3. In addition, user authentication information may be transferred, unencrypted, to the client device 3 from the server device 1 in which case the encryption section 13 and the decryption section 36 are omitted. The remote maintenance console 5 keeping the log-in state may not be disconnected forcibly at the time of setting user authentication information, in which case the cutoff enforcement section 37 is omitted.

Sixth Embodiment of the Invention

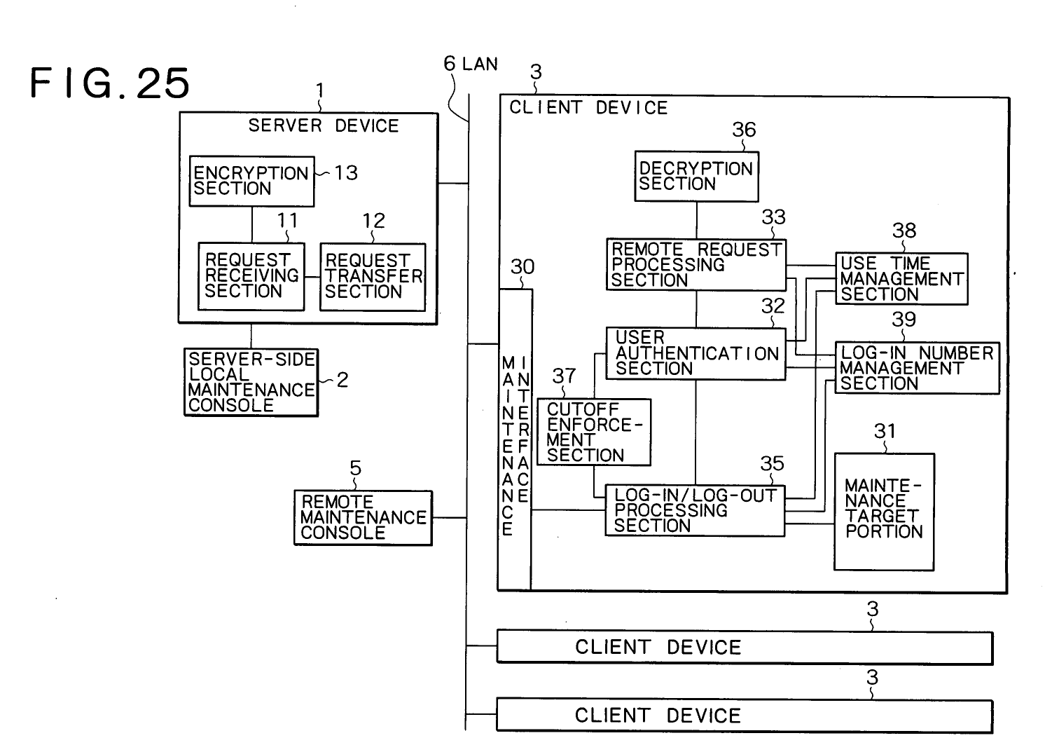

Referring to FIG. 25, a client/server type distribution system according to the sixth embodiment of the invention differs from the client/server type distribution system according to the fifth embodiment of the invention illustrated in FIG. 20 in that the server device 1 of the fifth embodiment is provided with a function of receiving a request for the allowable number of log-in events from the server-side local maintenance console 2 and transferring it to the client device 3, and each client device 3 has a log-in number management section 39 which manages the number of log-in events from the remote maintenance console 5 and does not permit log-in, sends an end-of-use-number notification to the remote maintenance console 5 and nullifies user authentication information registered in the user authentication section 32, when the number of log-in events exceeds the allowable number of log-in events set from the server device 1. The sixth embodiment is identical to the fifth embodiment in the other points.

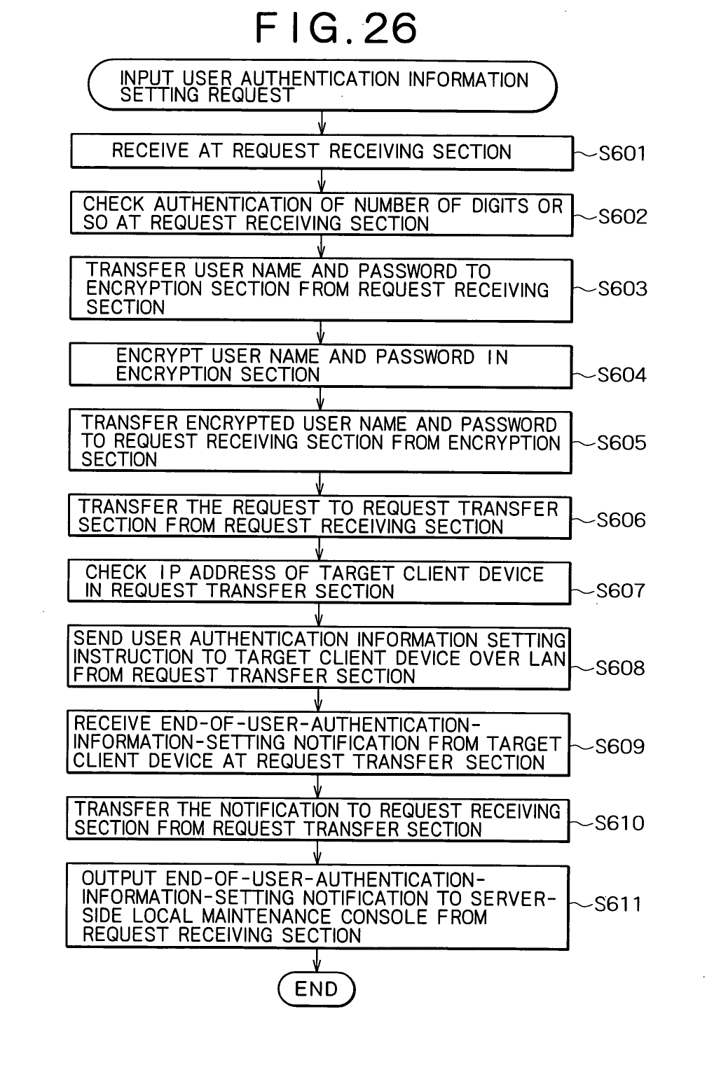

FIG. 26 is a flowchart which illustrates an example of a process done by the server device 1 at the time a user authentication information setting request is input from the server-side local maintenance console 2. When a system manager or so inputs, from the server-side local maintenance console 2, a user authentication information setting request including information designating a client device 3 where user authentication information is to be set, a user name and password as user authentication information to set, an allowable use time to set, and the allowable number of log-in events to set the request receiving section 11 receives the request (S601) and checks the authentication of the numbers of digits or so of the user name and password, the allowable use time and the allowable number of log-in events (S602). In case where the numbers of digits or so do not meet a predetermined condition, the request is rejected. When there is no authentication failure, the encryption section 13 encrypts the user name and password in the received user authentication information setting request (S603 to S605) and the user authentication information setting request including the encrypted user name and password, the allowable use time and the allowable number of log-in events is transferred to the request transfer section 12 (S606). Then, the request transfer section 12 acquires the IP address of the client device 3 designated in the user authentication information setting request (S607) and sends a user authentication information setting instruction including the encrypted user name and password, the allowable use time and the allowable number of log-in events in the user authentication information setting request to the target client device 3 over the LAN 6 (S608). Then, when the target client device 3 returns an end-of-user-authentication-information-setting notification, the notification is received at the request transfer section 12 and the end-of-user-authentication-information-setting notification is sent to the server-side local maintenance console 2 through the request receiving section 11 (S609 to S611).

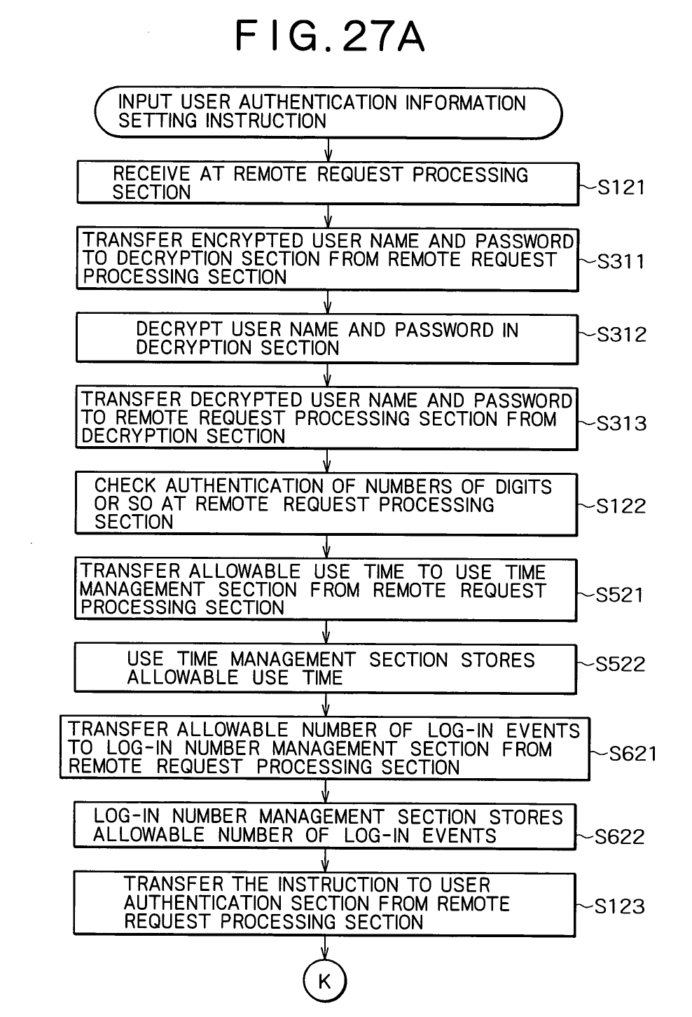

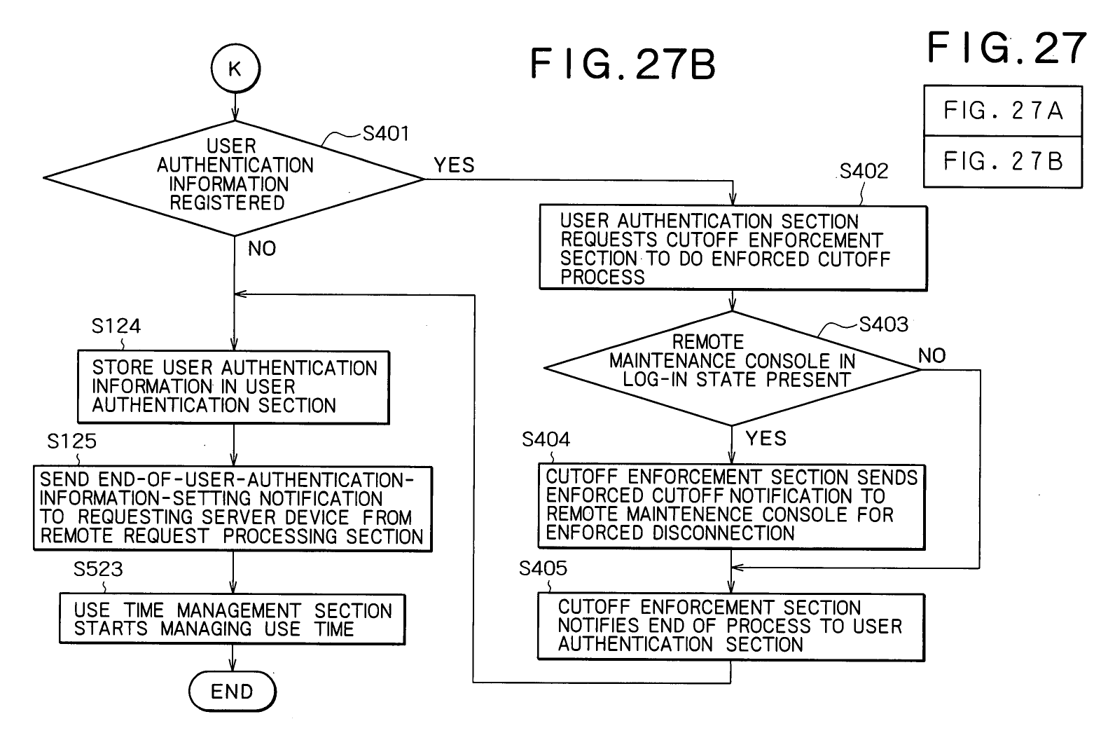

FIGS. 27A and 27B are flowcharts which illustrate an example of a process done by the server device 1 at the time a user authentication information setting request is input from the server-side local maintenance console 2, and differs from the flowchart in FIGS. 22A and 22B in that steps S621 and S623 are added. The client device 3 to which the user authentication information setting instruction is sent over the LAN 6 receives the instruction at the remote request processing section 33 (S121), decrypts the encrypted user name and password in the decryption section 36 (S311 to S313), checks if the user name and password, the allowable use time and the allowable number of log-in events satisfy predetermined numbers of digits (S122). If there is no check failure, the allowable use time is transferred to the user authentication section 32 (S521) and the use time management section 38 stores the allowable use time (S522). Further, the allowable number of log-in events is transferred to the log-in number management section 39 (S621) and the log-in number management section 39 stores the allowable number of log-in events (S622). Thereafter, the same processes as shown in FIGS. 22A and 22B are executed (S123, S401 to S405, S124, S125 and S523).

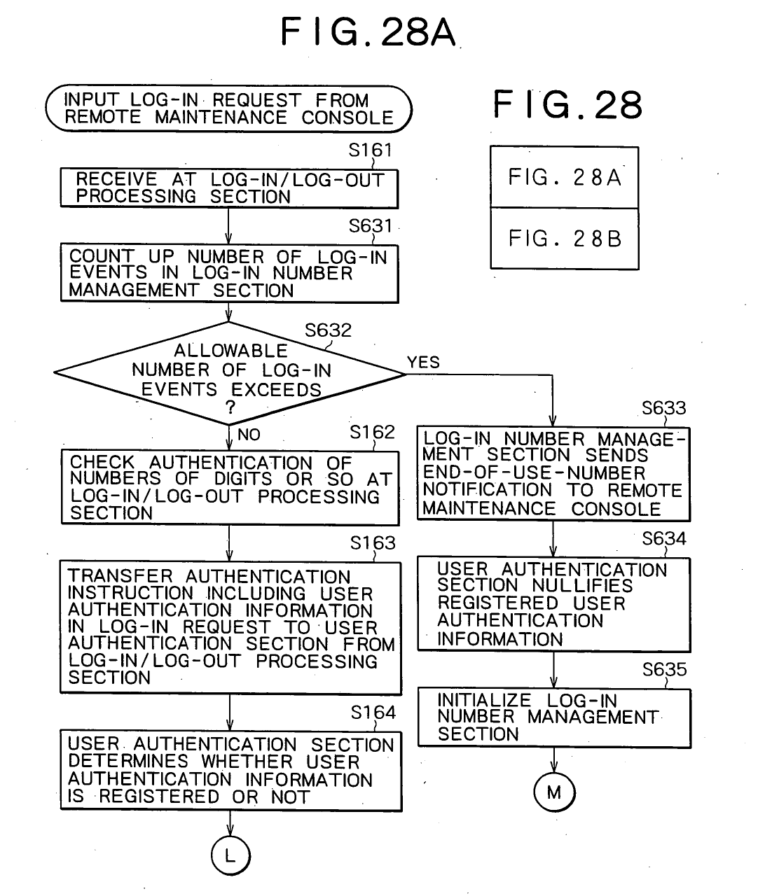

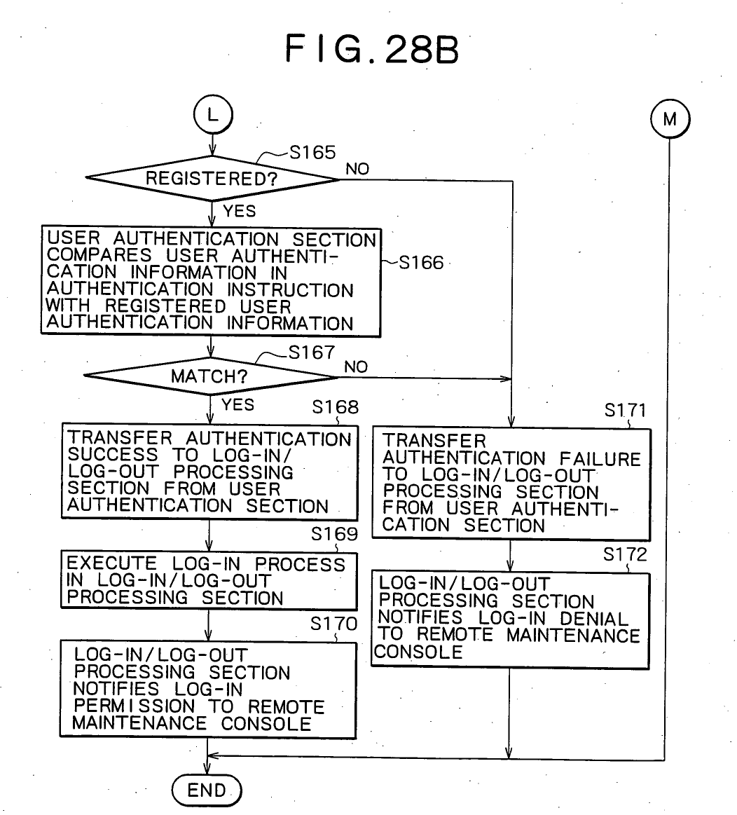

FIGS. 28A and 28B are flowcharts which illustrate an example of a process done by the client device 3 at the time a log-in request including designation of a user name and password is sent from the remote maintenance console 5 over the LAN 6, and differs from the flowcharts in FIGS. 8A and 8B in that steps S531 to S635 are added. In this embodiment, when the log-in/log-out processing section 35 receives a log-in request from the remote maintenance console 5 (S161), the log-in number management section 39 increments the number of log-in events by “+1” (S631) and determines whether or not the number of log-in events exceeds the allowable number of log-in events set beforehand (S632). When the number of log-in events does not exceed the allowable number of log-in events, the same processes as described referring to FIGS. 8A and 8B are executed (S162 to S172).

When the number of log-in events is greater than the allowable number of log-in events, the log-in number management section 39 sends an end-of-use-number notification to the remote maintenance console 5 that has made the log-in request (S633). At this time, the log-in/log-out processing section 35 does not permit log-in. Further, the user authentication section 32 nullifies the registered user authentication information (S634). Then, the log-in number management section 39 is initialized (S635).

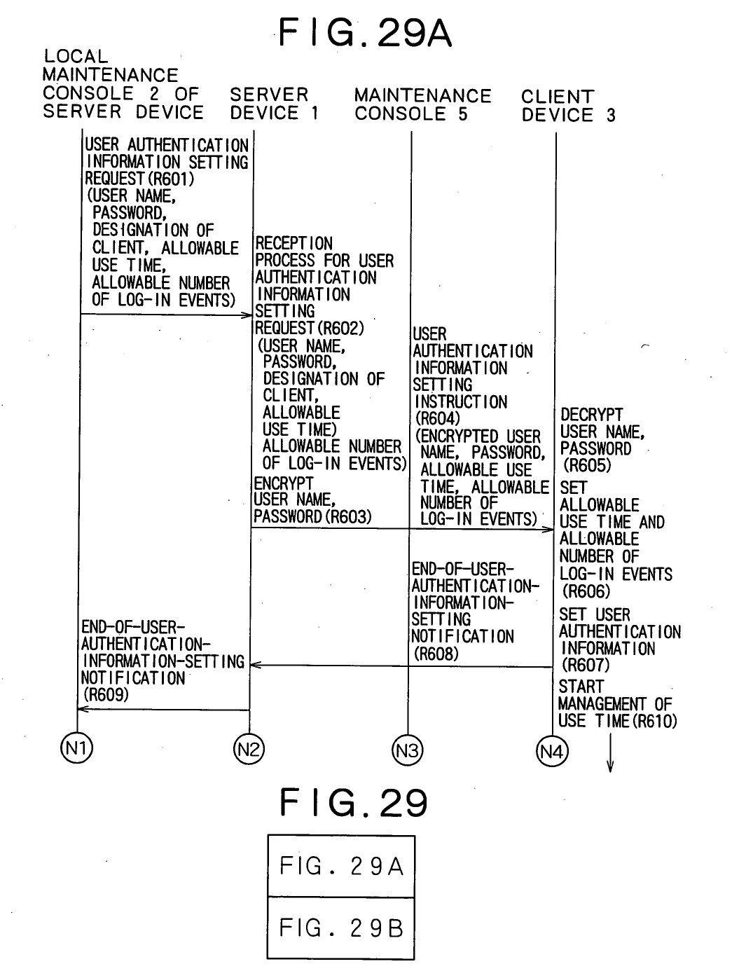

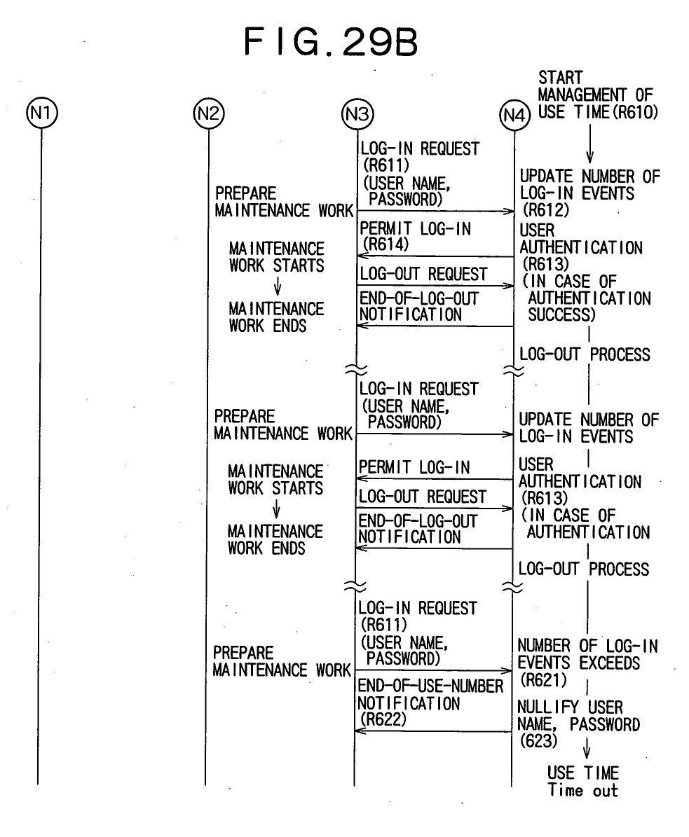

FIGS. 29A and 29B are sequence charts illustrating an operational example of the embodiment showing sequences for the following two cases.

(1) Setting of user authentication information, the allowable use time and the allowable number of log-in events in the client device 3 from the server-side local maintenance console 2

(2) Frequent log-in to the client device 3 by the remote maintenance console 5

The operation of the embodiment is described below on the two cases.

(1) First, referring to FIGS. 25 to 27 and 29, an operation at the time of setting the user authentication information, allowable use time and allowable number of log-in events in the client device 3 from the server-side local maintenance console 2 is described.

When a system manager or so inputs, from the server-side local maintenance console 2, a user authentication information setting request including a user name and password for releasing the security on the maintenance interface 30 of the client device 3, designation of the target client device 3, an allowable use time or the maximum log-in time permitted and the allowable number of log-in events or the maximum allowable number of log-in events within the allowable use time (R601 in FIGS. 29A and 29B), the server device 1 executes a process of receiving this request (R602). In this reception process, when the request receiving section 11 performs a process of receiving the user authentication information setting request and a process of checking the authentication of the user name and password, the allowable use time and the allowable number of log-in events (S601 and S602 in FIG. 26). When there is no authentication failure, encryption of the user name and password is performed in the encryption section 13 (R603 in FIGS. 29A and 29B and S603 to S605 in FIG. 26). Then, the request receiving section 11 transfers the user authentication information setting request including the encrypted user name and password, the allowable use time and the allowable number of log-in events to the request transfer section 12 (S606). Thereafter, the request transfer section 12 acquires the IP address of the client device 3 designated in the user authentication information setting request (S607) and sends a user authentication information setting instruction including the user name and password and the allowable use time to the remote request processing section 33 of the client device 3 over the LAN 6 (R604 in FIGS. 29A and 29B and S608 in FIG. 26).

The client device 3 receives the user authentication information setting instruction, transferred from the server device 1, at the remote request processing section 33 (S121 in FIGS. 27A and 27B) and decrypts the encrypted user name and password included in the instruction using the decryption section 36 (R605 in FIGS. 29A and 29B and S311 to S313 in FIGS. 27A and 27B). Subsequently, authentication of the decrypted user name and password, the allowable use time and the allowable number of log-in events is checked (S122), the allowable use time is transferred to the use time management section 38 and the allowable number of log-in events is transferred to the log-in number management section 39 if there is no authentication failure, and the use time management section 38 stores the allowable use time and the log-in number management section 39 stores the allowable number of log-in events (R606 in FIGS. 29A and 29B, and S521, S522, S621 and S622 in FIGS. 27A and 27B). Next, the remote request processing section 33 sends a user authentication information setting instruction including the user name and password to the user authentication section 32 (S123). Thereafter, the same processes as illustrated in FIGS. 22A and 22B are carried out (S401 to S405, S124, S125 and S523), the user name and password are set in the user authentication section 32 (R607 in FIGS. 29A and 29B) and the end-of-user-authentication-information-setting notification is given to the server-side local maintenance console 2 from the client device 3 (R608 and R609). Further, the use time management section 38 starts managing the use time (R610).

(2) Referring to FIGS. 25, 28 and 29, the following discusses an operation when someone has logged into the client device 3 from the remote maintenance console 5.

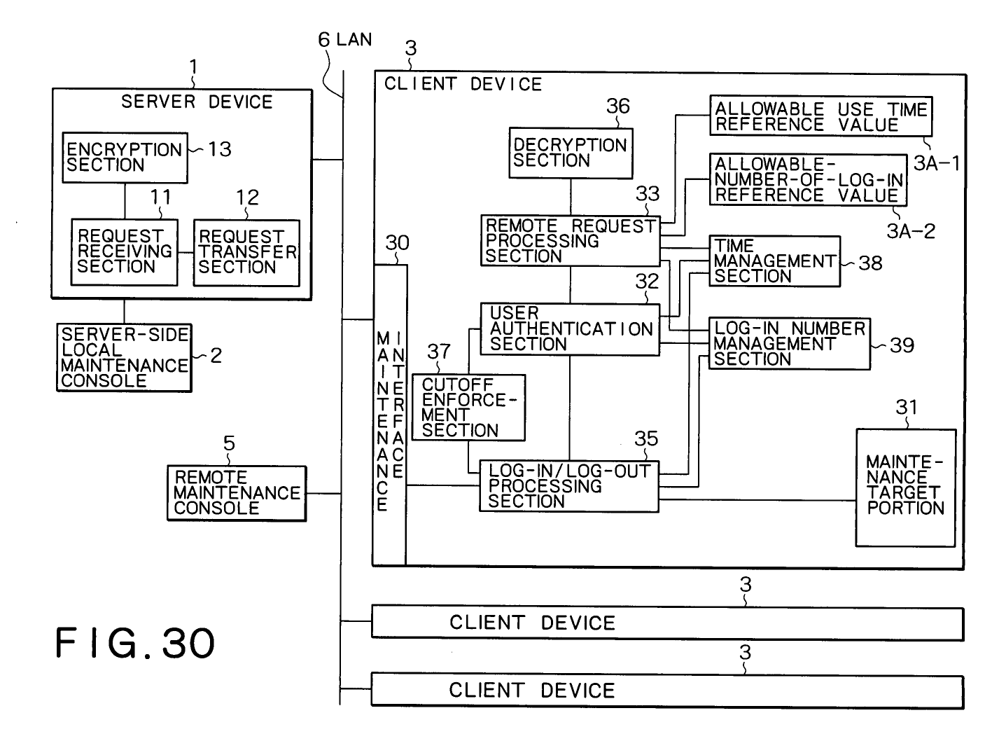

In case where someone inputs a log-in request designating a user name and password to the client device 3 from the remote maintenance console 5 over the LAN 6 after the user name and password are set in the user authentication section 32 of the client device 3, the allowable use time is set in the use time management section 38 and the allowable number of log-in events is set in the log-in number management section 39, (R611 in FIGS. 29A and 29B), the number of log-in events is updated in the log-in number management section 39 (R612 in FIGS. 29A and 29B and S631 in FIGS. 28A and 28B), a user authentication process R613 is executed, when the user name and password in the log-in request match with those registered in the user authentication section 32, the log-in is permitted (R614 in FIGS. 29A and 29B). This allows an access to the maintenance target portion 31 of the client device 3 from the remote maintenance console 5. Thereafter, the remote maintenance console 5 logs out and logs in again in the sequences in FIG. 30.

In the fifth embodiment, log-in and log-out from can be done repeatedly from the remote maintenance console 5 within the allowable use time using the user name and password. In the sixth embodiment, however, the log-in number management section 39 updates the number of log-in events every time a log-in request is made and when the number of log-in events exceeds the allowable number of log-in events set beforehand (R621 in FIGS. 29A and 29B and YES in S632 in FIGS. 28A and 28B), an end-of-use-number notification is given to the remote maintenance console 5 (R621 in FIGS. 29A and 29B and S633 in FIGS. 28A and 28B), disabling the log-in. The user authentication section 32 nullifies the registered user name and password (R623 in FIGS. 29A and 29B and S634 in FIGS. 28A and 28B).

According to this embodiment, the number of usages of the maintenance interface 30 of the client device 3 (number of log-in events) can be managed. Therefore, once the maintenance interface 30 of the client device 3 is opened, frequent attacks on the maintenance interface 30 can be prevented and congestion of the client device 3 can be prevented.

Although the setting of the allowable number of log-in events is instructed also by an instruction to set user authentication information in the client device 3 from the server-side local maintenance console 2 in this embodiment, an instruction to set the user authentication information in the client device 3 from the server-side local maintenance console 2 and an instruction to set the allowable number of log-in events in the client device 3 from the server-side local maintenance console 2 may be given independently. A function of setting the allowable number of log-in events to the client device 3 from the server-side local maintenance console 2 may be omitted and a fixed allowable number of log-in events prestored in the log-in number management section 39 may be used instead.

In the embodiment, like in the first embodiment, the client-side local maintenance console 4 in FIG. 1 may be connected to each client device 3 and the local request processing section 34 may be provided in each client device 3. In addition, user authentication information may be transferred, unencrypted, to the client device 3 from the server device 1 in which case the encryption section 13 and the decryption section 36 are omitted. The remote maintenance console 5 maintaining the log-in state may not be disconnected forcibly at the time of setting user authentication information, in which case the cutoff enforcement section 37 is omitted. Further, the allowable use time may not be managed in which case the use time management section 38 is omitted.

Seventh Embodiment of the Invention

Referring to FIG. 30, a client/server type distribution system according to the seventh embodiment of the invention differs from the client/server type distribution system according to the sixth embodiment of the invention illustrated in FIG. 25 in that each client device 3 in the sixth embodiment has a section for prestoring an allowable use time reference value 3A-1 and an allowable-number-of-log-in reference value 3A-2 and the allowable use time reference value 3A-1 and the allowable-number-of-log-in reference value 3A-2 are set in the use time management section 38 and the log-in number management section 39 respectively in case where the allowable use time and the allowable number of log-in events are not included in the user authentication information setting instruction from the remote maintenance console 5 or are not usable due to a reception failure or so even if they are included, and is identical to the sixth embodiment in the other points.

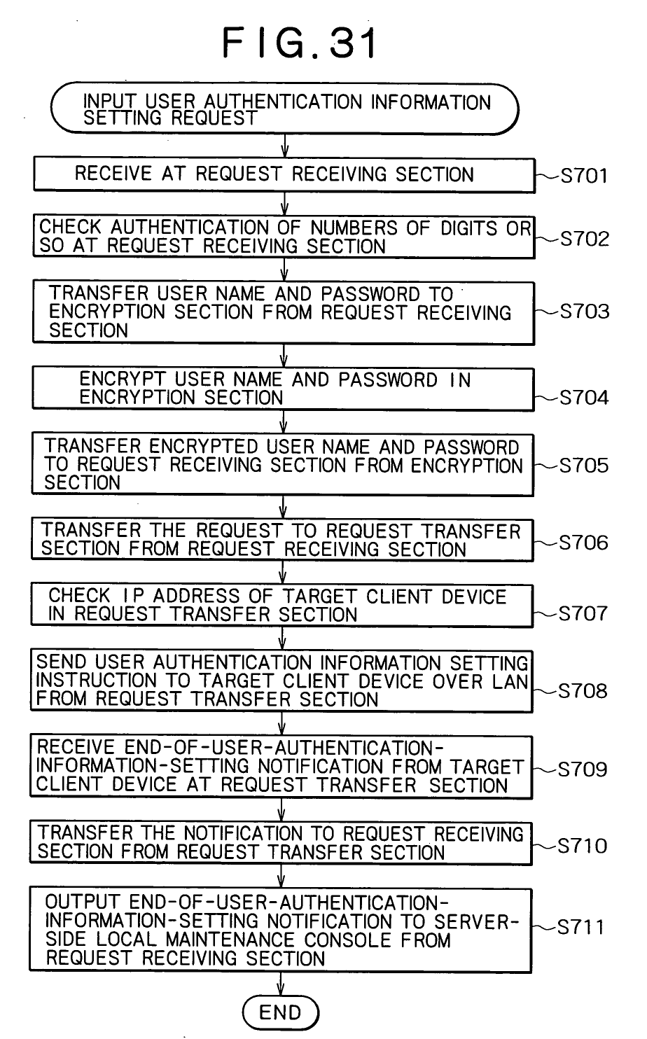

FIG. 31 is a flowchart which illustrates an example of a process done by the server device 1 at the time a user authentication information setting request is input from the server-side local maintenance console 2. A system manager or so inputs, from the server-side local maintenance console 2, a user authentication information setting request including information designating a client device 3 where user authentication information is to be set and a user name and password as user authentication information to be set, an allowable use time to set and an allowable number of log-in events to set. In this embodiment, the designation of the allowable use time and the allowable number of log-in events is arbitrary and is not needed when the allowable use time reference value 3A-1 and the allowable-number-of-log-in reference value 3A-2 of the client device 3 are used. The request from the server-side local maintenance console 2 is received by the request receiving section 11 (S701), and the same processes as steps S603 to S611 in FIG. 26 are executed thereafter (S702 to S711).

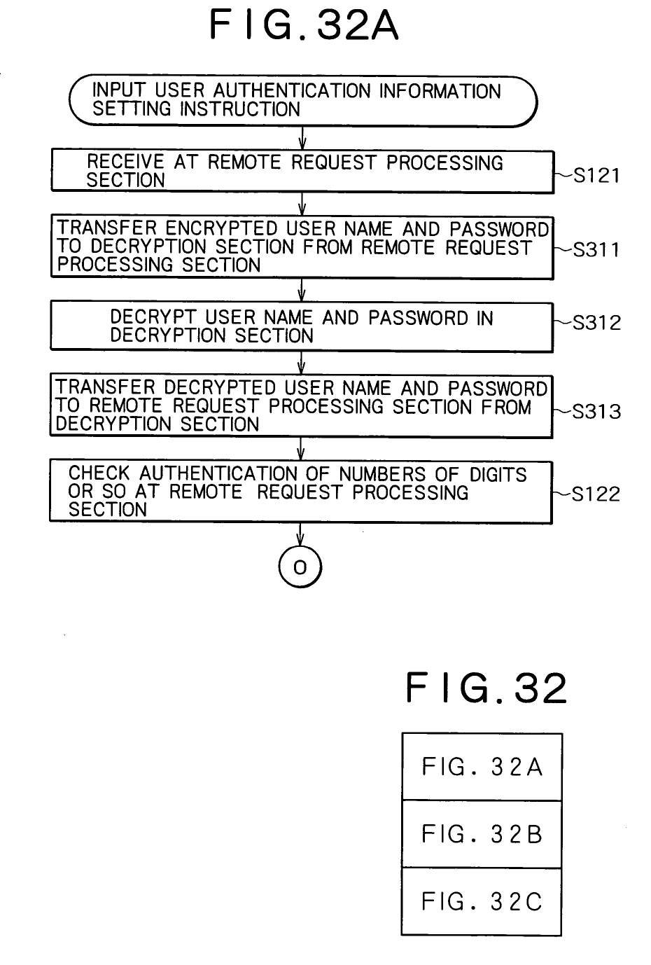

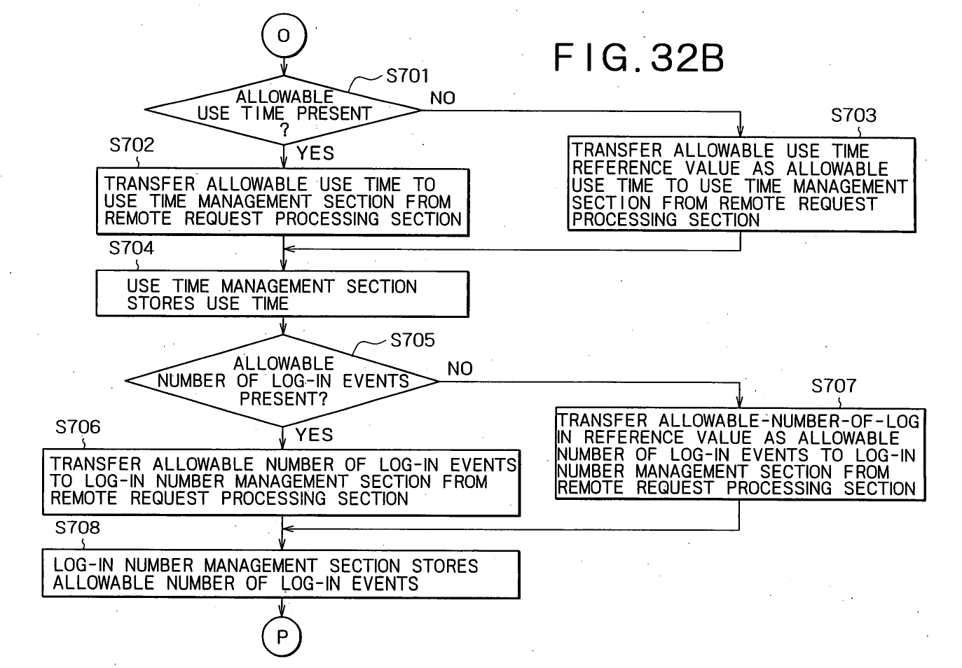

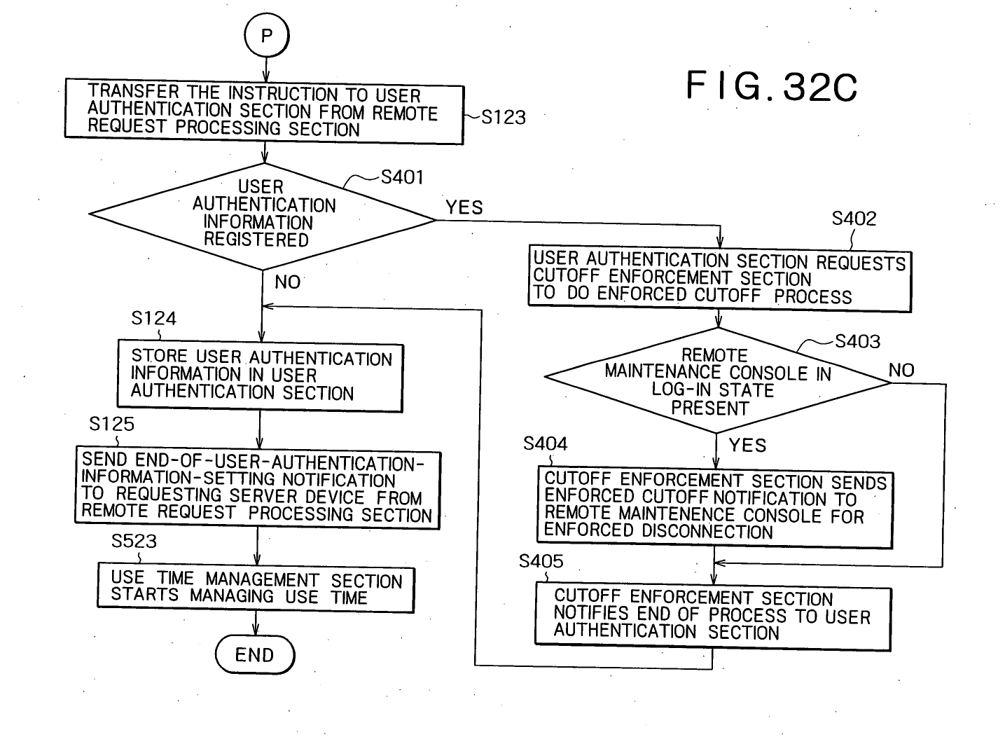

FIGS. 32A and 32B are flowcharts which illustrate an example of a process done by the client device 3 at the time a user authentication information setting instruction is sent over the LAN 6 from the server device 1 and differs from the flowchart in FIGS. 27A and 27B in that steps S521, S522, S621 and S622 in FIGS. 27A and 27B are replaced with steps S701 to S708. When the client device 3 receives the user authentication information setting instruction, sent over the LAN 6, at the remote request processing section 33 (S121), the client device 3 decrypts the encrypted user name and password in the instruction in the decryption section 36 (S311 to S313) and checks whether or not the user name and password, and the allowable use time and the allowable number of log-in events if included in the instruction, satisfy predetermined numbers of digits (S122). If the allowable use time is included in the instruction and is usable (YES in S701), it is transferred to the use time management section 38 (S702). If the allowable use time is not included in the instruction or is not usable due to a reception failure (NO in S701), the allowable use time reference value 3A-1 is transferred to the use time management section 38 (S703). The use time management section 38 stores the transferred allowable use time (S704). Further, if the allowable number of log-in events is included in the instruction and is usable (YES in S705), the remote request processing section 33 transfers the allowable number of log-in events to the log-in number management section 39 (S706). If the allowable number of log-in events is not included in the instruction or is not usable due to a reception failure (NO in S705), the remote request processing section 33 transfers the allowable-number-of-log-in reference value 3A-2 to the log-in number management section 39 (S707). The log-in number management section 39 stores the transferred allowable number of log-in events (S708). Thereafter, the same processes as illustrated to FIGS. 27A and 27B are executed (S123, S401 to S405, S124, S125 and S523).

According to the embodiment, at the time of setting user authentication information in the client device 3 from the server-side local maintenance console 2 and opening the maintenance interface 30, even when the allowable use time is not set from the server-side local maintenance console 2, the use time can be managed by using the allowable use time reference value 3A-1 of the client device 3, and when the use time exceeds the allowable use time reference value 3A-1, the use of the maintenance interface 30 can be inhibited forcibly. Even in case where the maintenance interface 30 of the client device 3 is opened without designation of the allowable use time, it is possible to prevent the threat of malignant accesses from becoming greater as the maintenance interface 30 is kept over a long period of time.

According to the embodiment, at the time of setting user authentication information in the client device 3 from the server-side local maintenance console 2 and opening the maintenance interface 30, even when the allowable number of log-in events is not set from the server-side local maintenance console 2, the number of log-in events can be managed by using the allowable-number-of-log-in reference value 3A-2 of the client device 3, and when the number of log-in events exceeds the allowable-number-of-log-in reference value 3A-2, the use of the maintenance interface 30 can be inhibited forcibly. Even in case where the maintenance interface 30 of the client device 3 is opened without designation of the allowable number of log-in events, it is possible to prevent multiple attacks against the maintenance interface 30.

In the embodiment, like in the first embodiment, the client-side local maintenance console 4 in FIG. 1 may be connected to each client device 3 and the local request processing section 34 may be provided in each client device 3. In addition, user authentication information may be transferred, unencrypted, to the client device 3 from the server device 1 in which case the encryption section 13 and the decryption section 36 are omitted. The remote maintenance console 5 maintaining the log-in state may not be disconnected forcibly at the time of setting user authentication information, in which case the cutoff enforcement section 37 is omitted.

Eighth Embodiment of the Invention

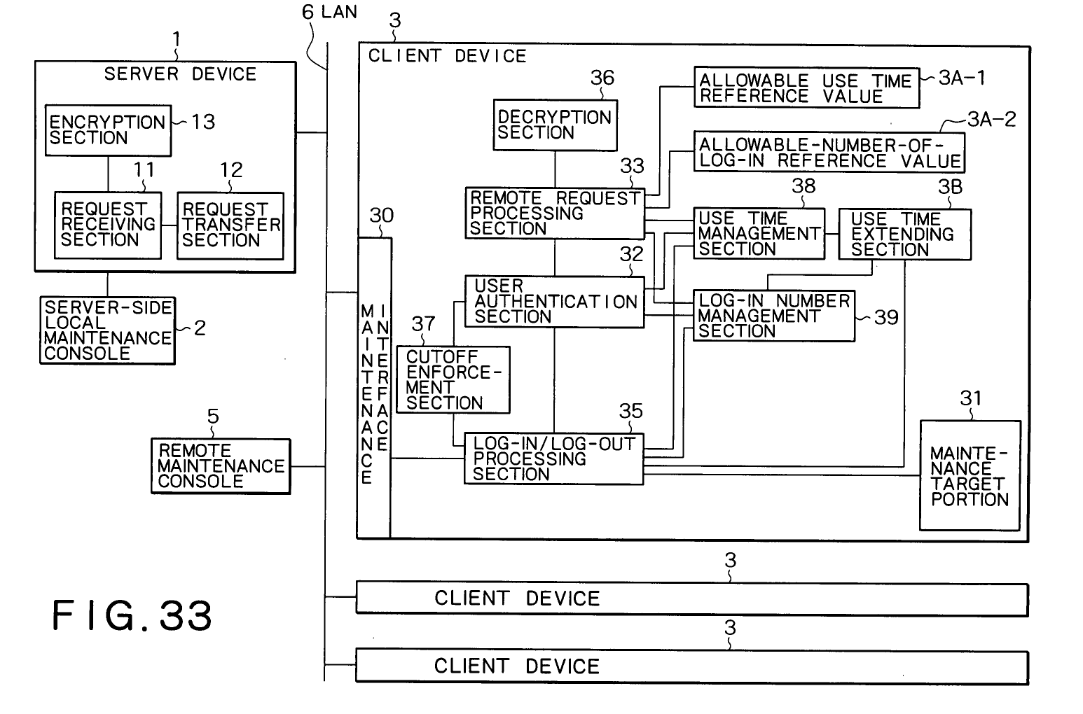

Referring to FIG. 33, a client/server type distribution system according to the eighth embodiment of the invention differs from the client/server type distribution system according to the seventh embodiment of the invention illustrated in FIG. 30 in that each client device 3 in the seventh embodiment has a use time extending section 3B which extends the remaining use time in the use time management section 38 by a predetermined extension time only for the first log-in since the opening of the maintenance interface 30, and is identical to the seventh embodiment in the other points.

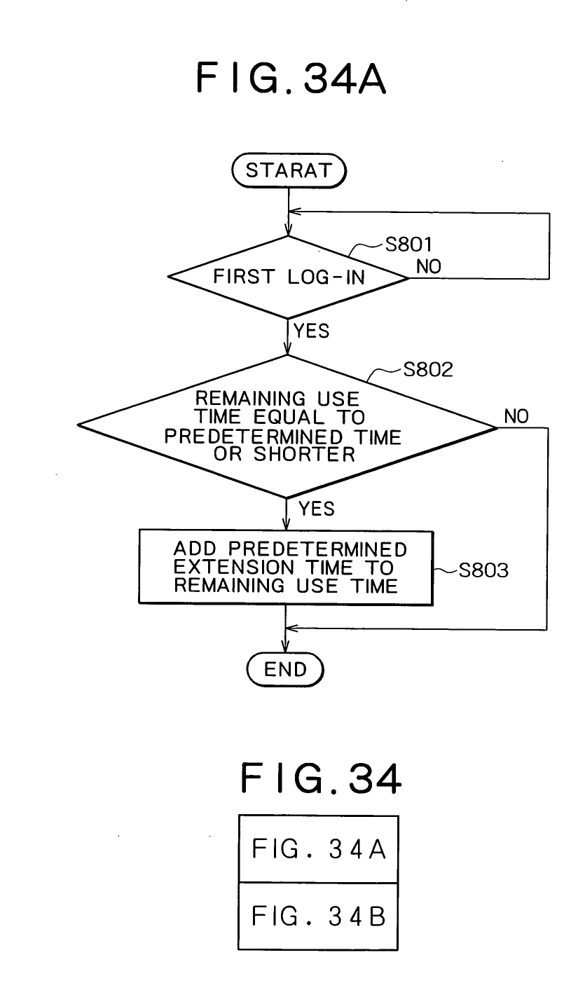

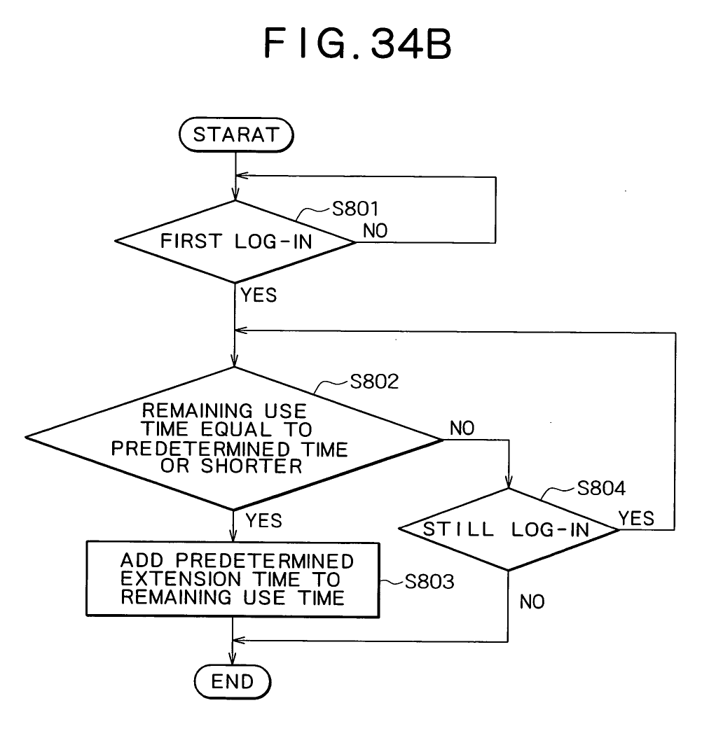

FIG. 34A is a flowchart illustrating an example of the use time extending section 3B. The use time extending section 3B is activated, for example, at the same time as the use time management section 38. The use time management section 38 first detects if it is the first log-in of the remote maintenance console 5 since the maintenance interface 30 was opened by the setting of the user authentication information in the user authentication section 32 (S801). This can be achieved by checking if the number of log-in events managed by the log-in number management section 39 has become 1. When detecting the first log-in from the remote maintenance console 5, the use time extending section 3B detects if the remaining use time which is managed by the use time management section 38 is equal to a preset time or shorter (S802). If the remaining use time is shorter than the preset time (YES in S802), a predetermined extension time is added to the remaining time information managed by the use time management section 38 (S803). Instead of being added to the remaining use time, the extension time may alone be set as the remaining use time. If the remaining use time at the time of the first log-in is not equal to or shorter than the preset time (NO in S802), the use time is no longer extended so that the process in FIG. 34A is terminated.

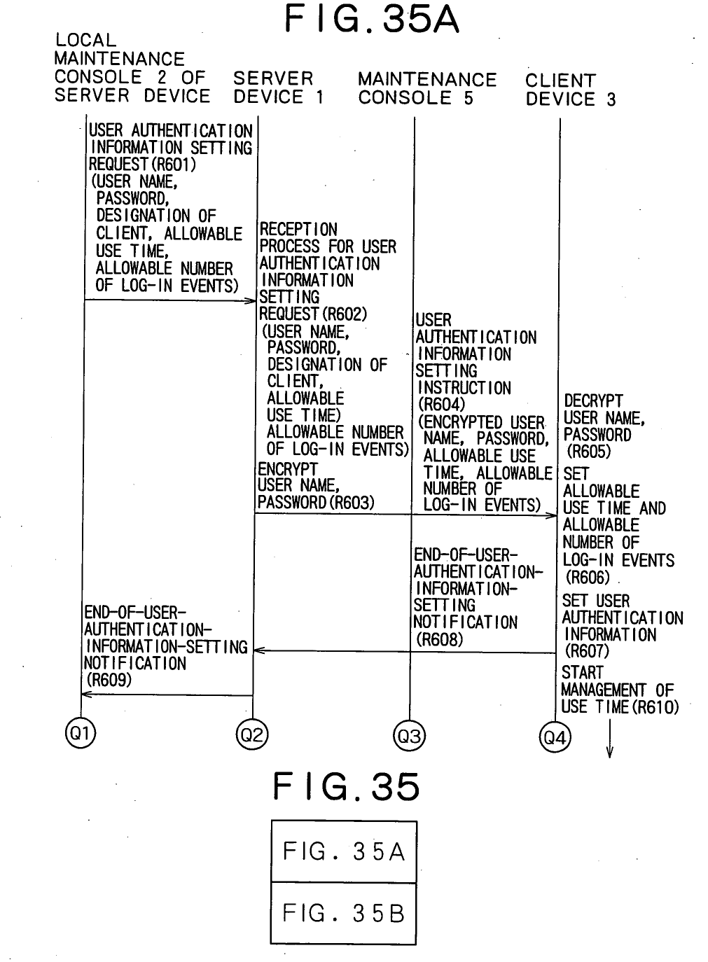

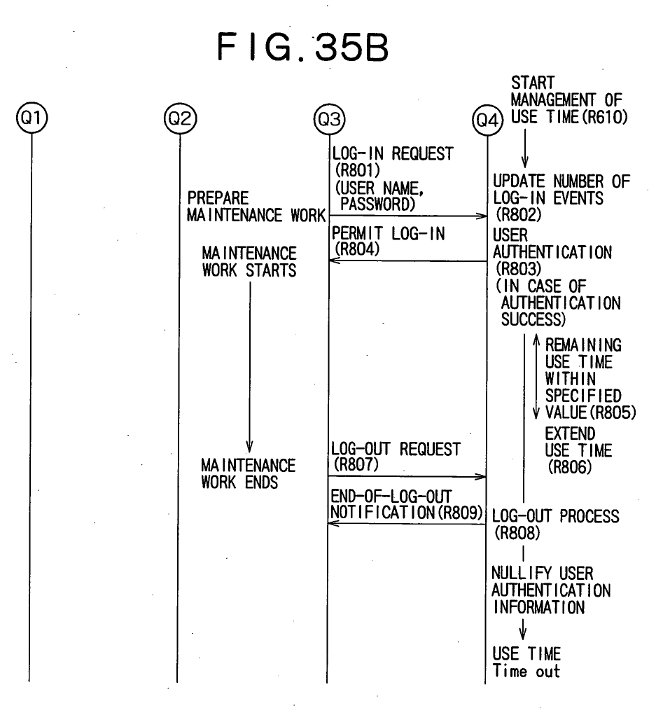

FIGS. 35A and 35B are sequence charts illustrating an operational example of the embodiment showing sequences for the following two cases.

(1) Setting of user authentication information, allowable use time and the allowable number of log-in events in the client device 3 from the server-side local maintenance console 2

(2) First log-in to the client device 3 from the remote maintenance console 5

As the operation of the embodiment in the sequence (1) is the same as that of the sequence in FIGS. 29A and 29B, an operation in the case (2) where a maintenance worker logs in to the client device 3 from the remote maintenance console 5 for the first time is described below referring to FIGS. 33 and 35.

As the user name and password are set in the user authentication section 32 of the client device 3, the allowable use time is set in the use time management section 38, the allowable number of log-in events is set in the log-in number management section 39 after a while a maintenance worker inputs a log-in request designating a user name and password to the client device 3 from the remote maintenance console 5 over the LAN 6 (R801 in FIGS. 35A and 35B), the number of log-in events is updated in the log-in number management section 39 (R802 in FIGS. 35A and 35B) and becomes equals to “1”. As a user authentication process R803 is executed and the user name and password in the log-in request match with those registered in the user authentication section 32, log-in is allowed (R804 in FIGS. 35A and 35B). This permits an access to the maintenance target portion 31 of the client device 3 from the remote maintenance console 5.

In case where some period of time elapses before the remote maintenance console 5 logs in after the maintenance interface 30 was opened by the setting of the user authentication information in the user authentication section 32 so that the remaining use time at the time of the log-in is equal to a preset time or shorter (R805 in FIGS. 35A and 35B), the use time extending section 3B detects that event (YES in S802 in FIG. 34A) and a predetermined extension time is added to the remaining use time in the use time management section 38 (R806 in FIGS. 35A and 35B and S803 in FIG. 34A). Then, in the sequence in FIGS. 35A and 35B, the maintenance worker who has finished a maintenance work logs out the remote maintenance console 5 (R807 to R809).

According to the embodiment, in case where the maintenance interface 30 of the client device 3 is opened from the server-side local maintenance console 2 with a time set after which the first log-in from the remote maintenance console 5 takes place near the end of the use time, the use time can be extended by a given time for the purpose of ensuring a sufficient maintenance work. Even in case where the first log-in is delayed for some reasons, therefore, a maintenance work can be carried out without problem. In the process in FIG. 34A, extension of the use time is granted when the remaining use time at the point of the first log-in is equal to a predetermined time or shorter. However, even if the remaining use time at the point of the first log-in is equal to a predetermined time or greater, extension of the use time may be granted in case where a maintenance work took time so that the remaining use time would become too short. FIG. 34B is a flowchart illustrating an example of the use time extending section 3B in such a mode and has step S804 added to the flowchart in FIG. 34A. When the use time management section 38 detects that the first log-in from the remote maintenance console 5 has taken place since the opening of the maintenance interface 30 achieved by setting user authentication information in the user authentication section 32 (S801), the use time management section 38 detects if the remaining use time which is managed by the use time management section 38 is equal to a preset time or shorter (S802) and if the first log-in is in progress (S804). Whether the first log-in is in progress or not can be detected by referring to the log-in status that is managed by the log-in/log-out processing section 35. When it is detected during the first log-in that the remaining use time is equal to the preset time or shorter (YES in S802), a predetermined extension time is added to the remaining time information managed by the use time management section 38 (S803). Instead of being added to the remaining use-time, the extension time may alone be set as the remaining use time. If the first log-in ends and the remote maintenance console 5 logs out (NO in S804), the use time is no longer extended so that the process in FIG. 34B is terminated.

In the embodiment, like in the first embodiment, the client-side local maintenance console 4 in FIG. 1 may be connected to each client device 3 and the local request processing section 34 may be provided in each client device 3. In addition, user authentication information may be transferred, unencrypted, to the client device 3 from the server device 1 in which case the encryption section 13 and the decryption section 36 are omitted. The remote maintenance console 5 maintaining the log-in state may not be disconnected forcibly at the time of setting user authentication information, in which case the cutoff enforcement section 37 is omitted. Further, the allowable number of log-in events may not be managed in which case the log-in number management section 39 is omitted. In this case, whether or not it is the first log-in since opening of the maintenance interface 30 can be checked by, for example, managing the number of log-in events after opening of the maintenance interface 30 in the use time extending section 3B.

Ninth Embodiment of the Invention

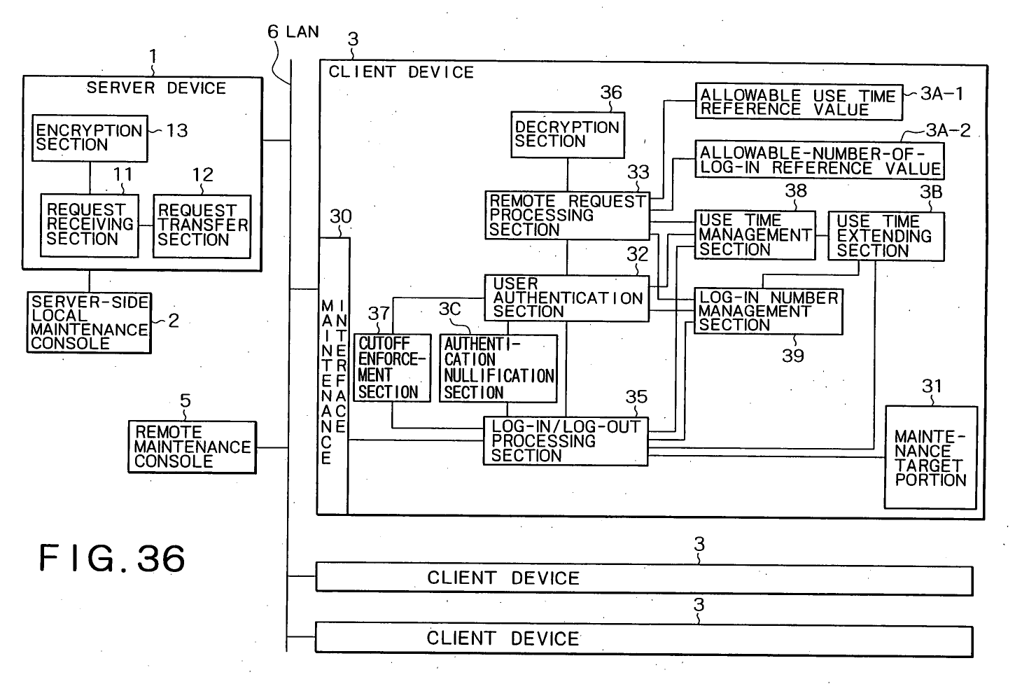

Referring to FIG. 36, a client/server type distribution system according to the ninth embodiment of the invention differs from the client/server type distribution system according to the eighth embodiment of the invention illustrated in FIG. 33 in that each client device 3 in the eighth embodiment has an authentication nullification section 3C which nullifies user authentication information registered in the user authentication section 32 and sends a notification of the nullification of the user authentication information to the remote maintenance console 5 when receiving an end-of-use-of-maintenance-interface notification from the remote maintenance console 5 which keeps the log-in state, and is identical to the eighth embodiment in the other points.

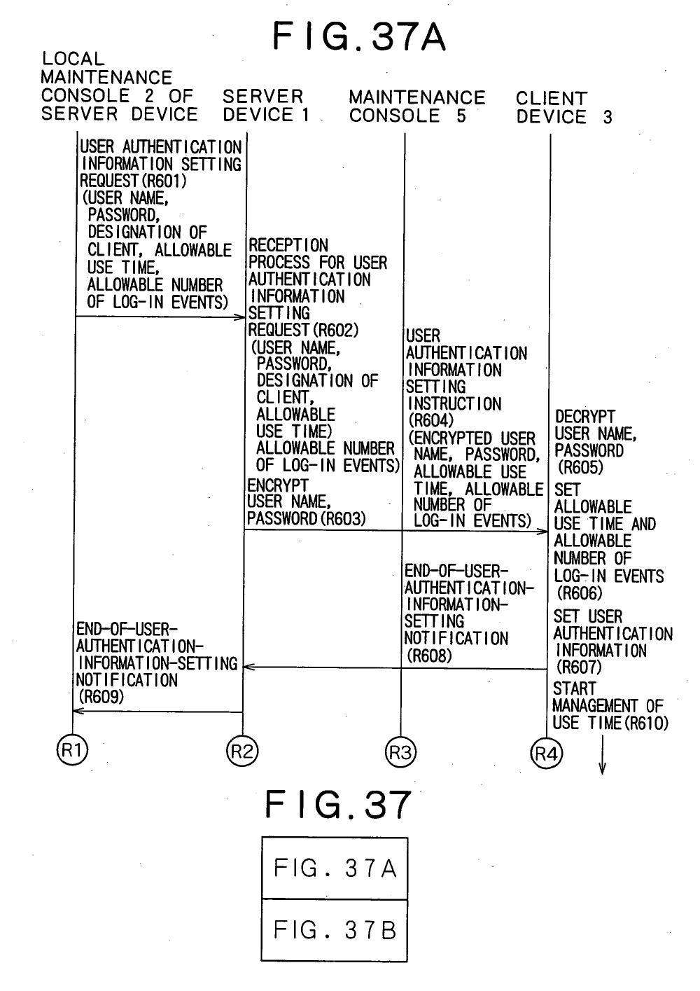

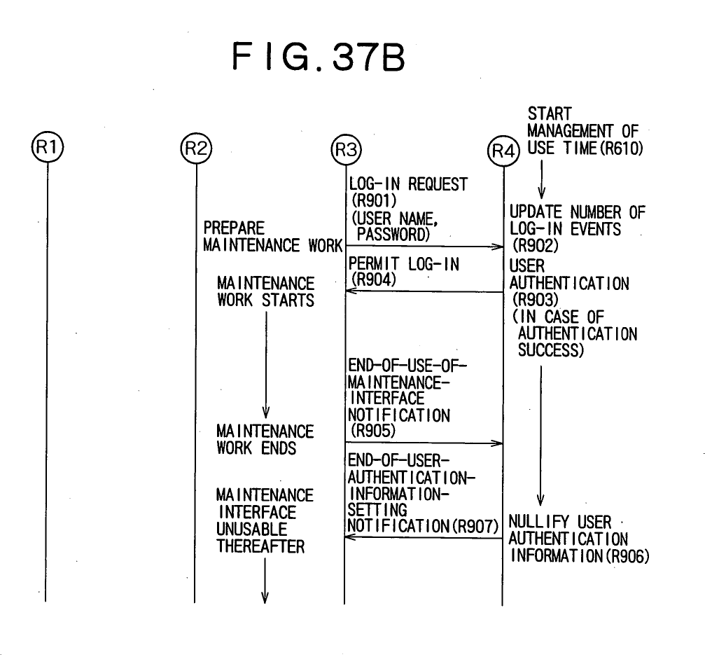

FIGS. 37A and 37B are sequence charts illustrating an operational example of the embodiment showing sequences for the following two cases.

(1) Setting of user authentication information, allowable use time and the allowable number of log-in events in the client device 3 from the server-side local maintenance console 2

(2) Log-in to the client device 3 from the remote maintenance console 5 and transmission of end-of-use-of-maintenance-interface notification therefrom

As the operation of the embodiment in the sequence (1) is the same as that of the sequence in FIGS. 29A and 29B, the following discusses an operation in the case (2) where a maintenance worker logs in to the client device 3 from the remote maintenance console 5, does a maintenance work and inputs an end-of-use-of-maintenance-interface notification from the remote maintenance console 5 when the maintenance work is done by referring to FIGS. 36 and 37.

As the user name and password are set in the user authentication section 32 of the client device 3, the allowable use time is set in the use time management section 38, the allowable number of log-in events is set in the log-in number management section 39 after which a maintenance worker inputs a log-in request designating a user name and password to the client device 3 from the remote maintenance console 5 over the LAN 6 (R901 in FIGS. 37A and 37B), the number of log-in events is updated in the log-in number management section 39-(R902 in FIGS. 37A and 37B). As a user authentication process R903 is executed and the user name and password in the log-in request match with those registered in the user authentication section 32, log-in is allowed (R904 in FIGS. 37A and 37B). This permits an access to the maintenance target portion 31 of the client device 3 from the remote maintenance console 5.

When the maintenance worker finishes maintenance of the maintenance target portion 31 of the client device 3 and inputs an end-of-use-of-maintenance-interface notification from the remote maintenance console 5 (R905), the notification is transferred to the authentication nullification section 3C through the log-in/log-out processing section 35 of the client device 3. The authentication nullification section 3C instructs the user authentication section 32 to nullify user authentication information and the user authentication section 32 nullifies the registered user authentication information by erasing it or so (R906). Then, the authentication nullification section 3C sends an end-of-user-authentication-information-setting notification to the remote maintenance console 5 (R907). Thereafter, the maintenance interface 30 is closed and is available until it is opened again.

According to the embodiment, as the maintenance interface 30 of the client device 3 is opened from the server-side local maintenance console 2 with a time set after which a maintenance worker logs in from the remote maintenance console 5 and inputs an end-of-use-of-maintenance-interface notification from the remote maintenance console 5 when the work is done, the use of the maintenance interface 30 of the client device 3 can be prohibited even before the use time is up. As user authentication information can be nullified when a maintenance work is finished, it is possible to prevent the threat of malignant accesses from becoming greater as the maintenance interface 30 is kept over a long period of time.

In the embodiment, like in the first embodiment, the client-side local maintenance console 4 in FIG. 1 may be connected to each client device 3 and the local request processing section 34 may be provided in each client device 3. In addition, user authentication information may be transferred, unencrypted, to the client device 3 from the server device 1 in which case the encryption section 13 and the decryption section 36 are omitted. The remote maintenance console 5 in a log-in operation may not be disconnected forcibly at the time of setting user authentication information, in which case the cutoff enforcement section 37 is omitted. Further, the use may not be extended in which case the use time extending section 3B is omitted. The allowable use time may not be managed in which case the use time management section 38 and the use time extending section 3B are omitted. The allowable number of log-in events-may not be managed in which case the log-in number management section 39 is omitted.

Although the embodiments of the invention have been described above, the invention is not limited to those embodiments, but may be modified in various other forms. For example, the network which connects the server device 1 to the client devices is not limited to a LAN but may be other types of networks, such as the Internet and intranet.

The functions of the server device and client device according to the invention can of course be achieved by hardware but can also be achieved by a computer and a server program and a client program. The server program and client program are provided with computer readable recording media, such as a magnetic disk or semiconductor memory, on which the programs are written, and are read by a computer at the time a computer constituting the server device and a console constituting a client device are activated. As the operations of the computers are controlled by the programs, the computers can function as the server device and client device according to each of the above-described embodiments.

What is claimed is:

1. A maintenance interface user authentication apparatus in a client/server type distribution system having a plurality of client devices connected to a server device over a network,
said server device having:
a request receiving section which receives from a server-side console a user authentication information setting request including user authentication information and designation of said client devices and a nullification-of-user-authentication-information-setting request including designation of said client devices; and
a request transfer section which transfers said user authentication information setting request and said nullification-of-user-authentication-information-setting request, received by said request receiving section, to those of said client devices which are designated over said network,
each of said client devices having:
a user authentication section which authenticates a user at a time of using a maintenance interface; and
a remote request processing section which sets said user authentication information, included in said user authentication information setting request, in said user authentication section when receiving said user authentication information setting request from said server device over said network, and nullifies said user authentication information set in said user authentication section when receiving said nullification-of-user-authentication-information-setting request from said server device over said network.

2. The maintenance interface user authentication apparatus according to claim 1, wherein setting of said user authentication information in said user authentication section in each of said client devices can be done only from said server-side console.

3. The maintenance interface user authentication apparatus according to claim 1, wherein said server device has an encryption section which encrypts said user authentication information in said user authentication information setting request to be transferred by said request transfer section, and each of said client devices has a decryption section which decrypts encrypted user authentication information in said user authentication information setting request received by said remote request processing section.

4. The maintenance interface user authentication apparatus according to claim 1, wherein each of said client devices has a cutoff enforcement section which forcibly disables use of a user who is currently using said maintenance interface in case where that user authentication information which is already set in said user authentication section is set again by a new user authentication information setting request received over said network.

5. The maintenance interface user authentication apparatus according to claim 1, wherein each of said client devices has a use time management section which nullifies said user authentication information set in said user authentication section and forcibly disables use of a user who is currently using said maintenance interface when an allowable use time has elapsed since setting of said user authentication information in said user authentication section.

6. The maintenance interface user authentication apparatus according to claim 5, wherein each of said client devices has a use time extending section which extends a remaining use time of said use time management section by a predetermined extension time only for first log-in since opening of said maintenance interface.

7. The maintenance interface user authentication apparatus according to claim 6, wherein at a time a first log-in request is issued since opening of said maintenance interface, said use time extending section determines whether or not a remaining use time managed by said use time management section lies within a predetermined given time and extends said remaining use time of said use time management section by a predetermined extension time when said remaining use time lies within said predetermined given time.

8. The maintenance interface user authentication apparatus according to claim 6, wherein during first log-in since opening of said maintenance interface, said use time extending section determines whether or not a remaining use time managed by said use time management section has fallen within a predetermined given time and extends said remaining use time of said use time management section by a predetermined extension time when said remaining use time has fallen within said predetermined given time.

9. The maintenance interface user authentication apparatus according to claim 5, wherein said use time management section uses, as said allowable use time, an allowable use time designated in said user authentication information setting request sent from said server device.

10. The maintenance interface user authentication apparatus according to claim 5, wherein said use time management section uses an allowable use time reference value prestored in said client devices as said allowable use time.

11. The maintenance interface user authentication apparatus according to claim 5, wherein when an allowable use time is designated in said user authentication information setting request sent from said server device, said use time management section uses said designated allowable use time as said allowable use time, and when said allowable use time is not designated, said use time management section uses an allowable use time reference value prestored in said client devices as said allowable use time.

12. The maintenance interface user authentication apparatus according to claim 1, wherein each of said client devices has a log-in number management section which nullifies said user authentication information set in said user authentication section and forcibly disables use of a user who is currently using said maintenance interface when an allowable number of log-in events has taken place since setting of said user authentication information in said user authentication section.

13. The maintenance interface user authentication apparatus according to claim 9, wherein said log-in number management section uses, as said allowable number of log-in events, an allowable number of log-in events designated in said user authentication information setting request sent from said server device.

14. The maintenance interface user authentication apparatus according to claim 13, wherein said log-in number management section uses an allowable-number-of-log-in reference value prestored in said client devices as said allowable number of log-in events.

15. The maintenance interface user authentication apparatus according to claim 13, wherein when an allowable number of log-in events is designated in said user authentication information setting request sent from said server device, said log-in number management section uses said designated allowable number of log-in events as said allowable number of log-in events, and when said allowable number of log-in events is not designated, said log-in number management section uses an allowable-number-of-log-in reference value prestored in said client devices as said allowable number of log-in events.

16. The maintenance interface user authentication apparatus according to claim 1, wherein each of said client devices has an authentication nullification section which nullifies said user authentication information set in said user authentication section at a time a user of said maintenance interface ends use of said maintenance interface.

17. A maintenance interface user authentication method in a client/server type distribution system comprising:
(a) a step in which a server device receives a user authentication information setting request including user authentication information and designation of client devices from a server-side console and transfers said user authentication information setting request to said designated client devices over a network;
(b) a step in which said client devices receive said user authentication information setting request over said network and set said user authentication information setting request in a user authentication section which authenticates a user at a time of using a maintenance interface;
(c) a step in which said server device receives a nullification-of-user-authentication-information-setting request including designation of said client devices from said server-side console and transfers said nullification-of-user-authentication-information-setting request to said designated client devices over said network; and
(d) a step in which said client devices receive said nullification-of-user-authentication-information-setting request over said network and nullify said user authentication information set in said user authentication section.

18. The maintenance interface user authentication method according to claim 17, wherein setting of said user authentication information in said user authentication section in each of said client devices can be done only from said server-side console.

19. The maintenance interface user authentication method according to claim 17, wherein said step (a) includes a process of causing said server device to encrypt said user authentication information to be transferred and said step (b) includes a process of causing said client devices to decrypt said received user authentication information.

20. The maintenance interface user authentication method according to claim 17, wherein said step (b) includes a process of forcibly disabling use of a user who is currently using said maintenance interface in case where that user authentication information which is already set in said user authentication section is set again to new user authentication information received.

21. The maintenance interface user authentication method according to claim 17, further including:
(e) a step in which each of said client devices nullifies said user authentication information set in said user authentication section and forcibly disables use of a user who is currently using said maintenance interface when an allowable use time has elapsed since setting of said user authentication information in said user authentication section.

22. The maintenance interface user authentication method according to claim 21, further including:
(f) a step in which said each of said client devices extends a remaining use time of said use time management section by a predetermined extension time only for first log-in since opening of said maintenance interface.

23. The maintenance interface user authentication method according to claim 22, wherein at a time a first log-in request is issued since opening of said maintenance interface, said step (f) determines whether or not a remaining use time managed in said step (e) lies within a predetermined given time and extends said remaining use time by a predetermined extension time when said remaining use time lies within said predetermined given time.

24. The maintenance interface user authentication method according to claim 22, wherein during first log-in since opening of said maintenance interface, said step (f) determines whether or not a remaining use time managed in said step (e) has fallen within a predetermined given time and extends said remaining use time by a predetermined extension time when said remaining use time has fallen within said predetermined given time.

25. The maintenance interface user authentication method according to claim 21, wherein as said allowable use time in said step (e), an allowable use time designated in said user authentication information setting request sent from said server device is used.

26. The maintenance interface user authentication method according to claim 21, wherein as said allowable use time in said step (e), an allowable use time reference value prestored in said client devices is used.

27. The maintenance interface user authentication method according to claim 21, wherein when an allowable use time is designated in said user authentication information setting request sent from said server device, said designated allowable use time is used as said allowable use time in said step (e), and when said allowable use time is not designated, an allowable use time reference value prestored in said client devices is used as said allowable use time.

28. The maintenance interface user authentication method according to claim 17, further including:
(e) a step in which each of said client devices nullifies said user authentication information set in said user authentication section and forcibly disables use of a user who is currently using said maintenance interface when an allowable number of log-in events has taken place since setting of said user authentication information in said user authentication section.

29. The maintenance interface user authentication method according to claim 28, wherein as said allowable number of log-in events in said step (e), an allowable number of log-in events designated in said user authentication information setting request sent from said server device is used.

30. The maintenance interface user authentication method according to claim 29, wherein as said allowable number of log-in events in said step (e), an allowable-number-of-log-in reference value prestored in said client devices is used.

31. The maintenance interface user authentication method according to claim 29, wherein when an allowable number of log-in events is designated in said user authentication information setting request sent from said server device, said designated allowable number of log-in events is used as said allowable number of log-in events in said step (e), and when said allowable number of log-in events is not designated, an allowable-number-of-log-in reference value prestored in said client devices is used as said allowable number of log-in events.

32. The maintenance interface user authentication method according to claim 17, further including:
(e) a step in which each of said client devices nullifies said user authentication information set in said user authentication section at a time a user of said maintenance interface ends use of said maintenance interface.

33. A server device to be connected to a plurality of client devices over a network, comprising:
a request receiving section which receives from a server-side console a user authentication information setting request including user authentication information, which is set in user authentication section for authenticating a user at a time said client devices use a maintenance interface, and designation of said client devices and a nullification-of-user-authentication-information-setting request including designation of said client devices; and
a request transfer section which transfers said user authentication information setting request and said nullification-of-user-authentication-information-setting request, received by said request receiving section, to those of said client devices which are designated over said network.

34. The server device according to claim 33, further having an encryption section which encrypts said user authentication information in said user authentication information setting request to be transferred by said request transfer section.

35. The server device according to claim 33, wherein each of said client devices has a structure for transmitting said allowable use time to be set in use time management section, which nullifies said user authentication information set in said user authentication section and forcibly disables use of a user who is currently using said maintenance interface when an allowable use time has elapsed since setting of said user authentication information in said user authentication section, in such a way as to be included in said user authentication information setting request.

36. The server device according to claim 33, wherein each of said client devices has a structure for transmitting said allowable number of log-in events to be set in a log-in number management section, which nullifies said user authentication information set in said user authentication section and forcibly disables use of a user who is currently using said maintenance interface when an allowable number of log-in events has taken place since setting of said user authentication information in said user authentication section, in such a way as to be included in said user authentication information setting request.

37. A client device to be connected to a server device over a network, comprising:
a user authentication section which authenticates a user at a time of using a maintenance interface; and
a remote request processing section which sets user authentication information, included in a user authentication information setting request, in said user authentication section when receiving said user authentication information setting request including said user authentication information from said server device over said network, and nullifies said user authentication information set in said user authentication section when receiving said nullification-of-user-authentication-information-setting request from said server device over said network.

38. The client device according to claim 37, wherein setting of said user authentication information in said user authentication section can be done only by said user authentication information setting request received from said server device.

39. The client device according to claim 37, further comprising a decryption section which decrypts encrypted user authentication information in said user authentication information setting request received from said server device over said network.

40. The client device according to claim 37, further comprising a cutoff enforcement section which forcibly disables use of a user who is currently using said maintenance interface in case where that user authentication information which is already set in said user authentication section is set again by a new user authentication information setting request received over said network.

41. The client device according to claim 37, further comprising a use time management section which nullifies said user authentication information set in said user authentication section and forcibly disables use of a user who is currently using said maintenance interface when an allowable use time has elapsed since setting of said user authentication information in said user authentication section.

42. The client device according to claim 41, further comprising a use time extending section which extends a remaining use time of said use time management section by a predetermined extension time only for first log-in since opening of said maintenance interface.

43. The client device according to claim 37, further comprising a log-in number management section which nullifies said user authentication information set in said user authentication section and forcibly disables use of a user who is currently using said maintenance interface when an allowable number of log-in events has taken place since setting of said user authentication information in said user authentication section.

44. The client device according to claim 37, further comprising an authentication nullification section which nullifies said user authentication information set in said user authentication section at a time a user of said maintenance interface ends use of said maintenance interface.

45. A server program for causing a computer constituting a server device to be connected to a plurality of client devices over a network to function as:
a request receiving section which receives from a server-side console a user authentication information setting request including user authentication information, which is set in user authentication section for authenticating a user at a time said client devices use a maintenance interface, and designation of said client devices and a nullification-of-user-authentication-information-setting request including designation of said client devices; and
a request transfer section which transfers said user authentication information setting request and said nullification-of-user-authentication-information-setting request, received by said request receiving section, to those of said client devices which are designated over said network.

46. The server program according to claim 45, wherein said computer is further caused to function as an encryption section which encrypts said user authentication information in said user authentication information setting request to be transferred by said request transfer section.

47. The server program according to claim 45, wherein said request receiving section and said request transfer section receive from said server-side console said allowable use time to be set in a use time management section, which nullifies said user authentication information set in said user authentication section and forcibly disables use of a user who is currently using said maintenance interface when an allowable use time has elapsed since setting of said user authentication information in said user authentication section, and transfer said allowable use time in such a way as to be included in said user authentication information setting request.

48. The server program according to claim 45, wherein said request receiving section and said request transfer section receive from said server-side console section said allowable number of log-in events to be set in log-in number management section, which nullifies said user authentication information set in said user authentication section and forcibly disables use of a user who is currently using said maintenance interface when an allowable number of log-in events has taken place since setting of said user authentication information in said user authentication section, and transfer said allowable number of log-in events in such a way as to be included in said user authentication information setting request.

49. A client program for causing a computer constituting a client device to be connected to a server device over a network to function as:
a user authentication section which authenticates a user at a time of using a maintenance interface; and
a remote request processing section which sets user authentication information, included in a user authentication information setting request, in said user authentication section when receiving said user authentication information setting request including said user authentication information from said server device over said network, and nullifies said user authentication information set in said user authentication section when receiving said nullification-of-user-authentication-information-setting request from said server device over said network.

50. The client program according to claim 49, wherein setting of said user authentication information in said user authentication section can be done only by said user authentication information setting request received from said server device.

51. The client program according to claim 49, wherein said computer is further caused to function as a decryption section which decrypts encrypted user authentication information in said user authentication information setting request received from said server device over said network.

52. The client program according to claim 49, wherein said computer is further caused to function as a cutoff enforcement section which forcibly disables use of a user who is currently using said maintenance interface in case where that user authentication information which is already set in said user authentication section is set again by a new user authentication information setting request received over said network.

53. The client program according to claim 49, wherein said computer is further caused to function as a use time management section which nullifies said user authentication information set in said user authentication section and forcibly disables use of a user who is currently using said maintenance interface when an allowable use time has elapsed since setting of said user authentication information in said user authentication section.

54. The client program according to claim 53, wherein said computer is further caused to function as a use time extending section which extends a remaining use time of said use time management section by a predetermined extension time only for first log-in since opening of said maintenance interface.

55. The client program according to claim 49, wherein said computer is further caused to function as a log-in number management section which nullifies said user authentication information set in said user authentication section and forcibly disables use of a user who is currently using said maintenance interface when an allowable number of log-in events has taken place since setting of said user authentication information in said user authentication section.

56. The client program according to claim 49, wherein said computer is further caused to function as an authentication nullification section which nullifies said user authentication information set in said user authentication section at a time a user of said maintenance interface ends use of said maintenance interface.
